(19) United States
(12) Patent Application Publication
(10) Pub. No.: US 2015/0369924 A1
(43) Pub. Date: Dec. 24, 2015

(54) METHOD AND SYSTEM FOR HIGH-ACCURACY DIFFERENTIAL TRACKING OF GLOBAL POSITIONING SYSTEM (GPS) RECEIVERS

(71) Applicant: VANDERBILT UNIVERSITY, Nashville, TN (US)

(72) Inventors: Will HEDGECOCK, Nashville, TN (US); Miklos MAROTI, Szeged (HU); Janos SALLAI, Nashville, TN (US); Peter VOLGYESI, Nashville, TN (US); Akos LEDECZI, Nashville, TN (US)

(21) Appl. No.: 14/765,479

(22) PCT Filed: Feb. 4, 2014
(86) PCT No.: PCT/US2014/014702

§ 371 Date: Aug. 3, 2015

Related U.S. Application Data
(60) Provisional application No. 61/760,353, filed on Feb. 4, 2013.

(51) Int. Cl. G01S 19/51; G01S 5/00

(52) U.S. Cl. CPC G01S 19/51; G01S 5/0072

(57) ABSTRACT

Aspects of the present invention relate to methods and systems for high-accuracy differential tracking of global positioning system (GPS) receivers. In one embodiment, a network having multiple receivers is provided. The receivers are configured to communicate with each other. The receivers in the network are configured to measure raw satellite data, and to share the raw satellite data measured by each receiver. Each receiver is configured to process the measured raw satellite data with a Peak Ambiguity Function Value (AFV) Tracking Solution (PATS) to track relative motions of the neighboring receivers so as to derive relative location information for the plurality of receivers.

### CROSS-REFERENCE TO RELATED PATENT APPLICATIONS

This application claims priority to and the benefit of, pursuant to 35 U.S.C. §119(e), U.S. provisional patent application Ser. No. 61/760,353, filed Feb. 4, 2013, entitled “METHOD AND SYSTEM FOR HIGH-ACCURACY DIFFERENTIAL TRACKING OF GPS RECEIVERS,” by Will Hedgecock, Miklos Maroti, Janos Sallai, Peter Volgyesi and Akos Ledeczi, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [56] represents the 56th reference cited in the reference list, namely, Peter Volgyesi, Sandor Szilvasi, Janos Sallai, and Akos Ledeczi. External smart microphone for mobile phones. In Proceedings of the International Conference on Sensing Technology, ICST, 2011.

### STATEMENT AS TO RIGHTS UNDER FEDERALLY-SPONSORED RESEARCH

This invention was made with government support under grant number CNS-NeTS-1218710 awarded by the National Science Foundation. The government has certain rights in the invention.

### FIELD OF THE INVENTION

The present invention relates generally to a global positioning system (GPS), and more particularly to methods and systems for high-accuracy differential tracking of GPS receivers.

### BACKGROUND OF THE INVENTION

The Global Positioning System (GPS) is a satellite-based navigation system designed and operated by the U.S. Department of Defense that provides accurate localization services anywhere on Earth for military and civilian applications. Its original design criteria included global coverage, continuous, all-weathered operation, the ability of operating in high-dynamic conditions, and high accuracy [23]. The result is a system that allows individual receivers to calculate their approximate positions in three dimensions using signals from a closely monitored network of satellites, as well as the determination of a global atomic time to nanosecond accuracy without requiring Internet connectivity or external inputs.

Although the original idea behind a GPS-like radio navigation system was conceived as early as the 1940s [3, 28], the system in its current state was not commissioned until 1973 for use primarily in military applications [37]. It was realized, however, that the implications of such a system were immensely far-reaching and could include many non-military and commercial applications, especially in the realms of navigation and land surveying. As such, it evolved into a dual-signal system with one very precise restricted signal to be used in military-only applications and a second civilian signal to extend localization services to commercial applications. In an effort to protect the United States' interests by ensuring that its military was able to calculate receiver positions much more precisely than foreign militaries or civilian users, a mathematical degradation process known as Selective Availability (SA) was developed and applied to the civilian signal to decrease the maximum precision achievable by the system [52].

GPS reached a fully operational status on Apr. 27, 1995 and found immediate commercial interest and success. A significant amount of investigative resources were devoted to overcoming the degraded accuracy levels imposed by SA, and after several years of extremely rapid, widespread growth, along with research into differential techniques which effectively removed any advantage arising from the military's access to more accurate ranging signals, the use of SA on civilian signals quickly became superfluous. In 2000, the degradation service was turned off, and non-military users have since been able to enjoy new levels of increased accuracy due to un-degraded ranging signals [6].

Following the economies of scale, GPS has experienced exponential growth and wide commercial acceptance in the recent decade and now permeates daily life in ways completely unforeseen at the time of its inception. It has quickly become the world's most widely used means of localization and navigation in outdoor deployments, both for scientific and commercial purposes [40, 47], and its accuracy and level of utilization continue to grow to this day.

Therefore, a heretofore unaddressed need exists in the art to address the aforementioned deficiencies and inadequacies.

### SUMMARY OF THE INVENTION

One aspect of the present invention relates to a method of high-accuracy differential tracking of global positioning system (GPS) receivers. In one embodiment, the method includes: providing a network having a plurality of receivers, where the receivers are configured to communicate with each other; configuring the plurality of receivers in the network to measure raw satellite data, and to share the raw satellite data measured by each receiver; and processing the measured raw satellite data for each receiver with a Peak Ambiguity Function Value (AFV) Tracking Solution (PATS) to track relative motions of the neighboring receivers so as to derive relative location information for the plurality of receivers.

In certain embodiments, each receiver has a GPS chip configured to measure the raw satellite data.

In certain embodiments, the method further includes: for each receiver, determining an initial relative position of the receiver.

In certain embodiments, the step of processing the measured raw satellite data for each receiver includes: initializing an AFV set for a given three-dimensional (3D) search region, and identifying data of AFV peaks for the AFV set; calibrating the data of the AFV peaks for the AFV set; and performing a steady-state localization for the AFV set when the AFV maintains at an acceptable level.

In certain embodiments, the step of calibrating the data of the AFV peaks for the AFV set further includes: for each AFV peak, updating peak locations of the AFV peaks, re-evaluating the AFV at each of the updated peak locations, and performing hill climbing by steepest ascent to a maximum value of a local peak; calculating a worst AFV threshold value for a current epoch; and filtering the updated peak locations based on the calculated worst AFV threshold value.

In certain embodiments, the step of processing the measured raw satellite data for each receiver further includes: re-initializing the AFV set for the given 3D search region when the AFV is not at the acceptable level.

In certain embodiments, the method further includes: for each receiver, calculating 3D pairwise relative changes of position between the plurality of receivers. In certain embodiments, the step of calculating 3D pairwise relative changes of position includes: deriving vector solutions locally at each receiver with resulting tracks of other receivers in the network using a current location of the receiver as a reference position.

In certain embodiments, the step of calculating 3D pairwise relative changes of position includes: determining a receiver clock bias using a simple least-squares point positioning solution; determining a hypothetic receiver clock bias as if the raw satellite data were measured at a correct GPS epoch according to the receiver clock bias; determining a hypothetic receive time of the correct GPS epoch according to a local receiver clock of the receiver; calculating a change in satellite range over the receiver clock bias; updating pseudorange observables based on the calculated change in satellite range; calculating an extrapolated signal transmit time according to the updated pseudorange observables; calculating a satellite position at the extrapolated signal transmit time; and updating the satellite position for a Sagnac effect according to an actual receive epoch and the extrapolated signal transmit time.

In another aspect, the present invention relates to a system for high-accuracy differential tracking of GPS receivers. In one embodiment, the system includes a network, and a plurality of receivers in the network. The receivers are configured to communicate with each other, and each receiver is configured to measure raw satellite data, to share the raw satellite data measured by each receiver, and to process the measured raw satellite data for each receiver with a Peak Ambiguity Function Value (AFV) Tracking Solution (PATS) to track relative motions of the neighboring receivers so as to derive relative location information for the plurality of receivers.

In certain embodiments, each receiver has a GPS chip configured to measure the raw satellite data.

In certain embodiments, each receiver is further configured to determine an initial relative position of the receiver.

In certain embodiments, each receiver is configured to process the measured raw satellite data by: initializing an AFV set for a given 3D search region, and identifying data of AFV peaks for the AFV set; calibrating the data of the AFV peaks for the AFV set; and performing a steady-state localization for the AFV set when the AFV maintains at an acceptable level.

In certain embodiments, each receiver is configured to calibrate the data of the AFV peaks for the AFV set by: for each AFV peak, updating peak locations of the AFV peaks, re-evaluating the AFV at each of the updated peak locations, and performing hill climbing by steepest ascent to a maximum value of a local peak; calculating a worst AFV threshold value for a current epoch; and filtering the updated peak locations based on the calculated worst AFV threshold value.

In certain embodiments, each receiver is configured to process the measured raw satellite data by: re-initializing the AFV set for the given 3D search region when the AFV is not at the acceptable level.

In certain embodiments, each receiver is configured to calculate 3D pairwise relative changes of position between the plurality of receivers.

In certain embodiments, each receiver is configured to calculate the 3D pairwise relative changes of position by: deriving vector solutions locally at each receiver with resulting tracks of other receivers in the network using a current location of the receiver as a reference position.

In certain embodiments, each receiver is configured to calculate the 3D pairwise relative changes of position by: determining a receiver clock bias using a simple least-squares point positioning solution; determining a hypothetic receiver clock bias as if the raw satellite data were measured at a correct GPS epoch according to the receiver clock bias; determining a hypothetic receive time of the correct GPS epoch according to a local receiver clock of the receiver; calculating a change in satellite range over the receiver clock bias; updating pseudorange observables based on the calculated change in satellite range; calculating an extrapolated signal transmit time according to the updated pseudorange observables; calculating a satellite position at the extrapolated signal transmit time; and updating the satellite position for a Sagnac effect according to an actual receive epoch and the extrapolated signal transmit time.

In certain embodiments, each of the plurality of receivers is stationary or movable. In certain embodiments, each of the plurality of receivers is provided on a mobile device or an automobile.

A further aspect of the present invention relates to a non-transitory computer readable medium storing computer executable instructions, wherein the instructions, when executed at a processor of a GPS receiver, are configured to: configure the receiver in a network having a plurality of receivers; configure the receiver to measure raw satellite data, and to share the raw satellite data measured by each receiver with the plurality of receivers in the network; and process the measured raw satellite data with a Peak Ambiguity Function Value (AFV) Tracking Solution (PATS) to track relative motions of the neighboring receivers so as to derive relative location information for the plurality of receivers.

In certain embodiments, the instructions are further configured to determine an initial relative position of the receiver.

In certain embodiments, the instructions are further configured to process the measured raw satellite data for each receiver by: initializing an AFV set for a given 3D search region, and identifying data of AFV peaks for the AFV set; calibrating the data of the AFV peaks for the AFV set; and performing a steady-state localization for the AFV set when the AFV maintains at an acceptable level.

In certain embodiments, the instructions are further configured to calibrate the data of the AFV peaks for the AFV set by: for each AFV peak, updating peak locations of the AFV peaks, re-evaluating the AFV at each of the updated peak locations, and performing hill climbing by steepest ascent to a maximum value of a local peak; calculating a worst AFV threshold value for a current epoch; and filtering the updated peak locations based on the calculated worst AFV threshold value.

In certain embodiments, the instructions are further configured to process the measured raw satellite data for each receiver by: re-initializing the AFV set for the given 3D search region when the AFV is not at the acceptable level.

In certain embodiments, the instructions are further configured to calculate 3D pairwise relative changes of position between the plurality of receivers.

In certain embodiments, the instructions are further configured to calculate 3D pairwise relative changes of position by: deriving vector solutions locally at each receiver with resulting tracks of other receivers in the network using a current location of the receiver as a reference position.

In certain embodiments, the instructions are further configured to calculate 3D pairwise relative changes of position by: determining a receiver clock bias using a simple least-squares point positioning solution; determining a hypothetic receiver clock bias as if the raw satellite data were measured at a correct GPS epoch according to the receiver clock bias; determining a hypothetic receive time of the correct GPS epoch according to a local receiver clock of the receiver; calculating a change in satellite range over the receiver clock bias; updating pseudorange observables based on the calculated change in satellite range; calculating an extrapolated signal transmit time according to the updated pseudorange observables; calculating a satellite position at the extrapolated signal transmit time; and updating the satellite position for a Sagnac effect according to an actual receive epoch and the extrapolated signal transmit time.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The patent or application file contains at least one drawing executed in color. Copies of this patent or patent application publication with color drawing(s) will be provided by the Patent and Trademark Office upon request and payment of the necessary fee.

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematically a GPS satellite signal composition according to certain embodiments of the present invention.

FIG. 2 shows schematically GPS satellite-receiver range measurement timing relationships according to certain embodiments of the present invention.

FIG. 3 shows schematically the signal amplitude as a function of phase according to certain embodiments of the present invention.

FIG. 4 shows schematically propagation of radio waves through the Earth's atmosphere according to certain embodiments of the present invention.

FIG. 5 shows the Sagnec effect according to certain embodiments of the present invention, where (a) shows the ECI frame, and (b) shows the ECEF frame.

FIG. 6 shows a flowchart of the GPS extrapolation procedure according to certain embodiments of the present invention.

FIG. 7 shows schematically antenna phase center offsets and variations according to certain embodiments of the present invention.

FIG. 8A shows schematically ideal localization using trilateration where the sensor positions are precisely known according to certain embodiments of the present invention.

FIG. 8B shows schematically ideal localization using trilateration with receiver clock error according to certain embodiments of the present invention.

FIG. 9 shows schematically geometric interpretation of the single-differencing operation according to certain embodiments of the present invention.

FIG. 10 shows schematically constituent components of the double-differenced carrier phase observation for a single satellite through time according to certain embodiments of the present invention.

FIG. 11 shows schematically potential integer ambiguity candidates and their corresponding grid lines according to certain embodiments of the present invention.

FIG. 12 shows schematically change in candidate receiver locations through time according to certain embodiments of the present invention, where (a) shows a set of potential receiver locations at time t₀, and (b) shows a set of potential receiver locations at time tₙ.

FIG. 13 shows schematically the maximum 1D AFM error due to search resolution according to certain embodiments of the present invention.

FIG. 14 shows schematically an AFM search space as a heat map in two dimensions according to certain embodiments of the present invention.

FIG. 15 shows schematically an AFM search space as a heat map in three dimensions according to certain embodiments of the present invention.

FIG. 16 shows schematically a maximum 3D AFM error due to search resolution according to certain embodiments of the present invention.

FIG. 17 shows a flowchart of an algorithm of Peak AFV Tracking Solution (PATS) according to certain embodiments of the present invention.

FIG. 18A shows schematically candidate peak locations at time t in the PATS algorithm according to certain embodiments of the present invention.

FIG. 18B shows schematically candidate peak locations at time t+1 in the PATS algorithm according to certain embodiments of the present invention.

FIG. 19 shows schematically candidate peak locations after hill climbing and re-evaluation in the PATS algorithm according to certain embodiments of the present invention.

FIG. 20 shows schematically comparison of candidate peak locations before and after threshold filtering according to certain embodiments of the present invention, where (a) shows candidate peak locations before threshold filtering, and (b) shows candidate peak locations after threshold filtering.

FIG. 21 shows a block diagram of the software implementation of the system according to certain embodiments of the present invention.

FIG. 22 shows schematically cumulative error distributions for a stationary receiver according to certain embodiments of the present invention.

FIG. 23 shows schematically static tracks using (a) the built-in μBlox algorithms vs. (b) the tracking methodology according to certain embodiments of the present invention.

FIG. 24 shows schematically tracks of two nodes separated by a constant 9-foot baseline making one lap around a running track according to certain embodiments of the present invention, where (a) shows the ground truth using Google Earth, (b) shows the result using μBlox, and (c) shows the result using the tracking methodology according to certain embodiments of the present invention.

FIG. 25 shows schematically an estimated distance between two mobile nodes (as seen by a stationary node) as a function of time as they moved around the track according to certain embodiments of the present invention.

FIG. 26 shows schematically relative angular distributions between three nodes in an equilateral triangle configuration for one lap around the track according to certain embodiments of the present invention.

FIG. 27 shows schematically the mean errors over time for two of the mobile node pairs attached to the roof a car driving along the interstate according to certain embodiments of the present invention, where (a) shows the mean errors over time for nodes No. 1 and No. 2, and (b) shows the mean errors over time for nodes No. 2 and No.

3.

FIG. 28 shows schematically tracking of car carrying out a lane change according to certain embodiments of the present invention.

FIG. 29 shows a flowchart of a method of high-accuracy differential tracking of GPS receivers according to certain embodiments of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising”, “including”, “carrying”, “having”, “containing”, “involving”, and the like are to be understood to be open-ended, i.e., to mean including but not limited to.

### OVERVIEW OF THE INVENTION

The present invention relates to the Global Positioning System (GPS), and more particularly to methods and systems for high-accuracy differential tracking of GPS receivers.

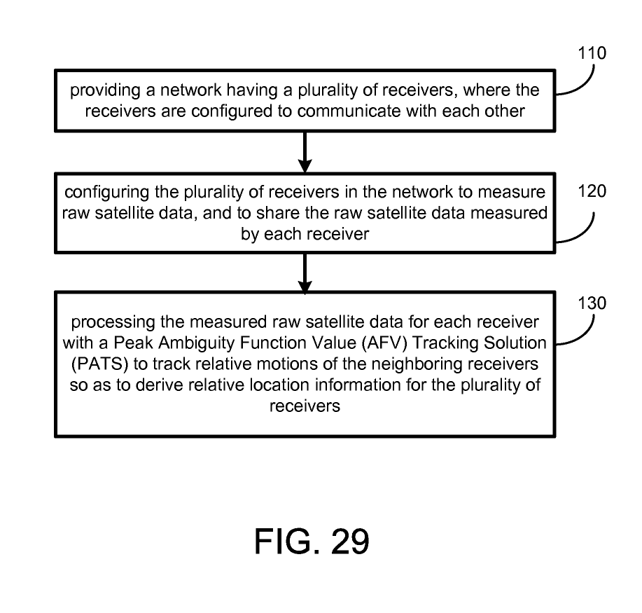

One aspect of the present invention relates to a method of high-accuracy differential tracking of global positioning system (GPS) receivers. FIG. 29 shows a flowchart of a method of high-accuracy differential tracking of GPS receivers according to certain embodiments of the present invention. As shown in FIG. 29, in certain embodiments, the method includes three steps. At step 110, a network having a plurality of receivers is provided, where the receivers are configured to communicate with each other. At step 120, the receivers in the network are configured to measure raw satellite data, and to share the raw satellite data measured by each receiver. At step 130, for each receiver, the measured raw satellite data is processed with a Peak Ambiguity Function Value (AFV) Tracking Solution (PATS) to track relative motions of the neighboring receivers so as to derive relative location information for the plurality of receivers.

In another aspect, the present invention relates to a system for high-accuracy differential tracking of global positioning system (GPS) receivers. In one embodiment, the system includes a network, and a plurality of receivers in the network. The receivers are configured to communicate with each other, and each receiver is configured to measure raw satellite data, to share the raw satellite data measured by each receiver, and to process the measured raw satellite data for each receiver with a Peak Ambiguity Function Value (AFV) Tracking Solution (PATS) to track relative motions of the neighboring receivers so as to derive relative location information for the plurality of receivers.

In certain embodiments, each of the plurality of receivers is stationary or movable. In certain embodiments, each of the plurality of receivers is provided on a mobile device or an automobile.

A further aspect of the present invention relates to a non-transitory computer readable medium storing computer executable instructions, wherein the instructions, when executed at a processor of a global positioning system (GPS) receiver, are configured to: configure the receiver in a network having a plurality of receivers; configure the receiver to measure raw satellite data, and to share the raw satellite data measured by each receiver with the plurality of receivers in the network; and process the measured raw satellite data with a Peak Ambiguity Function Value (AFV) Tracking Solution (PATS) to track relative motions of the neighboring receivers so as to derive relative location information for the plurality of receivers.

Currently, the GPS includes 31 satellites on six orbital planes about 20,000 km above the Earth's surface. This constellation enables accurate location information to be computed at any place, any time on Earth using trilateration with range measurements between an observer and a few visible satellites. Range estimation is done using the times-of-flight of radio signals transmitted by the satellites. Although each satellite is equipped with a highly accurate and synchronized atomic clock, receivers are driven by much less accurate crystal oscillators. This design decision allowed for a truly ubiquitous localization service, but makes it impossible to directly measure the time-of-flight of radio signals traveling at the speed of light with acceptable accuracy (distance estimates based on an imprecise and arbitrary local clock are called pseudoranges). Instead, the receiver's offset from true absolute time becomes another unknown in addition to its 3D position coordinates. Thus, at least four independent measurements (satellites) are needed for a position fix to be computed. For the same reason, a low-cost GPS receiver can provide a highly accurate global time reference (tens of nanoseconds) when locked onto the minimum number of satellites [5].

GPS satellites continuously transmit messages using a Code Division Multiple Access (CDMA) spread spectrum technique, which allows them to share the exact same carrier frequency and, more importantly, use a single local oscillator (LO) at the receiver; thus, the phase noise and frequency instability of the LO affect all received signals in the same way. The GPS signal has a rich hierarchical structure with each signal derived from the same atomic clock source. All satellites transmit on at least two carrier frequencies (L1: 1.57542 GHz and L2: 1.2276 GHz) which are modulated by a pseudo-random noise (PRN) sequence. For civilian applications, each satellite uses a unique sequence of 1023 bits (C/A code) transmitted continuously at 1.023 million bits/s, whereas military applications make use of a much longer sequence (P code) at 10.23 million bits/s. Receivers need to know the assigned sequences a priori to lock onto the signals and separate them from noise and from each other. At the top of the signal hierarchy, each satellite transmits a low speed navigation message at 50 bits/s that contains its own clock and location (ephemeris) information.

A typical GPS receiver includes a low-noise analog frontend for amplifying, filtering, and down-converting the antenna signal (˜1.5 GHz), an analog-to-digital converter (ADC) for digitizing the quadrature IF signal (˜2 MHz), and a highly parallel digital signal processor implemented in an ASIC along with a traditional processor core. The key element of this architecture is the custom digital signal processor, operating on tens of independent signal paths (channels) in parallel. Each channel uses a digital correlator (assigned to one of the known satellite codes) to find, track, and correlate a PRN sequence in the received data with the expected PRN signal, shifted and scaled in time. The tracked shift and scale values that give the maximum correlation value represent the time of flight and Doppler-shift (satellite orbital velocity is 4000 m/s), respectively.

Each standalone GPS receiver is prone to several sources of measurement error, and understanding the error budget is essential to enhancing accuracy. First, the propagation speed of radio signals in the ionosphere and troposphere is different than in free space; thus, both refract GPS signals, potentially causing significant error in the overall result. Second, each GPS satellite broadcasts its orbital position (ephemeris) and clock correction data in the navigation message, as described above. Both pieces of information are based on a predictive model and are, therefore, inaccurate. These errors however, along with atmospheric effects, are correlated within a bounded geographic region and can be compensated later when more accurate information is available. Other sources of error include multipath propagation and measurement noise in the GPS receiver. It is much more difficult to mitigate these (using more refined antennas or higher precision receivers that increase the cost, size, and power requirements of the unit); fortunately, these effects represent a smaller percentage of the error budget.

Consumer GPS receivers-used mainly for navigational and recreational applications-represent the standalone class and are affected by all errors described above. The prevalence of these receivers has dramatically driven down cost, size, and power requirements over the past decade. For those applications where standalone accuracy is insufficient, the huge price gap to a more precise system can be prohibitive. Our work aims at bridging this gap when only accurate relative locations are needed.

High precision GPS receivers and receiver systems employ a variety of techniques to mitigate these errors. Atmospheric effects can be corrected by using both L1 and L2 carrier frequencies, since refraction is frequency dependent. In fact, as part of the GPS modernization program, there is a proposed L5 carrier frequency for civilian receivers. In military-grade GPS, receivers can use the faster P(Y) code for more precise time-of-arrival measurements. Carrier phase measurement and tracking can be used to provide even higher accuracy (comparable to the wavelength of the carrier signal), but generally requires extensive post-processing.

Finally, there are several solutions based on differential corrections. While all of these approaches employ more than one receiver, they differ widely in geographic scale, real-time properties, complexity, and their effectiveness in mitigating atmospheric, ephemeris, and satellite clock errors. One end of the spectrum is represented by Satellite-Based Augmentation Systems (SBAS), like the Wide Area Augmentation System (WAAS) used in the U.S., which broadcasts real-time correction information via geostationary satellites based on measurements from several ground reference stations. Most consumer-grade GPS receivers are capable of using this coarse correction information. The other extreme is based on offline post-processing, where highly accurate correction data is calculated at a reference station with a precise clock (such as an atomic clock source) and a well-known location.

Most similar to our work is Differential GPS (DGPS), because it, too, uses multiple receivers to increase GPS accuracy. In DGPS, mobile receivers can calculate their absolute positions with increased accuracy by altering their received satellite measurements according to corrections sent out by one or more static base stations which have been well-calibrated and know their own positions to a high degree of accuracy [15]. This method, while providing absolute instead of relative coordinates, requires preliminary setup of expensive, stationary base stations which precludes it from being used in everyday mobile system deployments.

Another class of methods which has been gaining popularity and increasing in accuracy over recent years is called Real Time Kinematic (RTK) satellite navigation [13, 11], which works in a similar fashion to DGPS, except that all coordinates are found using carrier phase measurements with respect to a dedicated sensing station. Again, the sensing station is located at a well-known, pre-defined location and transmits its own position and carrier phase measurements to other receivers in the vicinity. As such, it provides coordinates relative to a base receiver with a high degree of accuracy. In RegTrack, there is no dedicated base station or reference node. Every node considers itself the reference when computing the relative locations of its neighbors. Hence, the architecture is symmetric and there is no single point of failure.

Another drawback of RTK is that the carrier phase measurements it uses are exclusively relative measurements which require knowledge of an unknown (but constant) number of wavelengths between satellite and receiver at an arbitrary point in time to be of any use in absolute positioning; thus, the system must either:
1 have extremely accurate knowledge of the absolute base station position,
2 use dual-frequency receivers to minimize single-point errors such as atmospheric delay or measurement noise, or
3 spend a considerable amount of time solving for the carrier ambiguities in the system—a very active area of research itself [16, 12].

Even after taking these steps into consideration, the system breaks down readily in the face of difficult multipath environments, moderate to severe line of sight obstructions to satellite visibility, satellite losses of lock, or cycle slips, making it most appropriate for use in low-dynamic situations with a clear, broad view of the sky such as nautical navigation or land surveying [9].

There is also ongoing research in enhancing the core methods and algorithms used in standard GPS positioning techniques. Researchers from several Brazilian universities have tried to improve upon the RTK positioning algorithm by using wavelets as the foundation for a mathematical model of the GPS system [4]. Additionally, there has been research into better methods of DGPS base station design [6], as well as the use of relative positioning in automotive safety applications [2]. The advantage of our research, however, is that it is general and extensible to most any type of mobile sensing network, whereas these papers present very application-specific results which do not provide a means of building upon them or extending them to other areas.

Finally, there are active research efforts in the mobile systems community centered around GPS with the focus of reducing power consumption. Jurdak et al. [8] and Paek et al. [3] explore various duty cycling strategies. Liu et al. [10] go one step further and offload location determination using raw satellite measurements from the battery-powered node to a remote server, trading off GPS usage for additional communication overhead. These efforts are orthogonal to our approach, as we are focusing on increasing positioning accuracy and disregarding the associated cost in power in this first phase of our project.

Many of today's wireless mobile applications rely heavily on highly accurate node location information. For outdoor applications, GPS is quickly becoming the de-facto standard for location determination; however, low-cost receivers, such as those found in smartphones, can exhibit large errors on the order of tens of meters, especially in urban areas or under dense foliage. Higher quality devices provide much better accuracy, but can cost hundreds of dollars, and commercial-grade surveying deployments can reach into the thousands while requiring extensive setup and calibration before they are usable.

While GPS is remarkable in its ability to provide absolute coordinates anywhere on Earth, many applications, including typical wireless sensor network (WSN) deployments, do not need precise absolute locations. In fact, many of today's WSN localization methods rely on estimating the range between nodes to derive their locations in a relative coordinate system. Furthermore, numerous applications beyond WSNs also require accurate relative locations, such as the formation flying of unmanned aerial vehicles (UAVs) and other robotics applications, precision agriculture, land surveying, and autonomous driving (e.g. platoon formation and collision avoidance), among others. Existing solutions in use today are based on absolute GPS coordinates (e.g. Dierential GPS) or additional sensors such as LIDAR or gyroscopes, but these are typically very costly.

Aspects of the present invention relates to a novel relative localization system based on the ubiquitous U.S.-based GPS and only low-cost, single-frequency GPS receivers. The goal is to enable commercial receivers to achieve an unprecedented centimeter-scale level of accuracy for applications that require node locations in a relative coordinate frame. Such an increase in GPS accuracy (in the relative sense) without a corresponding increase in cost should enable the production of novel applications that are either not economical today or are out of reach altogether.

In many mobile wireless applications such as the automated driving of cars, formation flying of unmanned air vehicles, and source localization or target tracking with wireless sensor networks, it is more important to know the precise relative locations of nodes than their absolute coordinates. GPS, the most ubiquitous localization system available, generally provides only absolute coordinates. Furthermore, low-cost receivers can exhibit tens of meters of error or worse in challenging RF environments. This disclosure presents an approach that uses GPS to derive relative location information for multiple receivers. Nodes in a network share their raw satellite measurements and use this data to track the relative motions of neighboring nodes as opposed to computing their own absolute coordinates. The system has been implemented using a network of Android phones equipped with a custom Blue-tooth headset and integrated GPS chip to provide raw measurement data. Our evaluation shows that centimeter-scale tracking accuracy at an update rate of 1 Hz is possible under various conditions with the presented technique. This is more than an order of magnitude more accurate than simply taking the difference of reported absolute node coordinates or other simplistic approaches due to the presence of uncorrelated measurement errors.

Location information is highly important for many mobile systems. For outdoor applications, GPS is quickly becoming the de-facto standard for location determination. In the past, GPS was rarely used in battery-powered, low cost systems, such as wireless sensor networks (WSN), due to its relatively high price and significant power draw. With the proliferation of smart-phones, the price of GPS chips has rapidly decreased. Furthermore, there are many active research efforts to decrease the power consumption of GPS for battery-powered mobile nodes [10, 8, 3]. A third concern for a subset of applications is accuracy. Low-cost receivers, such as those found in smartphones, can exhibit large errors on the order of tens of meters, especially in urban areas or under dense foliage. Higher quality devices provide much better accuracy, but can cost hundreds of dollars, and commercial-grade surveying deployments can reach into the thousands while requiring extensive setup and calibration before they are usable.

It is important to note that while GPS is remarkable in its ability to provide absolute coordinates anywhere on Earth, many applications, including typical WSN deployments, do not need absolute locations—at least not precise absolute locations. They “only” require node locations relative to one another. In fact, most of today's WSN localization methods rely on estimating the range between nodes to derive their locations in a relative coordinate system. Furthermore, there are numerous applications beyond WSNs that also need accurate relative locations, such as formation flying of UAVs and other robotic applications, precision agriculture, land surveying, autonomous driving (e.g. platoon formation and collision avoidance), and others. There are existing solutions in use today based on either absolute GPS coordinates (for example, Differential GPS) or additional sensors such as LIDAR or gyroscopes, but these are typically very costly.

The GPS can be separated into three distinct components: a space segment, a user segment, and a control segment. These segments are respectively made up of the GPS satellite constellation, the user equipment which receives satellite ranging signals, and a ground monitoring network. Each of these segments will be discussed in turn and examined as to how they relate and work together to comprise the ubiquitous localization service that is GPS.

### Space Segment

The original GPS commission called for 24 satellites to make up the bulk of what is known as the “space segment.” Nominally, these satellites would move in 6 orbital planes with 4 evenly-spaced satellites per plane, ensuring that a minimum of five satellites would be visible from any line-of-sight point on Earth at any given time [33]. This configuration was realized in 1995 when the GPS system became fully operational. However, additional satellites have been launched over the years, resulting in an asymmetrical configuration that expands upon the original principles. The current GPS satellite constellation consists of a set of 31 medium-Earth orbiting (MEO) satellites, which has substantially increased the number of satellites visible at any given time from the original specification [36].

The orbital period of each satellite is 11 hours, 58 minutes, with each plane evenly-spaced around the equator at 60° of separation and a nominal inclination of 55° relative to the equatorial plane. Each satellite maintains a nearly circular orbit approximately 26,600 kilometers from the center of the Earth. Assuming an average Earth radius of 6,378 km, the satellites tend to orbit about 20,222 km above any given point on the surface of the Earth [34]. With the original 24 satellites, the relative angle between any two satellites in adjacent orbits was ˜40°, but this number has since decreased with the seven additional satellites that were added to the current constellation [23].

GPS satellites are referred to formally by their official Space Vehicle Numbers (SVN) as assigned by the Department of Defense, but can also be referenced according to their orbital plane (a capital letter in the range A-F) and numerical slot in that plane. Most commonly, satellites are referenced by the unique individual ranging codes that they emit. There are currently 32 pre-defined digital sequences known as Pseudo-Random Noise (PRN) codes, with each satellite emitting exactly one of these PRN sequences at any given time. It is possible for a satellite to switch between different PRN sequences, but no two satellites will ever emit the same sequence simultaneously; thus, the PRN ranging signal can be used to uniquely identify any satellite at a given time [35]. For the rest of this dissertation, we will discuss satellites in terms of their assigned PRN codes ranging from 1 to 32 (e.g. if NAVSTAR SVN 60 is emitting PRN code No. 12, the satellite will simply be referred to as ‘PRN 12’).

### GPS Signal Composition

GPS is a passive system in which each satellite transmits a unique one-way signal to a potentially infinite number of receivers whose job it is to decode and utilize that signal for navigation purposes. As such, receivers rely on a one-way form of Time-of-Arrival (TOA) ranging to determine their positions. Due to the one-way nature of these signals along with the fact that satellites cannot communicate with one another, it is essential that all satellite clocks be precisely aligned to some reference time. This is achieved via synchronization of highly accurate atomic clocks on board each satellite to a so-called absolute \GPS time” which is directly related to the Coordinated Universal Time (UTC) to which our Earth clocks are synchronized [34]. These atomic clocks generate a long-band (IEEE designation \L-band”) sine wave with a frequency of 10.23 MHz, which is then separated into two additional signals via multiplication by 154 and 120. The resulting frequencies, denoted L1 (1,575.42 MHz) and L2 (1,227.6 MHz), are the carrier frequencies used by all GPS satellites on which to encode their ranging signals [12].

As mentioned in the introduction, GPS currently implements two positioning services. The first is called the Standard Positioning Service (SPS), and it is available for unrestricted civilian use worldwide. The signal associated with this service is called the Course-Acquisition (C/A) code, and it is encoded onto the L1 frequency. A separate Precision (P) code, associated with the restricted, military-only Precise Positioning Service (PPS), is encrypted and encoded onto both the L1 and L2 carrier frequencies [23]. The focus of this research lies strictly with SPS, so the signals of interest are the various C/A codes used to modulate the L1 frequency.

We mentioned that each satellite emits a unique, pre-defined pseudo-random noise (PRN) sequence. The C/A code for each satellite is a 1 kHz signal made up of continuously repeating 1 millisecond long PRN sequences over time. Each digital PRN sequence consists of 1,023 binary bits which modulate the L1 carrier wave at a rate of 1.023 MHz to form a ranging signal [12]. Note that the PRN code is considered a 1 kHz signal because each code symbol is 1 ms long, but the actual PRN bits modulate the carrier wave at 1.023 MHz. In essence, this distinction between carrier and code allows GPS to utilize Direct Sequence Spread Spectrum (DSSS) modulation to provide Code Division Multiple Access (CDMA) multiplexing, whereby each satellite signal has access to its own high-bandwidth (2.046 MHz) data channel by virtue of the unique PRN code used to encode its data [34].

In DSSS modulation, a carrier wave is phase-modulated by a string of pseudo-random noise symbols called \chips” which are made up of a deterministic (but seemingly random, hence pseudo-random) set of binary noise bits. In GPS, the 1,023 bits of the PRN code sequence are used as chips to modulate the L1 carrier signal using Binary Phase Shift Keying (BPSK). This results in a signal that looks like and has characteristics similar to white noise [23]. The benefits of such a modulation technique include resistance to jamming, reduced signal-to-background noise, and the ability to share a single data channel among multiple receivers, hampered only by the amount of cross-correlation between the various PRN codes used to “spread” the signal [42]. As such, the 32 PRN sequences currently in use were carefully chosen based on their low cross-correlation profiles with respect to one another.

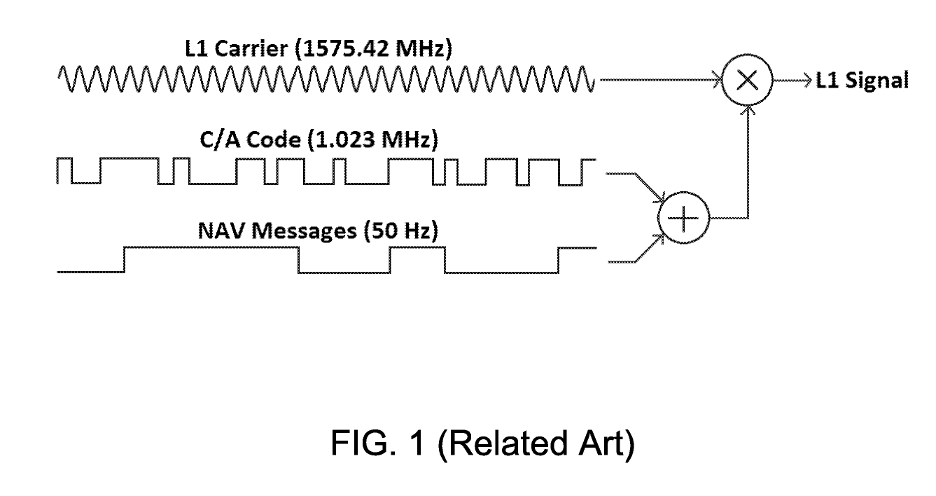

Finally, each satellite continuously sends navigation messages encoded at 50 data bits per second on top of the C/A code signal [12]. These navigation messages contain satellite and clock parameters, enabling a receiver to compute the position of the satellites at the time of signal transmission, determine correction factors for satellite clock biases and atmospheric disturbances, and read status and health updates regarding the transmitting satellite. Together, these signals form a composite GPS L1 signal as shown in FIG. 1 [11].

### User Segment

In order to utilize the spread-spectrum L1 signal as described in the previous section, GPS receivers use a variety of specialized hardware to detect, demodulate, and separate the composite signal into its individual components. While the hardware specifications of a receiver depend heavily on its intended application, the necessary set of components needed to process a GPS signal remains the same: an antenna, filtering and downconversion components, an internal oscillator, digital signal processors, and a navigation processor.

### Antenna

The antennas used in the majority of GPS receivers are right-hand circularly polarized (RHCP) with nearly complete hemispheric coverage. Most antennas have unity gain at elevation angles around 15°, increasing to about 2.5 dBic (decibels-isotropic circular) at the zenith [23]. The gain below an elevation of 15° is typically negative; thus, stronger and more reliable signals can be received from satellites at higher angles with respect to the receiver.

Depending on the use case, a GPS antenna should be able to pass the entire bandwidth of an L1 signal (2.046 MHz). Many low-cost, inaccurate receivers will only pass a portion of the bandwidth (for instance, many hiking receivers pass only 1.7 MHz [23]). This results in a loss of information and less accurate ranging signals. Additionally, antennas have electrical phase centers that do not usually coincide with the actual geometric center of the antenna. In fact, the phase center may be dependent not only on the receiver itself, but also on the elevation and azimuth of the incoming signal, with some antennas more sensitive to these effects than others. It is, therefore, imperative that the antenna design characteristics match the intended application's specifications.

### Filtering and Downconversion

The received signals are immediately routed from the antenna through a passive bandpass filter to remove any out-of-band RF interference. This is followed by pre-amplification before a downconversion process in which the RF signals are converted to an intermediate frequency (IF) to be sampled by an analog-to-digital (A/D) converter. Generally, the A/D converter will sample at a rate anywhere between 2 and 20 times the PRN code chipping rate (1.023 MHz for L1 C/A) [23]. The minimum sampling rate that satisfies the Nyquist sampling theorem would be 2.046 MHz, but oversampling reduces the sensitivity of the receiver to quantization noise, thereby reducing the number of bits required by the A/D converter.

### Internal Oscillator

The entire GPS receiver is controlled by a low-cost internal oscillator that can be implemented using any number of technologies. This oscillator is used to drive the downconversion and A/D conversion processes, as well as to synthesize local versions of the various PRN codes being emitted by the satellites. Since these local oscillators are much less accurate than the atomic clocks found on board a GPS satellite, their biases and drifts over time constitute large sources of error in the localization process, requiring them to be handled mathematically during position estimation.

### Digital Signal Processors

A digital output stream from the A/D converter is fed simultaneously into a bank of Digital Signal Processors (DSPs) which are responsible for tracking the various PRN code streams being transmitted by the satellites. Each DSP comprises its own separate “channel,” with each channel being used to track one and only one PRN sequence at a time. Since there are a limited number of satellites visible to a receiver at any given time, the number of parallel channels does not need to equal the total number of possible PRN sequences. In most receivers, there are typically 8 to 12 channels, which adequately allows the receiver to track all satellites that may be visible at any one time instant [23]. The output from these processors includes the raw navigation messages that were encoded on the L1 signal for that satellite, as well as the estimated time-of-flight measurements and any Doppler shifts noted in the tracked signal.

### Navigation Processor

Finally, the output from the DSP channels are used by a Navigation Processor component to keep track of various signal acquisition properties and measurement observables, and in some receivers, to provide an instantaneous estimate of the current position, velocity, and time to the user.

### Signal Decomposition

The L1 GPS signal captured by a receiver's antenna will be the same composite signal as shown in FIG. 1. The individual signal components can be recovered by essentially reversing the modulation operations used to create the signal in the first place. In order to do this, however, the receiver must be able to uniquely identify the transmitting satellite and its current position in transmission of the PRN code sequence (known as the codephase). This operation is carried out by a process known as digital autocorrelation [45].

In autocorrelation, a signal is compared with a duplicate of itself shifted by some arbitrary amount of time. An integrator keeps track of the “sameness” of the digital signals by adding a +1 whenever the current chips or bits match and a −1 whenever they are different. If the signals being compared are of a finite length (like PRN codes), the resulting accumulated value can be divided by the total code length so that a perfectly matched code will result in an autocorrelation value of +1. Random DSSS binary code signals (including GPS PRN codes) are unique in that they produce an autocorrelation value of +1 only when they successfully correlate with themselves to within one chip offset. Correlation of the signal with any other random binary code or with itself shifted any other number of chips will result in an autocorrelation value close to 0 [5]. It is for this reason that multiple PRN codes can be transmitted on the same frequency without corrupting each other's data.

Since there are currently 32 possible GPS PRN codes, each only 1 ms long, a receiver is required to search through all available PRN sequences shifted arbitrarily through time until it finds a sequence that exactly matches one of the PRN codes present in the L1 signal [23]. (Note that in order to \match” code sequences, a receiver must know the PRN sequences a priori.) For each available DSP channel in the receiver, a different PRN code is generated locally and fed into an autocorrelation component along with the downconverted L1 GPS signal. This autocorrelation component consists of a feedback loop which attempts to maximize the amplitude of the autocorrelation function by shifting the currently-generated PRN sequence chip by chip through time over a period of 1 ms (the length of one full PRN cycle). Upon finding a PRN sequence and shift that results in an autocorrelation value near 1, a satellite “lock” is said to have been acquired. If no lock is acquired after attempting to autocorrelate over the entire PRN sequence, it is evident that the receiver is not receiving a signal from the satellite associated with that PRN, and it may move on to the next untested PRN sequence.

After a satellite lock has been acquired, the DSP will add its locally generated version of the shifted PRN sequence to the received signal, which effectively cancels out the PRN code leaving only the intermediate carrier frequency and the navigation message corresponding to the locked PRN [45]. By stripping the carrier frequency from the resulting signal, the receiver is left with the raw 50 Hz navigation messages which are then forwarded to the navigation processor, along with the amount of shift required to lock onto the PRN code and any Doppler shift required to maintain that lock after it was initially acquired.

### Control Segment

In order to keep the entire GPS system running smoothly, the network of satellites is closely monitored by what is known as the \Control Segment.” This segment consists of sixteen monitoring stations, four ground antennas, and a Master Control Station (MCS), located at Schriever Air Force Base in Colorado Springs, Colorado [31]. Its purpose is to monitor all satellite navigation signals for accuracy, coherence, and consistency, update the satellites' position data (known as the ephemerides), resolve satellite anomalies, correct satellite clock and orbital errors, and keep up with the general housekeeping tasks required for continuous, smooth satellite operation [23].

### Satellite Augmentation Systems

An additional “helper” service called the Wide Area Augmentation System (WAAS) was developed to enhance the accuracy and availability of the standard GPS system and satellite constellation. The WAAS belongs to a group of Satellite Based Augmentation Systems (SBAS) whose purpose is to augment the features and applicability of various navigation systems from different countries. By analyzing received satellite ranging signals based on what the expected signals should be, WAAS monitoring stations are able to determine differential corrections with respect to atmospheric signal delays, satellite orbital and clock errors, and a number of other environmental conditions that can affect GPS signals uniformly over a wide region for all users within a given satellite's visibility range [1].

Unlike GPS satellites, WAAS satellites are geostationary, with the current constellation consisting of three equatorial satellites at varying longitudes, providing full-time coverage of the entire United States. While the primary purpose of WAAS is to improve the accuracy, availability, and integrity of GPS, WAAS satellites also transmit ranging signals of their own using PRN codes just like GPS, essentially serving as additional GPS satellites for receivers capable of decoding the WAAS signals [1].

### Measurement Observables

Contrary to popular belief, the natural measurements of a GPS receiver are not the same as the so-called \raw measurements” that the receiver outputs. In fact, the natural measurements have already been alluded, as discussed above, that the replica carrier wave and PRN codes generated locally by the receiver. The only measurements a GPS receiver actually makes are the amount of time shift required to align the received and locally generated PRN codes (the codephase) and the amount of frequency shift required to keep the locally generated carrier wave synchronized to the frequency of the received wave (the Doppler shift) [57]. The measurement observables from a GPS receiver are formed directly from these two observations and consist of a set of three distinct values known as the pseudorange, carrier phase, and Doppler shift.

### Pseudorange

The pseudorange observable is one of the most basic and fundamental concepts in GPS. In essence, it is the real physical range between a satellite and receiver, including possibly hundreds of kilometers of error due to receiver clock bias [23]. Fortunately, this bias manifests itself uniformly in the observed pseudoranges to all visible satellites, so it is a correlated form of error that can be accounted for. Thus, the \pseudo” in pseudorange comes from the fact that all range values may be tainted significantly by a uniform receiver-side error.

Pseudorange is calculated quite simply by multiplying the time-of-flight (TOF) of a transmitted signal from satellite to receiver by the propagation speed of the radio signal which, in this case, equals the speed of light. The transmit time is known exactly since it is included in the navigation message, but the receive time is based on an inaccurate local clock; thus, the complexity in pseudorange measurement arises from synchronizing the receiver clock to GPS time with such precision that an accurate TOF can be measured.

In general, a GPS receiver is able to utilize the structure of the navigation messages and bit transitions encoded on the various satellite signals to synchronize its own internal clock to an accuracy of better than 1 ms. In fact, since PRN codes repeat themselves every millisecond, most receivers are able to detect when their synchronization has drifted over that threshold, limiting the worst-case bias to no more than 1 ms. Determination of sub-millisecond clock bias directly from the radio signals, however, is not possible. As such, by multiplying the observed time of flight of each radio signal (with a maximum error of 1 ms) by the speed of light, the GPS receiver is able to return a pseudorange to each visible satellite [44], with observation errors ranging anywhere from −300 to 300 km, corresponding to a receiver clock synchronization error in the range from −1 to 1 ms.

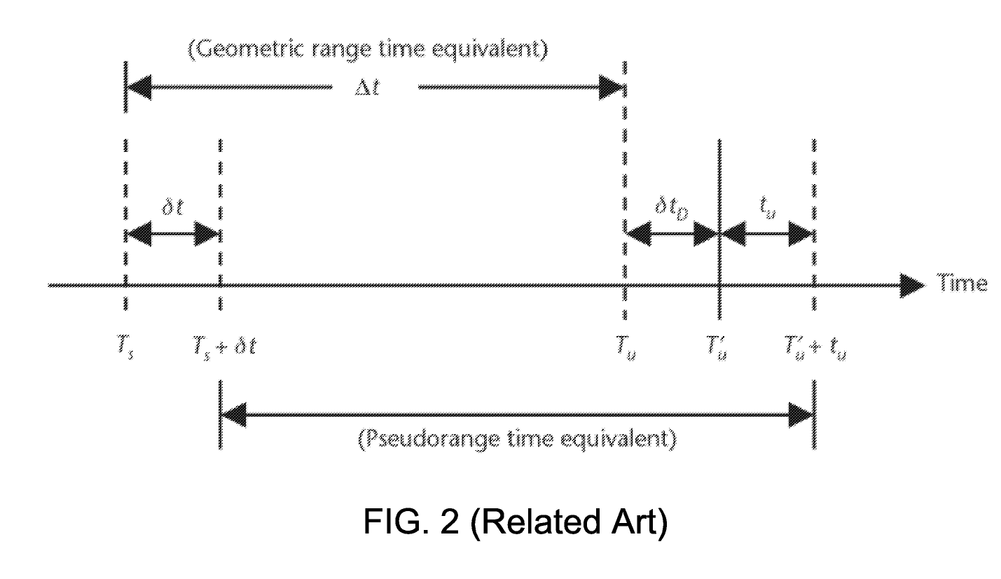

FIG. 2 shows schematically GPS satellite-receiver range measurement timing relationships according to certain embodiments of the present invention. As shown in FIG. 2:

Tₛ=GPS system time when the signal left the satellite

Tᵤ=GPS system time when the error-free signal would have reached the user

T′ᵤ=GPS system time when the signal actually reached user with delay δtD

δt=satellite clock offset from GPS time

tᵤ=receiver clock offset from GPS time

Assume now that the pseudoranges are known to at least four satellites. The primary source of error in these observations is the local clock bias from GPS time due to an imprecise local oscillator. As shown in FIG. 2, this bias manifests itself equally in determination of the local time and the pseudorange calculation [23]. Thus, by subtracting the pseudorange (divided by the speed of light) from the local clock's estimate of the receive time, the actual transmit time (i.e. the time when the current point in the L1 signal left the corresponding satellite) is obtained.

Since we know the actual satellite transmit times, the positions of the satellites (from their navigation messages), and the corresponding pseudoranges which include the receiver clock bias times the speed of light, the actual GPS system receive time can be found by estimating the receiver clock bias along with the X,Y,Z-coordinates of the receiver position [23].

In order to use the measured TOF and receiver clock bias to calculate pseudorange, the following generalized equation for receiver r and satellite s is used [5]:

Pᵣ^{s}=(Tᵣₓ−Tₜₓ)·c (1)

where Tᵣₓ is the local clock time of reception and Tₜₓ is the satellite clock time of transmission. Since both times contain a clock bias, τ, from actual GPS time, t, (due to either satellite clock error or receiver clock error), the pseudorange equation can be rewritten:

$$\begin{matrix}{P}_{r}^{s} ( {t}_{rx} ) = ( {t}_{rx} + {τ}_{r} ) \cdot c - ( {t}_{tx} + {τ}^{s} ) \cdot c \\ = ( {t}_{rx} - {t}_{tx} ) c + c {τ}_{r} - c {τ}^{s} \\ = {ρ}_{r}^{s} ( {t}_{rx} ) + c {τ}_{r} - c {τ}^{s}\end{matrix} \qquad ( 2 )$$

where ρᵣ^{s}(tᵣₓ) is the physical distance the signal had to travel from time of transmission to time of reception; in other words, the geometric range. Additionally, the satellite clock bias is constantly measured by the Control Segment and transmitted in the navigation message, so most receivers will correct for this term (cτ^{s}), making it negligible in Equation 2.

It should be noted that this formula represents a generalized model for pseudorange, neglecting relatively small errors such as atmospheric delay and multipath; however, these error sources must be taken into account to achieve a higher level of accuracy [25].

### Doppler Shift

While pseudorange is used in virtually all localization and navigation procedures, the method by which it is acquired makes it the least accurate of the measurement observables. Two other measurements known as Doppler shift and carrier phase are formed directly from the received L1 carrier signals, providing a means for much more accurate position estimation. Doppler shift is a well-known phenomenon that affects traveling wavefronts when two objects move at different speeds relative to one another [62]. In this case, a radio signal transmitted at a nominal frequency of f₀ from a satellite in motion will appear at the receiver with a slightly different frequency of f_{R}. This is significant because the amount of shift from the nominal frequency is mathematically related to the relative change in position of the satellite over time.

There are two methods by which GPS receivers typically measure this effect. The first and most common method arises simply from the way in which a GPS receiver maintains its satellite locks. It has been shown that satellite locks are achieved by maximizing an autocorrelation function between the received PRN code on the L1 signal and the same locally generated code shifted through time. It is apparent that the autocorrelation function must be maximized by aligning the received and generated code sequences over a significant amount of time (at least one full code cycle). This is only possible if the code being generated has the same frequency as the code being received.

When a receiver is carrying out its search-and-acquire procedure for the various PRN codes, it must try to align the codes not only in time, but also in frequency. As such, most receivers will scale the generated code according to a set of frequency bins centered around the nominal L1 frequency [41]. Upon finding a frequency value (and alignment) that results in a successful autocorrelation, the frequency can then be fine-tuned to maximize the autocorrelation result. The exact frequency that does so should be equal to the frequency of the received signal. As such, the instantaneous Doppler shift can be found by simply subtracting the nominal frequency from the received frequency:

f_{D}=f_{R}−f₀.

It should be noted that the satellites and receivers are not moving relative to one another in a constant fashion; therefore, the Doppler shifts change over time. The receiver is constantly tracking this shift to maintain its satellite lock, with the result that every Doppler observation is an instantaneous observation that changes with each consecutive epoch.

The second method by which a receiver might calculate the Doppler shift to a satellite is by determining the beat frequency resulting from mixing the received GPS signal with the locally-generated one [5]. When two sine waves with slightly different frequencies are mixed together, a wave is produced with two frequency components equal to the sum and difference of the original waves' frequencies. Knowing that

$$f ≡ \frac{d ∅ ( t )}{d t} ,$$

this can be written as:

$$( 3 )$$

$$\begin{matrix}{S}_{1} ( t ) ⊗ {S}_{2} ( t ) = {A}_{1} sin 2 {π∅}_{1} ( t ) \times {A}_{2} sin 2 {π∅}_{2} ( t ) \\ = \frac{{A}_{1} {A}_{2}}{2} [ cos 2 π ( {∅}_{2} ( t ) - {∅}_{1} ( t ) ) - cos 2 π ( {∅}_{2} ( t ) + {∅}_{1} ( t ) ) ]\end{matrix}$$

By passing this resulting wave through a low-pass filter to remove the high-frequency component, a pure sine wave containing only the beat frequency (i.e. the Doppler shift) will remain:

S_{B}(t)=B sin 2πØ_{B}(t) (4)

where B is the amplitude of the resulting beat signal and Ø_{B} (t) is the resulting phase difference which changes as a function of time (a.k.a. the beat frequency). Once the Doppler shift is known, it can be used to determine user velocity, signal anomalies, or even user position with the aid of additional observables.

### Carrier Phase

An extremely valuable observable utilized in most high-precision applications is the carrier phase. Like Doppler shift, this type of observation is formed directly from the GPS carrier signal instead of TOF measurements; as such, accuracies in line with 1% of the wavelength of the L1 carrier wave (1.91 mm) are theoretically achievable using this type of observation [23].

The term “carrier phase” is confusing terminology which seems to indicate that the observation is some sort of phase angle. In reality, it is the number of whole and fractional L1 carrier cycles that exist between a satellite and receiver at a given time, or simply put, the geometric range between satellite and receiver in units of carrier cycles. The term phase is used because it is derived from an accumulation of phase over time.

It should be noted that phase is a property fundamentally related to pure sinusoidal waves. Since GPS uses a sine wave as a carrier with a well-known, constant L1 frequency, the carrier can be written in complex form as y=Ae^{j2π(f}^{_{L1}}^{t+θ)}, where A is the signal amplitude, f_{L1}=1575.42 MHz, and θ is the phase in radians at time t=0. For an L1 sine wave transmitted from satellite s at time Tₜₓ and received by receiver r at time Tᵣₓ, the signal can be represented as [39]:

tᵣ^{s}(tᵣₓ)=Ae^{j2πØ}^{ᵣ}^{^{s}}^{(t}^{ᵣₓ}) (5)

where Øᵣ^{s} (tᵣₓ) is the received phase in cycles.

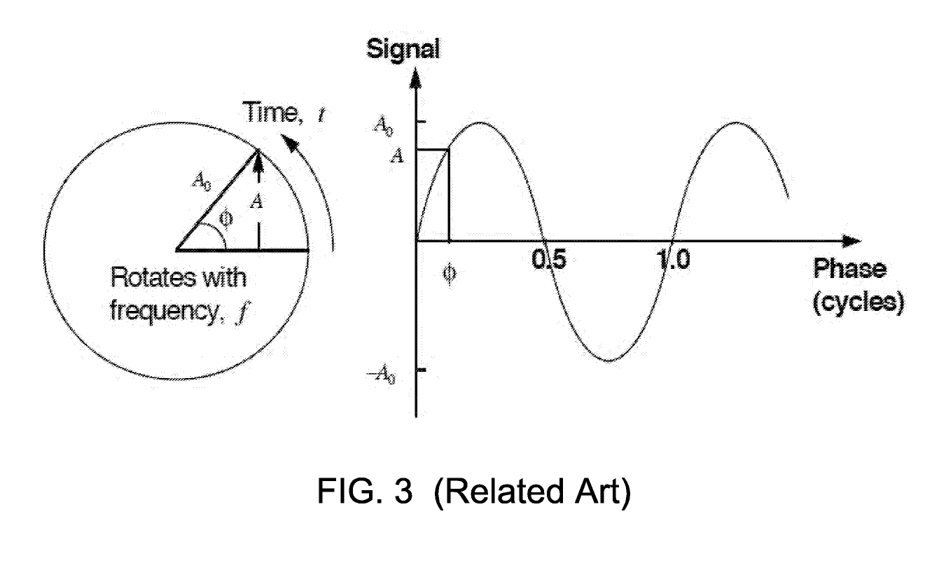

FIG. 3 shows schematically the signal amplitude as a function of phase according to certain embodiments of the present invention. FIG. 3 depicts how phase relates to frequency and signal amplitude in a sine wave over time [5].

For ideal plane waves propagating in free space, the behavior of Øᵣ^{s} is well-known; therefore, assuming tₜₓ and tᵣₓ are the transmit and receive times of the exact same point in the sine wave, the received phase in Equation 5 can be written,

$$\begin{matrix}{∅}_{r}^{s} ( {t}_{rx} ) ≡ ( {f}_{L 1} {t}_{tx} + {∅}^{s} ( 0 ) ) mod 1 \\ ≡ ( {f}_{L 1} {t}_{tx} - \frac{{ρ}_{r}^{s} ( {t}_{rx} )}{{λ}_{L 1}} + {∅}^{s} ( 0 ) ) mod 1\end{matrix} \qquad ( 6 )$$

where Ø^{s}(0) is the initial transmit phase at the satellite, λ_{L1} is the L1 carrier wavelength, and ρᵣ^{s}(tᵣₓ) is the satellite-receiver range, with ρᵣ^{s} (tᵣₓ)=(tᵣₓ tₜₓ)c [39].

Geometrically, the carrier phase measurement may be used to determine a receiver-satellite range. In this case, Equation 6 can be rearranged to give the satellite range in units of carrier cycles as:

$$\frac{{ρ}_{r}^{s} ( {t}_{rx} )}{{λ}_{L 1}} = ( {t}_{rx} - {t}_{tx} ) {f}_{L 1} = {f}_{L 1} {t}_{rx} + {∅}^{s} ( 0 ) - {∅}_{r}^{s} ( {t}_{rx} ) + {N}_{r}^{s} ( {t}_{rx} ) \qquad ( 7 )$$

where Nᵣ^{s} is the integer number of full cycles (wavelengths) between the satellite and receiver (arising from the modulo operation in Equation 6). In order to calculate the range, the receiver must therefore know or be able to estimate the receive time, tᵣₓ, the initial satellite phase offset, Ø^{s}(0), the received RF phase, Øᵣ^{s}, and the integer number of cycles between satellite and receiver, Nᵣ^{s}.

Unfortunately, receivers cannot calculate this range value directly because the initial satellite phase offsets, integer ambiguities, and receiver clock biases are unknown, and Equation 7 represents the instantaneous phase at the exact time instant that the transmitted signal phase arrives at the receiver given a constant frequency. If there were no errors and the GPS satellites were geostationary, this equation would hold true. In reality, the satellites are in constant motion relative to us; thus, the received frequency is not constant nor equal to the ideal L1 frequency. In order for the phase value to be useful in terms of GPS positioning, it is necessary to know the difference between the received frequency and the ideal, transmitted frequency—in other words, the Doppler shift. Luckily, the previous section explained how this shift can be found.

Since Doppler shift can be measured to much greater precision than the codephase used in pseudorange determination, use of this value will greatly increase the potential accuracy in position estimation. We know that Doppler shift arises from the change in relative position (i.e. velocity) of a satellite to a receiver over time. Thus, by integrating the Doppler shift values at each epoch, a receiver is able to keep track of the line-of-sight changes in position of each satellite relative to where it was when the Doppler integration began. By initializing a simple integer counter that increases every time a full cycle of the beat signal has passed, the receiver can calculate how far the satellite has moved since its time of lock in units of L1 carrier cycles. Mathematically, this looks like [23]:

Øᵣ^{s}(tₙ)=Øᵣ^{s}(tₙ₋₁)+∫ₜ_{ₙ₋₁}^{t}^{ₙ}f_{D}(τ)dτ+Ø_{r,frac}^{s}(tₙ) (8)

where tₙ is the time associated with epoch number n, Øᵣ^{s} is the accumulated phase at the specified time, f_{D} is the Doppler shift at the specified time, and Ø_{r,frac}^{s} is the fractional remainder of the received phase. The reason the fractional portion is separated out from the accumulated Doppler shift is because receivers usually implement this function using simple integer counters [23]. The counter will increase by 1 whenever a full Doppler cycle has completed, which means that there will exist some fractional amount of phase remaining at the end of each epoch that a receiver can easily identify from its carrier-phase tracking loops. Due to this method of calculation, carrier phase is oftentimes referred to as accumulated or integrated Doppler shift.

It is apparent that Equation 8 constitutes a highly accurate phase accumulation function, but that it neglects the base case of the number of cycles already present between a satellite and receiver at the arbitrary startup time, t₀. From Equation 7, we can see that this omission includes the initial signal phase from the satellite at the time of transmission, the initial signal phase of the replica receiver at the time of satellite lock, and the integer number of wavelengths between satellite and receiver. Most receivers will simply initialize these unknowns to zero and return the carrier phase observable under the assumption that Øᵣ^{s}(t₀)=0.

In order to use this carrier phase observable, we must formulate a model which incorporates the measurement aspects just discussed. This is a simple enough task, given our knowledge that for an incoming L1 signal with phase Øᵣ^{s} (Tᵣₓ) at receiver time Tᵣₓ that left satellite s at satellite time Tₜₓ, the following equations are true [5]:

Ø^{s}(Tₜₓ)=(f_{L1}tₜₓ+φ^{s}(t₀))mod 1

φᵣ(Tᵣₓ)=(f_{L1}tᵣₓ+φᵣ(t₀))mod 1 (9)

The difference between these two equations will give the geometric satellite-receiver range in units of carrier cycles at time Tᵣₓ:

φᵣ^{s}(Tᵣₓ)=f_{L1}(tᵣₓ−tₜₓ)+φᵣ(t₀)−φ^{s}(t₀)−Nᵣ^{s}(Tᵣₓ) (10)

As mentioned in the section on pseudorange formulation, both T terms include some amount of clock bias, τ, from GPS time, t. We have also shown in Equation 8 that the carrier phase observable integrates continuously once a satellite lock is established, with the result that the Nᵣ^{s}(Tᵣₓ) term actually models the integer number of wavelengths between satellite and receiver at the reference time, t₀, and remains constant as long as a satellite lock is maintained. In other words, Nᵣ^{s}(Tᵣₓ)=Nᵣ^{s}(T₀)=Nᵣ^{s}. Therefore, the formula can be re-written in terms of GPS time as:

Φᵣ^{s}=f_{L1}(tᵣₓ−tₜₓ)+f_{L1}τᵣ−f_{L1}τ^{s}+φᵣ(t₀)−φ^{s}(t₀)−Nᵣ^{s} (11)

Again, the f_{L1}τ^{s} term can be virtually eliminated based on satellite clock correction data in the navigation messages, so it will fall out of this equation once compensated for.

It should be noted that the final three terms of this equation are constants which together indicate the total number of carrier cycles between satellite and receiver at the time of satellite lock. In many cases, these terms will be lumped together as Bᵣ^{s}≡(φᵣ(t₀)−φ^{s}(t₀)−Nᵣ^{s}) [5]. The reason to keep them separate is that several differencing techniques will result in the fractional φ terms completely canceling out, leaving only the integer ambiguities to deal with.

For the sake of symmetry and ease of combining carrier phase and pseudorange measurements, the carrier phase observable is converted into a so-called carrier range by multiplying it by the wavelength of the L1 sine wave. This results in an observation in units of meters, like pseudorange, with a very similar-looking equation:

$$\begin{matrix}{L}_{r}^{s} ( {t}_{rx} ) ≡ {λ}_{L 1} {Φ}_{r}^{s} ( {t}_{rx} ) \\ = {λ}_{L 1} {f}_{L 1} ( {t}_{rx} - {t}_{tx} ) + {λ}_{L 1} {f}_{L 1} {τ}_{r} - {λ}_{L 1} {f}_{L 1} {τ}^{s} + {λ}_{L 1} {B}_{r}^{s} \\ = c ( {t}_{rx} - {t}_{tx} ) + c {τ}_{r} - c {τ}^{s} + λ {B}_{r}^{s} \\ = {ρ}_{r}^{s} ( {t}_{rx} ) + c {τ}_{r} - c {τ}^{s} + λ {B}_{r}^{s}\end{matrix} \qquad ( 12 )$$

In the rest of this dissertation, the term carrier phase is used to refer to the observable in units of L1 carrier cycles, and the term “carrier range” is used to refer to it in terms of meters, as shown above.

### GPS Error Sources and Correction Techniques

Thus far, discussions regarding the observables that a GPS receiver uses to calculate its position have been taken from the point of view of an idealized world. In reality, there are a variety of effects and conditions, in addition to clock synchronization errors, that alter the precision of the observations and make it much more difficult to achieve highly accurate position localization. The disclosure gives an overview of these error sources and presents ways in which some of them can be mitigated, if not removed completely.

### Satellite Clock Bias

Each GPS satellite uses a highly stable atomic clock to ensure that it is precisely aligned to actual GPS time; however, the Control Segment (CS) allows for these clocks to drift up to 1 ms from GPS time before sending synchronization corrections [23]. Essentially any bias from actual GPS time means that the satellite is transmitting its PRN code at a slightly incorrect time. Since a GPS receiver calculates pseudorange based on TOF values times the speed of light, 1 ms of satellite clock error will correspond to approximately 300 km of error in the pseudorange. The CS is constantly monitoring these errors, however, and sends correction values in the navigation message of each satellite.

Specifically, a satellite's navigation message will include its clock bias (denoted a_{f0}) at some reference time, tᵣₓ—usually the time when the clock correction parameters were estimated and uploaded to the satellite—its clock drift (α_{f1}), and its frequency drift (a_{f2}) [13]. These parameters can be used by the GPS receiver to correct the signal transmit time according to the following formula:

δt_{clk}=α_{f0}+α_{f1}(t−t_{oc})+α_{f2}(t−t_{oc})² (13)

where t represents the current receive time epoch.

It should be noted that these corrections are estimates of the clock parameters based on previous behavior and are not completely accurate. The atomic clocks on each satellite have stabilities of about 1 part in 10¹³ per day [38]. After one full day (−10⁵ s), the clock error will have accumulated to about 10⁻⁸ s, or roughly 3.5 m. Empirically, residual errors on the order of 0.8-4 m usually remain, depending on the type of satellite and the age of the estimated parameters, with precision degrading over time. In most cases, clock parameters are re-estimated and uploaded to each satellite at least once per day such that, according to a 2004 study, the 1-sigma error due to satellite clock bias averaged over the entire age of data (up to 24 hours) was 1.1 m [23].

### Receiver Clock Bias

As with GPS satellite clocks, the internal clock in each GPS receiver is subject to bias from GPS time. In fact, these biases are much larger and change more rapidly than satellite biases since these clocks are driven by low-cost internal oscillators instead of the atomic clocks used on board GPS satellites. The effect of receiver clock bias on each of the observables is identical to that of satellite clock bias; namely, the introduction of significant error based on the magnitude of the bias times the speed of light [23].

Since this bias is large and changes so rapidly, it is frequently handled by estimation in the localization procedures for each GPS receiver. This is possible because the bias is uniform in the observations to all satellites, enabling it to be modeled by a single error parameter for each receiver in addition to the X, Y, and Z coordinate parameters.

One further complication arises from the fact that receiver clocks drift out of synchronization from GPS time so quickly that they must be reset fairly often. We have discussed how PRN codes repeat every millisecond and how the amount of shift required to align the locally generated code with the received code is the basis for forming the pseudorange observation. Since each code is only 1 ms long, this shift is only meaningful (in that it is not a modulo operation) for clock biases less than 1 ms. As such, most GPS receivers will internally keep track of the estimated receiver clock bias and perform a hard reset to synchronize back to GPS time when the bias approaches or reaches ±1 ms. These resets produce noticeable “jumps” in the observables, since all counters must be re-initialized, causing the measurement period for one observation, by necessity, to be longer or shorter than the rest. Luckily, observation jumps are easily detectable, and care must be taken to account for them in any GPS localization software.

### Satellite Orbital Errors

The GPS satellite constellation has been very precisely designed, with each satellite following an extremely specific orbit around the Earth. Nonetheless, various forces such as solar radiation pressure, gravitational forces, tidal movements, infrared radiation, and deformations of the Earth can cause slight shifts and inaccuracies in the pre-defined orbital paths of the satellites [8]. These shifts cannot be anticipated and only become apparent during post facto analysis.

Luckily, orbital errors are usually small, and furthermore, only the portion of the error that is projected onto the line-of-sight vector from satellite to receiver has any effect on the ranging observables [38]. Typical magnitudes for such orbital errors range from 1 to 6 meters, with the average effective 1-sigma error on the observables approximately 0.8 m [23].

### Atmospheric Effects

When discussing the formation of the various GPS observables, we made the assumption that all radio signals were traveling through a vacuum at the speed of light. This is not strictly true since all signals must travel through the various layers of the Earth's atmosphere. Two layers in particular cause deformations of the radio waves, namely the ionosphere and the troposphere. Since the index of refraction—and thus the radio wave propagation speed—is different for each of these layers, they will contribute some amount of error to each GPS observable formed under the pretense of speed-of-light propagation with no refraction between layers.

### Ionospheric Delay

The ionosphere is a region of the atmosphere spanning from about 70 km to 1,000 km above the surface of the Earth. It is filled with free electrons that cause it to be a dispersive medium (a medium in which propagation speeds are a function of the frequency of the wave) [23]. It is beyond the scope of this dissertation to discuss material propagation properties, but it is important to note that the propagation velocity of the signal's carrier phase differs from the velocity of the PRN codes used to carry the signal information.

The velocity associated with the carrier phase of the signal is known as phase velocity while the velocity associated with the PRN codes is known as group velocity. It can be observed that the phase velocity always exceeds the group velocity in GPS signals. Also, the advance of the phase velocity with respect to vacuum-propagation speeds is equal to the retardation of the group velocity. In terms of GPS observables, this means that all signal information (PRN codes and navigation data) are delayed by exactly the same amount that the carrier phase is advanced. This phenomenon is known as ionospheric divergence. Therefore, when looking at the corresponding errors (in meters) of the pseudorange and carrier range observables, the magnitudes of the errors due to the ionosphere are identical, but with opposite signs.

Since the amount of delay a radio wave experiences in the ionosphere is proportional to the amount of time it spends there, ionospheric delay is a function of not only the location where the signal entered the ionosphere (known as the “pierce point”), but also the elevation of the satellite with respect to the receiver (as radio waves from lower-elevation satellites necessarily have more atmosphere to penetrate than waves that entered at a higher angle). In fact, the error incurred on waves from satellites at low elevations is almost three times greater than the error on signals coming in from the zenith.

Each satellite transmits ionospheric correction parameters for use by the receiver in a Klobuchar model which can reduce the amount of error due to the ionosphere by approximately 50%. Without correction, ionospheric delay can introduce errors ranging from 3-9 m at night and 15-45 m during the day. A typical 1-sigma error value for ionospheric delays averaged over all locations and all elevation angles is 7 m.

### Tropospheric Delay

The troposphere is located directly below the ionosphere and is a non-dispersive medium, meaning that all phase and group velocities are equivalent in this layer. The delay arises from the index of refraction which, in this layer, is dependent upon the local temperature, pressure, and relative humidity. Uncompensated errors due to the troposphere can range from 2.4 m for satellites at the zenith to 25 m for satellites approximately 5° above the horizon. Using advanced modeling techniques, it is possible to minimize, but not completely eliminate the errors arising from this layer.

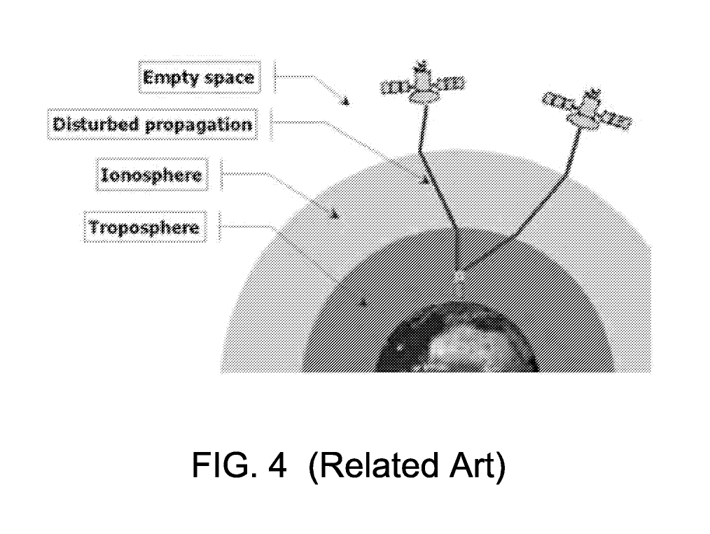

FIG. 4 shows schematically propagation of radio waves through the Earth's atmosphere according to certain embodiments of the present invention. FIG. 4 shows how the various layers of the atmosphere contribute to the delay of the radio signal from satellite to receiver [24].

### Relativistic Effects

Einstein's Theory of Relativity is an omnipresent, but often overlooked concept that becomes quite apparent in terms of GPS satellites and signals. In general, it states that time runs more slowly for objects experiencing fast motions when viewed from a slower-moving frame of reference (or conversely, time runs faster for slower-moving objects). GPS satellites move at a speed of 3,874 m/s relative to the Earth, causing their clocks to run more slowly than the clocks on Earth. The amount of time dilation experienced at these speeds causes clock inaccuracies of approximately 7.2 microseconds per day [24]. Additionally, the theory states that time runs more quickly for clocks experiencing lower gravitational potentials. The satellites orbiting ˜20,000 km above the Earth experience four times less gravity than our Earth clocks, resulting in an apparent time speedup of about 45 microseconds per day. These two effects negate each other, resulting in the appearance that satellite clocks are running 38 μs a day faster than clocks on Earth [58].

The architects of GPS decided to overcome these effects by adjusting the satellite clock frequencies from the nominal 10.23 MHz to 10.22999999543 MHz prior to launch. When radio signals are transmitted at this frequency, they appear, on average, to arrive on Earth at the nominal frequency of 10.23 MHz, and the satellite clocks stay synchronized to GPS time as viewed from an Earth frame of reference [23]. Although this adjustment allows satellite clocks to remain synchronized and removes the bulk of the relativistic error, there still exists a small clock deviation due to the fact that satellite orbits are slightly elliptical, meaning both their speeds relative to the Earth and their gravitational potentials change as a periodic function of their locations in orbit. Left uncorrected, these relativistic effects can contribute a maximum of 70 ns of clock error (21 m in range) to the observations. Luckily, these effects can be almost completely eliminated by compensating the received clock time according to:

Δtᵣ=Fe\sqrt{a} sin Eₖ (14)

where all parameter values are either constant or transmitted by the satellite with:

F=−4:442807633×10⁻¹⁰ s/m^{1/2}

e=satellite orbital eccentricity

a=semimajor axis of the satellite orbit

Eₖ=eccentric anomaly of the satellite orbit

There also exists another relativistic effect known as the Sagnac effect due to rotation of the Earth during the time of signal transmission[4]. Once a GPS signal leaves a satellite, it must travel a finite amount of time before it reaches a receiver. Since the Earth is rotating during this time, the propagation time (and hence the raw observations) will either grow or shrink as the receiver rotates away from or toward the incoming signal. If the receiver and satellite positions were calculated in a non-rotating Earth-Centered Inertial (ECI) frame, this would not cause a problem since the calculated satellite positions at the time of transmission would not rotate with the Earth and therefore would be the correct distance from the receiver. In the GPS, however, satellites transmit their ephemeris data to allow users to calculate their positions in an Earth-Centered, Earth-Fixed (ECEF) coordinate frame which rotates along with the Earth. As such, the calculated satellite position will be in terms of the rotated receiver position at the time of signal reception instead of at the time of signal transmission, regardless of the fact that the pseudorange observable will be based on the full propagation time.

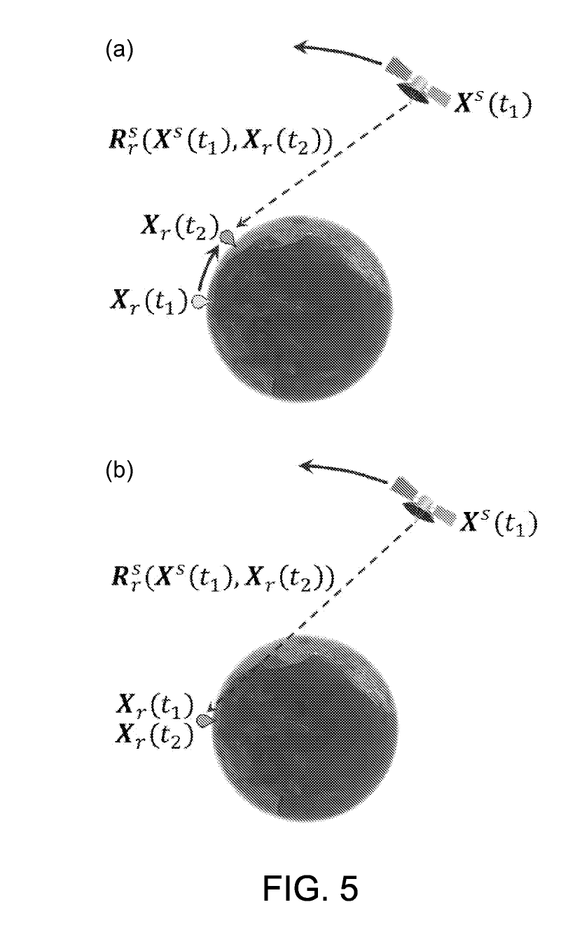

FIG. 5 shows the Sagnec effect according to certain embodiments of the present invention, where (a) shows the ECI frame, and (b) shows the ECEF frame. As shown in FIG. 5(a), in the ECI Frame, since the coordinate system is fixed in space, the receiver position, Xᵣ(t₁), at the time of signal transmission, t₁, is not equal to its position, Xᵣ(t₂), at the time of signal reception. Further, as shown in FIG. 5(b), in the ECEF Frame, since the coordinate system rotates with the Earth, the receiver positions at the time of signal transmission and reception appear identical, Xᵣ(t₁)=Xᵣ(t₂). Since the ECEF coordinate system rotates along with the Earth, it is clear from FIG. 5(b) that the signal propagation range from satellite to receiver, Rᵣ^{s}=∥X^{s}(t₁)−Xᵣ(t₂)∥, computed under the assumption that the coordinate system has remained stationary between t₁ and t₂ will be incorrect and will not coincide with the observed pseudorange and carrier phase measurements. In order to account for this problem, the user must correct the computed satellite positions for the amount of rotation the receiver experienced during the time of signal transmission. Corrections for this effect are commonly referred to as Earth rotation corrections and a number of algorithms exist for computing them. Left uncorrected, the Sagnac effect can contribute to satellite position errors on the order of 30 m, so this type of effect cannot be ignored.

### Dual-Receiver Error Sources

There exist several subtleties regarding the Sagnac effect that do not seem to appear in literature at this time of writing, stemming from the fact that the Earth continues to rotate in the presence of time delay errors such as atmospheric perturbations or clock biases:
1. Most Earth rotation corrections are calculated using pseudorange observations that include two types of errors: signal propagation errors (which directly affect the actual transit time of the satellite signal) and time bias errors (which appear in the measurement observation but are not due to physical signal delays). Due to the bias errors, we cannot know the exact time of reception of the satellite signals, which means we do not know the real propagation time of the signal, and hence cannot accurately estimate how far the Earth has rotated during this time.
2. In the two-receiver case, if measurements are made at two slightly different times, the satellite positions at the time of each signal transmission will have actually been different.
3. Also in the two-receiver case, the change in satellite positions during any measurement time discrepancy will result in an error analogous to the motion of the receivers described earlier in this section; namely, the signal propagation times will have been different, and thus, the Earth will have experienced differing amounts of rotation.

Due to these subtleties, two receivers making observations at apparently the same time (according to their local clocks) may calculate satellite positions that are up to −9 m apart from one another. In reality, these combined error sources typically amount to 1-3 meters of error per satellite observation.

Ideally, we'd like to take the satellite geometry \snapshots” according to both receivers and extrapolate the measurement data to correspond to what the observations and satellite positions should have been if taken exactly at the GPS epoch in the absence of any clock errors. Unfortunately, this requires a slight increase in computational complexity, and extrapolation of measurement data to a specific reception time is not quite as simple as it may seem, as shown in the next subsection.

### Data Conditioning and Extrapolation

The optimal way to overcome the error subtleties arising from the two-receiver case is to extrapolate the data from two or more receivers to the exact common point in time when the receivers should have made their measurements, namely the GPS epoch. In order to begin the extrapolation procedure, it is necessary to first determine the clock bias of each receiver so that we know how far forward or backward to extrapolate the data. This step can be as simple as solving for the standalone 3D position and bias of each receiver using a simple least-squares optimization routine as described in [23].

Once the receiver clock bias is known, the obvious next step would be to simply rotate each of the receivers' coordinate frames and data sets to coincide with the nominal GPS epoch. This will not result in a satisfactory solution however, especially in the multiple receiver case, because although the receivers themselves can be rotated into a cohesive frame, the satellite positions do not “rotate” with the Earth, but rather follow their own orbits. This means that errors due to the discrepancies between satellite positions at actually different transmit times will still be present. Additionally, the amount of Earth rotation experienced during the measured signal propagation interval cannot be assumed to be identical to the amount of rotation that would have been experienced at the extrapolated time.

In order to correctly extrapolate the data, we need to determine the change in signal propagation time (and by extension, the propagation range, Rᵣ^{s}) if the measurement had been made correctly at the GPS epoch. Fortunately, the instantaneous change in range can be inferred quite accurately using the Doppler shift observable (necessarily computed by all GPS chips), which directly indicates the line-of-sight range rate between a satellite and receiver at any given time:

ΔRᵣ^{s}(t)=*λ_{L1}*τ_{bias} (15)

where f_{D}^{s}(t) is the instantaneous Doppler frequency to satellite s reported by the receiver at time t, λ_{L1} is the vacuum wavelength of the carrier signal, and τ_{bias} is the receiver clock bias from GPS system time. Assuming a Doppler shift accuracy of ±1 Hz, this change in range is guaranteed to be accurate to better than 191 μm.

The pseudorange and carrier range observations to any given satellite can then be extrapolated to the exact GPS epoch by simply adding the ΔRᵣ^{s}(t) correction term to each observable. Likewise, it is trivial to track a receiver's clock bias through time to determine its rate of change, also known as the clock drift. Using this drift value, we can extrapolate the local clock bias to the GPS epoch via:

τ′_{bias}=τ_{bias}*(1+τ_{drift}) (16)

τ_{bias}^{f} can be used to determine signal reception time according to the receiver's local clock if the observations had been made correctly at the GPS epoch.

Since we now know both the correct receiver clock bias and what the measurement observables should have been, we can calculate the time when a signal received at the exact GPS epoch would have been transmitted, and thereby also the corresponding correct satellite positions, X^{s}, and Earth rotation corrections corresponding to the extrapolated epoch.

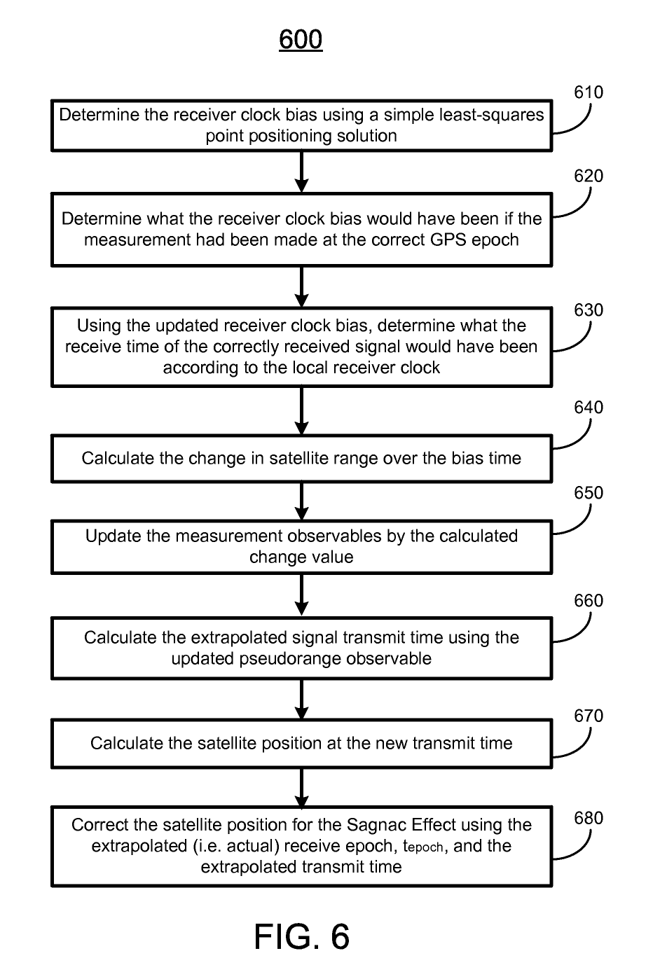

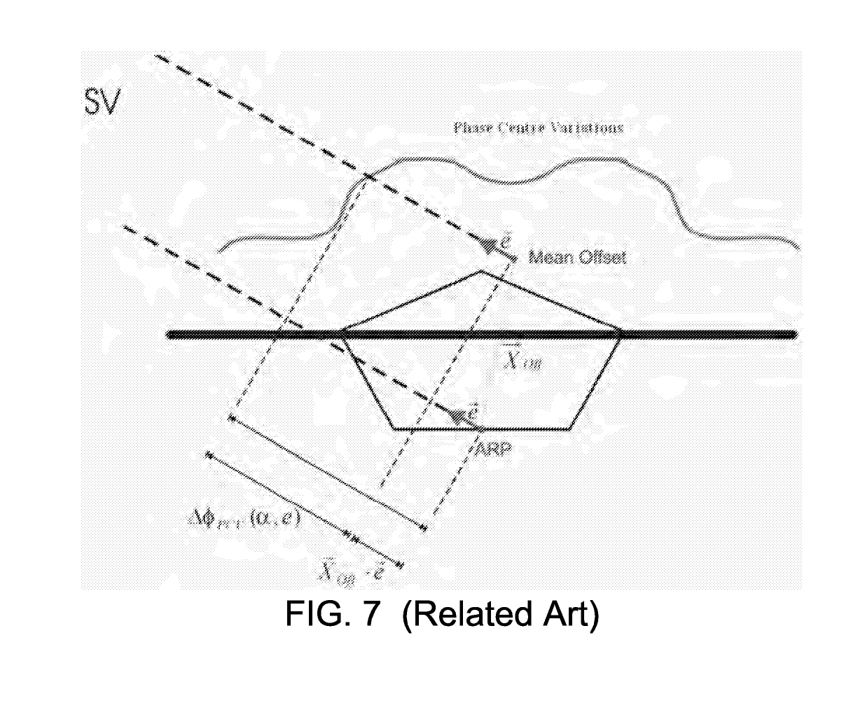

FIG. 6 shows a flowchart of the GPS extrapolation procedure according to certain embodiments of the present invention. As shown in FIG. 6, at step 610, the receiver clock bias τ_{bias} is determined using a simple least-squares point positioning solution. This bias is equal to the time difference between the desired measurement time and the actual measurement time. At step 620, the receiver clock bias τ_{bias} is used to determine what the receiver clock bias would have been if the measurement had been made at the correct GPS epoch according to Equation 16 of τ′_{bias}=τ_{bias}*(1+τ_{drift}).

At step 630, the updated receiver clock bias is used to determine what the receive time of the correctly received signal would have been according to the local receiver clock by the equation of T′ᵣₓ=t_{epoch}+τ′_{bias}. At step 640, the change in satellite range over the bias time is calculated using the Equation (15) of ΔRᵣ^{s}(t)=−f_{D}^{s}(t)*λ_{L1} τ_{bias}. At step 650, the measurement observables are updated by the calculated change value ΔRᵣ^{s}(t).

At step 660, the extrapolated signal transmit time is calculated using the updated pseudorange observable Pᵣ^{s}(T′ᵣₓ). Specifically, as shown in FIG. 2, the extrapolated signal transmit time t′ᵣₓ may be obtained by the Equation of

$${t}_{rx}^{′} = {T}_{rx}^{′} - \frac{{P}_{r}^{s} ( {T}_{rx}^{′} )}{c} .$$

At step 670, the satellite position at the new transmit time t′ᵣₓ is calculated. At step 680, the satellite position is corrected for the Sagnac Effect using the extrapolated (i.e. actual) receive epoch, t_{epoch}, and the extrapolated transmit time.

The algorithm as described in FIG. 6 can be used to extrapolate both satellite observations and satellite positions to the GPS epoch with μm accuracy. This can be verified by examining the apparent satellite positions according to two co-located receivers at the same time epoch and noting that the positions should be identical.

### Antenna Phase Center Offsets

Another problematic source of error arises from both the type of antenna used to receive the GPS signals, as well as the specific antenna itself, since small manufacturing anomalies can impact the characteristics of this error source. The problem arises from the fact that the electrical phase center (i.e. the location where the GPS signals are received and collected by the antenna) does not usually coincide with the geometric center of the antenna, also known as the Antenna Reference Point (ARP) [18].

Compounding this problem is the fact that the signal collection point varies based on the direction (azimuth and elevation) of the incoming signal. The average of all of the signal collection points for all possible signal directions is called the mean electrical phase center, or more commonly the phase center offset. This value can range from a few millimeters to several centimeters. The individual, instantaneous offsets used to calculate the mean phase center are called Phase Center Variations (PCV), which is shown as ΔØ_{PCV}(α,e) in the antenna phase center offsets and variations in FIG. 7 [60], and are usually larger than the mean electrical phase center.

The carrier phase observable can be corrected for antenna phase center offset as a function of satellite azimuth, a, and elevation, e, according to the following formula:

Δε_{φ}(α,e)=ΔØ_{PCV}(α,e)+\vec{X_{off}}×\vec{ε_{α,e}} (17)

Unfortunately, the only way to find the phase center offset and PCVs for an antenna is by experimentation. Most receiver manufacturers will report a tolerance range for phase center offset, and some receivers actually have pre-calculated offset tables based on empirical data from extremely large sample sets [53].

While phase center offsets and variations can potentially introduce measurable amounts of error into the raw observations, the majority of error manifests itself in the height component of the location estimate. Therefore, this type of error is much more important to consider when calculating 3D positions. Additionally, antennas of the same type from the same manufacturer tend to have similar mean phase center offsets, so using the same antenna for relative positioning will result in more accurate results than mixing a variety of antenna types [18].

### Multipath

One of the most serious and difficult-to-remedy errors in GPS receiver measurements is due to a phenomenon called multipath. Multipath occurs when satellite signals (which are transmitted in all directions) reflect off of objects nearby to the receiver, causing identical radio signals to be picked up one or more time instants after the correct line-of-sight signal has already reached the receiver. The magnitude of these additional signals varies greatly depending on the specific environment, but they can arise from any reflective surface such as trees, buildings, people, or even the ground.

The reason these signals are so hard to deal with is because they are not only time-dependent, but also receiver-, azimuth-, and elevation-dependent. As long as the multipath delay is large and the reflections arrive a measurable length of time greater than the PRN code period, the receiver can detect and discard the erroneous signals (since it is already locked onto and tracking the correct, direct signal, and erroneous signals will appear inconsistent). If, however, the multipath delay is short and unresolvable, it will distort the autocorrelation function between the received composite signal and the locally generated one, as well as the composite phase of the incoming signal, causing unpredictable errors in both the pseudorange and carrier phase [23].

Typical 1-sigma multipath error values in a benign environment average about 2 cm for the carrier phase measurement and 20 cm for the pseudorange. These are reasonable values; however, as the environment degrades with the addition of reflective surfaces, the pseudorange error can reach a maximum of one full PRN code length (293 m). It is important to note that multipath errors affect the carrier phase significantly less than the pseudorange, with maximum errors topping out around 5 cm [13].

### Carrier Cycle Slips

A GPS receiver will fail to return a pseudorange observable if the satellite signal is dropped for any amount of time causing the PRN autocorrelation function to diverge. This is known as a loss of lock, and it is easily detectable by any GPS receiver. Far more difficult to detect are minute losses of the satellite carrier signal which are regained quickly enough that the PRN code can still be detected and correlated. In this case, the autocorrelation function continues to produce a result, and the receiver does not know that any problem has occurred.

This problem manifests itself exclusively in the carrier phase observable (which is supposed to indicate the number of carrier wavelengths between a satellite and receiver). Since one full wavelength is equal to about 19 cm, a \cycle slip” of only five cycles will produce almost a full meter of error in the carrier range observable. For this reason, it is imperative that GPS localization software keep track of the carrier phase observable and try to detect any cycle slips. Numerous methods for doing this exist [15, 48], including monitoring the Doppler shift and predicting what the carrier phase observable should be at the next epoch assuming linearly smooth satellite motion between consecutive measurements.

If a cycle slip is detected, the GPS receiver can either attempt to fix the slip by inserting the correct number of cycles, or it can simply discard the observations for that satellite until the signal has regained a steady state.

### Receiver Measurement Noise

The main sources of error inherent to the GPS receiver itself include thermal noise jitter and interference effects on the receiver tracking loops. Experiments have shown the 1-sigma error on pseudorange measurements due to receiver noise to be less than a decimeter, while the 1-sigma error on carrier phase measurements is approximately 1.2 mm [23].

### Observation Models and Positioning Techniques

As discussed above, the various measurement observables that are output and used by GPS receivers are provided, and the possible sources of error that corrupt these observables, as well as ways by which they may be mitigated, are also provided. The synthesis of these two aspects results in the creation of observation models which allow us to see how manipulating and combining the observations can result in accurate methods of localization.

### Single Point Positioning Model

The simplest and most basic set of observation models is used primarily in standalone, point-positioning algorithms, providing absolute coordinates for a single receiver anywhere on Earth. This is the default operating paradigm for GPS, and all other observation models stem from it. In general, these modeling equations attempt to assign geometric error contributions to each of the sources of error as discussed above to determine their total impact on each of the pseudorange and carrier range observations, and by extension, the User-Equivalent Range Error (UERE) resulting from use of these observations in a point positioning algorithm.

### Pseudorange

A full pseudorange observation model is a direct extension of the generalized pseudorange equation as provided above, plus the error sources:

Pᵣ^{s}(t)=ρᵣ^{s}(t)+cτᵣ(t)−cτ^{s}(t)+dᵢₒₙₒ^{s}+dₜᵣₒₚₒ^{s}+M_{r,P}^{ss}(t)+ε^{s}+εₚ(t) (18)

where:

ρᵣ^{s} (t) is the geometric range from satellite to receiver at time t;

cτᵣ(t) is the pseudorange error due to receiver clock bias at time t;

cτ^{s}(t) is the pseudorange error due to satellite clock bias at time t;

dᵢₒₙₒ^{s} is the error due to ionospheric delay;

dₜᵣₒₚₒ^{s} is the error due to tropospheric delay;

M_{r,P}^{s} (t) is the pseudorange error due to multipath at time t;

ε^{s} is the error due to satellite orbital offsets; and

ε_{P}(t) is the pseudorange error due to receiver noise at time t.

It should be noted that the satellite orbital errors and atmospheric delay terms are modeled as constants in the equation above. Since satellite position is calculated according to a set of smooth Keplerian models, any instantaneous orbital errors will change extremely slowly over time such that they can be viewed as constants for each satellite over relatively long intervals.

The atmospheric delay terms also depend loosely on time; however, they change very slowly (with temporal correlations up to 50 minutes long), so that they can be modeled as constants from one epoch to the next [14]. This is significant because it allows for equation differencing through time to eliminate these types of errors. It must always be kept in mind that although epoch-to-epoch differencing virtually eliminates these errors, differencing over more significant amounts of time results in less and less of the error being removed. It should also be noted that the atmospheric delay terms are not dependent on a specific receiver as long as multiple receivers are located in a geographically similar region. Receivers with baselines shorter than 200 km under very disturbed atmospheric conditions or up to 1000 km under ideal conditions experience negligible atmospheric delay differences relative to one another and can be assumed to be identical [14].

Finally, any antenna phase center offsets are also neglected in this model since they are introduced solely by the manufacturing processes used to create the antenna and can be resolved or minimized by carefully matching the antenna to the application for which it is most suitable.

### Carrier Range

Again, a better model for the carrier range, including the generalized equation of the carrier range and the error sources, is provided as below. It is important to note the similarities of this model to that of the pseudorange:

Lᵣ^{s}(t)=ρᵣ^{s}(t)+cτᵣ(t)−cτ^{s}(t)+λBᵣ^{s}−dᵢₒₙₒ^{s}+dₜᵣₒₚₒ^{s}+M_{r,L}^{s}+ε^{s}+ε_{L}(t) (19)

where:

ρᵣ^{s} (t) is the geometric range from satellite to receiver at time t;

cτᵣ (t) is the carrier range error due to receiver clock bias at time t;

cτ^{s}(t) is the carrier range error due to satellite clock bias at time t;

λBᵣ^{s}≡λ(Øᵣ(t₀)−Ø^{s}(t₀)−Nᵣ^{s}) is the range ambiguity at the time of satellite lock;

dᵢₒₙₒ^{s} is the error due to ionospheric delay;

dₜᵣₒₚₒ^{s} is the error due to tropospheric delay;

M_{r,L}^{s}(t) is the carrier range error due to multipath at time t;

ε^{s} is the error due to satellite orbital offsets; and

ε_{L}(t) is the carrier range error due to receiver noise at time t.

The main differences in this model versus the pseudorange model are the additional satellite range bias term, λBᵣ^{s}, and the opposite sign for the ionospheric delay term, dᵢₒₙₒ. The satellite range bias term was defined and explained above, and the reason for the ionospheric sign inversion is ionospheric divergence as discussed above. To reiterate, the magnitude of errors due to multipath and receiver noise are much lower for carrier range observations than for the pseudorange.

### Absolute Localization

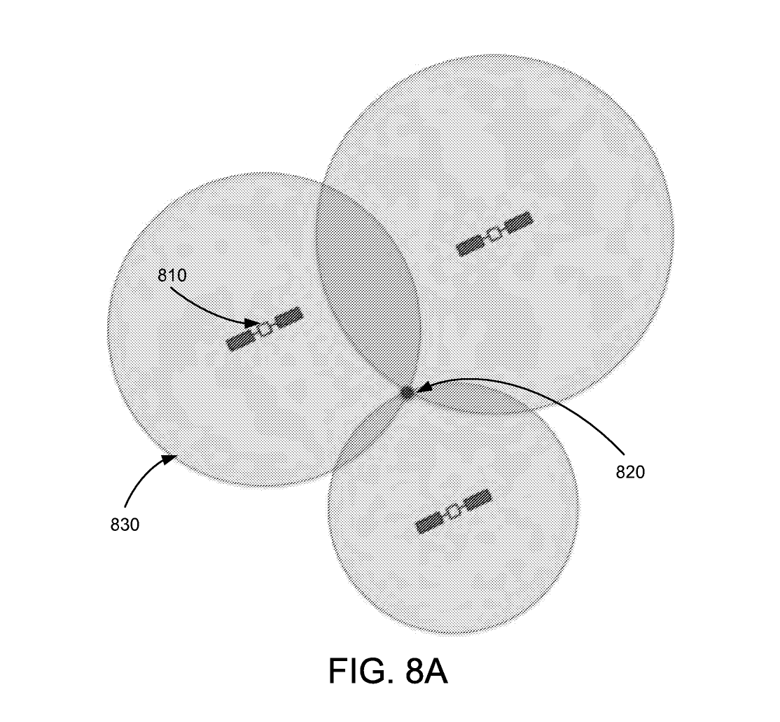

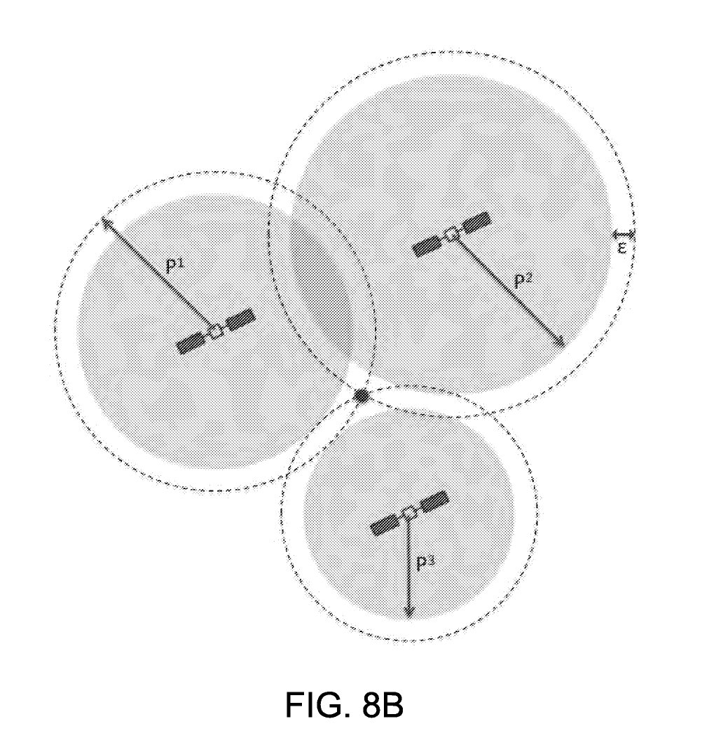

In general, the standalone carrier range model is rarely used by itself for localization of a single GPS receiver. Instead, the error terms described above are minimized in the pseudorange equation as much as possible, and localization is carried out using a mathematical concept called trilateration [22]. The idea behind trilateration is simple: it is possible to determine the coordinates of an arbitrary reference point in space given a set of position coordinates and their respective distances from the reference. Geometrically, this can be modeled by finding the single intersection point of a number of spheres with known center coordinates (satellite positions) and radii (ranges). FIG. 8A shows schematically ideal localization using trilateration where the sensor positions are precisely known according to certain embodiments of the present invention. As shown in FIG. 8A, when the satellite positions 810 are precisely known, the single intersection point 820 of a number of spheres 830 may be obtained.

However, all pseudorange observations for a given epoch will have a uniform error component due to the receiver's local clock offset from GPS time. As such, the reported pseudorange values cannot be used simply as actual satellite ranges in the trilateration procedure described above. Any amount of range error will result in a set of spheres centered around each of the satellites that do not intersect at exactly one and only one point. In fact, depending on the satellite geometry, the spheres may not intersect at all.

One further complication arises from the fact that pseudoranges contain errors not only due to receiver clock bias, but also all of the errors as discussed above, with the full model described by Equation 18. Even taking into account all other sources of error, the receiver clock bias dominates with the potential for up to 300 km of error. As such, it is always modeled as a fourth localization parameter. The remaining errors usually account for anywhere between 10 to 20 meters of error per pseudorange observation [13]. For this reason, the spheres of potential receiver locations around each satellite will generally not intersect at only one point; however, there will tend to be a large number of intersections focused around a central area which define a region of possible receiver locations. Assuming that we have already corrected the pseudorange observations for any additional sources of error excluding the uniform receiver clock bias, the equation representing pseudorange is:

Pᵣ^{s}=ρᵣ^{s}+cτᵣ=\sqrt{(X^{s}−xᵣ)²+(Y^{s}−yᵣ)²+(Z^{s}−zᵣ)²}+cτᵣ (20)

FIG. 8B shows schematically ideal localization using trilateration with receiver clock error according to certain embodiments of the present invention. For n satellites, we will have n pseudorange observations (Pᵣ¹, Pᵣ², . . . Pᵣⁿ) with 4 unknowns (xᵣ, yᵣ, zᵣ, and cτᵣ). Therefore, as shown in FIG. 8B, by adding a fourth dimension to the intersection of spheres model, namely the time offset (ε=cτᵣ), it is once again possible to find a common intersection point.

### Dual-Receiver Baseline Models

While single point positioning is a necessary and well-studied area of GPS, recent research has led to advances in a much more accurate realm of GPS localization techniques known as relative positioning. As the name indicates, relative positioning consists of localizing one or more GPS nodes relative to either a reference node or to one another. In general, this equates to solving for the so-called baselines between pairs of receivers. Since we are now dealing with applications involving the relative locations between two or more nodes, additional sets of modeling equations have been developed to more accurately remove many of the errors that dictate the highest level of accuracy achievable by single point positioning techniques.

As in point positioning, the most basic form of relative positioning involves simple manipulation of the primary measurement observables: the pseudorange and carrier range. The primary way in which these observables are used in relative positioning is through a manipulation of the observations known as differencing. As the name implies, the differencing operation quite literally takes the difference between two observations (and their corresponding models) to eliminate some of the common error sources present in both observations. There are three commonly accepted differencing variations—single, double, and triple-differencing—corresponding to the number of subtraction operations used in the model, as well a new model introduced in this dissertation called “temporal double-differencing.” Each of these models can be used to eliminate a different set of error sources in the ranging signals while magnifying others.

Single-Differencing Model

The most simple differencing operation, called “single-differencing” or “between-receivers differencing,” involves subtracting the observations (either carrier range or pseudorange) from two different receivers, j and k, to the same satellite, s, for a single time epoch [55]. Mathematically, this results in the following models (where we have combined the multipath and measurement noise terms into a single error, εᵣ^{s}, since they are practically inseparable from one another):

$$\begin{matrix}Δ {P}_{jk}^{s} = {P}_{k}^{s} - {P}_{j}^{s} \\ = ( {ρ}_{k}^{s} - {ρ}_{j}^{s} ) + c ( {τ}_{k} - {τ}_{j} ) + ( {ε}_{P , k}^{s} - {ε}_{P , j}^{s} ) \\ = Δ {ρ}_{jk}^{s} + c {Δτ}_{jk} + Δ {ε}_{P , jk}^{s}\end{matrix} \\ \begin{matrix}Δ {L}_{jk}^{s} = {L}_{k}^{s} - {L}_{j}^{s} \\ = ( {ρ}_{k}^{s} - {ρ}_{j}^{s} ) + c ( {τ}_{k} - {τ}_{j} ) + λ ( {B}_{k}^{s} - {B}_{j}^{s} ) + ( {ε}_{L , k}^{s} - {ε}_{L , j}^{s} ) \\ = Δ {ρ}_{jk}^{s} + c {Δτ}_{jk} + λΔ {B}_{jk}^{s} + {Δε}_{L , jk}^{s}\end{matrix} \qquad ( 21 )$$

It should be noted that many of the error sources present in observation model Equations 18 and 19 are not present in the single-differenced model as shown in the Equation 21, including satellite clock errors, orbital errors, ionospheric delay, and tropospheric delay. Since these errors are satellite and/or location-dependent, they completely cancel out when two observations to the same satellite in the same geographic region are differenced [17].

A set of single-differenced pseudorange observations can be used in a linear least squares solver in much the same way as the zero-differenced (raw) observations are used in point positioning. Assuming that one of the participating receivers, j, in the single-differenced model is static and its location is precisely known, the unknowns are the roving receiver's 3D coordinates and the relative clock bias between the two receivers (ignoring any unmodeled errors, due to receiver noise or multipath); thus, a pseudorange solver breaks down identically to the one in Equation 20 with the exception that we are now solving for the pseudorange difference instead of the pseudorange outright.

It should be noted that although many observation errors have been accounted for, all of the receiver-specific error sources (such as receiver clock bias, receiver phase offset, etc.) are still present in the signal. Unfortunately, some of these errors are more difficult to model and have a much larger impact on the final result than satellite-specific errors. Additionally, there is still an ambiguity term in the single-differenced carrier range model, which means that, once again, it is not useful in directly solving for receiver location.

### Double-Differencing Model

Double-differencing, also known as “between-satellites differencing,” is a direct extension of the single-differenced model described in the previous sub-section. Literally, it consists of taking the difference between two single-differences [55]. Mathematically, this equates to finding the difference between two receivers' observations to a single satellite, repeating this for a second satellite, and then taking the difference between these two results. This is an extremely useful error-minimizing operation and is actually considered to produce the strongest solution when used in existing localization techniques.

As discussed above, the full equations for single-differenced pseudorange and carrier range are:

$$Δ {P}_{jk}^{s} = {Δρ}_{jk}^{s} + c {Δτ}_{jk} + {Δε}_{P , jk}^{s} \\ \begin{matrix}Δ {L}_{jk}^{s} = Δ {ρ}_{jk}^{s} + c {Δτ}_{jk} + λΔ {B}_{jk}^{s} + {Δε}_{L , jk}^{s} \\ = {Δρ}_{jk}^{s} + c {Δτ}_{jk} + λ ( {Δφ}_{jk} ( {t}_{0} ) - Δ {N}_{jk}^{s} ) + {Δε}_{L , jk}^{s}\end{matrix} \qquad ( 22 )$$

The ambiguity term has been expanded in the single-differenced model for carrier range. This is to illustrate that the ambiguity includes a fractional portion that is receiver-specific, just like the receiver clock bias. By double-differencing the observations to two different satellites, m and n, as described above, we can not only eliminate all error sources originating from the satellites, but all receiver-side errors as well [23]:

$$\begin{matrix}Δ ∇ {P}_{jk}^{mn} = Δ {P}_{jk}^{n} - Δ {P}_{jk}^{m} \\ = Δ ∇ {ρ}_{jk}^{mn} + Δ ∇ {ε}_{P , jk}^{mn}\end{matrix} \\ \begin{matrix}Δ ∇ {L}_{jk}^{mn} = Δ {L}_{jk}^{n} - Δ {L}_{jk}^{m} \\ = Δ ∇ {ρ}_{jk}^{mn} + λΔ ∇ {N}_{jk}^{mn} + Δ ∇ {ε}_{L , jk}^{mn}\end{matrix} \qquad ( 23 )$$

In these equations, notice that the only remaining error sources are the unmodeled effects including receiver noise, multipath, and antenna phase center offset which are usually ignored. Even more importantly, note that only the integer portion of the ambiguity term remains. This is an extremely useful property in that it adds an integer constraint to the unknown observation ambiguities, re-framing the problem to include so-called integer ambiguities that are unknown but constant through time.

These equations are used as the basis for many relative positioning algorithms. It is important to note that with an arbitrary number of satellites and receivers, there are many more double-differenced observation possibilities than there are raw satellite observations. Since it is impossible to create more information than we started with, it can be seen that a large number of the possibilities are actually linear combinations of one another [5]. As such, they provide no useful information and should be excluded from processing.

In order to ensure that we only include observations which are linearly independent, we introduce the concepts of a reference receiver and a reference satellite. Quite simply, these reference nodes form the basis for all double-differencing operations for a single epoch. By differencing all satellite observations from a single reference satellite and all receiver observations from a single reference receiver, we ensure that the resulting double-differenced set contains only linearly independent observations [5]. Of course, the best results will be achieved if we use references with the highest quality data, since any unmodeled errors in the reference observations will be included in all double-differenced observations, resulting in a potential bias [5]. By choosing the reference node to be the least likely to include significant error, we ensure that random errors in the non-reference observations will only affect one double-differenced observation apiece.

The best way to choose a reference receiver is to pick the node that is closest to the center of a set of nodes being localized, with the fullest, clearest view of the sky possible to increase satellite visibility and minimize multipath. Likewise, the best choice of reference satellite is the satellite with the highest elevation in the sky. Not only is this satellite the most likely to be visible to all receivers, but it is also guaranteed to experience the least amount of multipath and the least amount of atmospheric delay since it has the most direct line of sight to all receivers and the least amount of atmosphere to traverse [5]. One key thing to keep in mind when choosing a reference satellite, however, is that the satellite constellation is constantly moving, meaning that over time, a better reference satellite may come into view or the current reference satellite may lose its line of sight. When this occurs, any currently fixed integer ambiguities are no longer valid and must be transformed for the new reference satellite. Luckily, this is a fairly trivial operation solved by many existing algorithms.

### Triple-Differencing Model

The final differencing model, triple-differencing, is, again, a direct extension of the double-differencing techniques just described. It is a temporal continuation in which two double-differences from the same two satellites and receivers but two different measurement epochs, usually consecutive, are subtracted [55]. This is almost never performed on pseudorange observables but is mainly a carrier range operation. Its purpose is to completely remove the ambiguity term from the carrier range model. The difference between two consecutive double-differenced observations will result in:

$$\begin{matrix}Δ ∇ Δ {L}_{jk}^{mn} = Δ ∇ {L}_{jk}^{mn} ( t ) - Δ ∇ {L}_{jk}^{mn} ( t - 1 ) \\ = Δ ∇ {ρ}_{jk}^{mn} ( t ) - Δ ∇ {ρ}_{jk}^{mn} ( t - 1 ) + \\ Δ ∇ {ε}_{L , jk}^{mn} ( t ) - Δ ∇ {ε}_{L , jk}^{mn} ( t - 1 ) \\ = Δ ∇ {Δρ}_{jk}^{mn} + Δ ∇ {Δε}_{L , jk}^{mn}\end{matrix} \qquad ( 24 )$$

This equation includes no error sources, ambiguities, or unknowns other than the change in double-difference and the change in unmodeled errors (receiver noise and multipath) over time. As such, it provides a direct way to solve for the baseline between two receivers using only carrier ranges.

There are three reasons why this type of differencing is not used exclusively in relative localization. The first and most obvious is because the model, by nature, requires that the two receivers remain completely static for as long as the triple-differencing is carried out. Since only one baseline is being estimated over multiple epochs, the baseline cannot change. As such, it is not suitable as a long-term solution for any sort of mobile receiver deployment.

The second reason is because some of the “unmodeled errors” may actually be multiplied by this operation. Note that in both the single- and double-differenced models, the solutions are based on observations from a single epoch; thus, unmodeled sources of time-variant error (such as multipath) do not introduce error correlations into the estimated solutions, but rather appear more like noise in the models [7]. In the triple-differenced model, however, changes in the observables are measured based on position over time. Therefore, although location-specific errors (such as atmospheric delay) and clock-specific errors (such as clock bias) cancel out, errors based on both location and time do not. This is because multipath is not identical (or even similar) for two different receivers, the same receiver and two different satellites, or the same receiver-satellite pair at two different times [46]. In other words,

The final and most important reason this model cannot be used alone is because by carrying out triple-differencing, the change in double-differences are measured, and thus, the change in relative satellite-receiver geometry over time. In other words, localization is now based on a change in geometry instead of the actual geometry itself. Since these changes happen quite slowly relative to the measurement interval, most of the geometric localization information is lost [49], and a weaker geometry results in less accurate position estimates. Therefore, this situation is not ideal for baseline determination.

Instead, triple differencing is usually used for either a very course-grained initial baseline estimate or for detecting time-based errors, such as cycle slips. We have shown that, assuming the integer ambiguities in the carrier range model are constant over time, they completely cancel out in the triple-differencing operation. Therefore, by keeping track of the triple-differences over time, any changes should occur slowly and linearly. If a cycle slip occurs, the integer ambiguity for that satellite will lose consistency, causing a dicontinuity; therefore, a \spike” will be present in the triple-differenced output. In such a way, these types of observations are quite useful for conditioning data to make sure that no inexplicable errors or cycle slips have occurred before passing the data to a more accurate and robust localization method.

### Temporal Double-Differencing Model

Although the double-differencing model is generally regarded as providing the strongest baseline solution from a geometric point of view, it has some limitations. These include:
Correlated errors present in every data observation due to the use of a reference satellite that is unlikely to be completely error-free,
The necessity of solving for a set of ambiguity terms that are dependent on satellite, receiver, and reference satellite, which is a complex and relatively slow process,
Problems whenever the tracking lock to a reference satellite is lost, since any integer ambiguities that have been solved for are only valid with respect to the given reference satellite, requiring either large data transformations or even re-initialization of the localization procedure, and
The requirement that the receivers remain stationary while the ambiguity fixing process is being carried out (if using carrier ranges), which can take a significant amount of time.

Keeping these shortcomings in mind, certain aspects of the present invention introduce an additional observation model called the “temporal double-differencing model” which is a time-based extension of the single-differencing model. Recall the single-differenced observation equations (here marked to indicate their dependence on time):

ΔPⱼₖ^{s}(t)=Δρⱼₖ^{s}(t)+cΔτⱼₖ(t)+Δε_{P,jk}^{s}(t)

ΔLⱼₖ^{s}(t)=Δρⱼₖ^{s}(t)+cΔτⱼₖ(t)+λΔBⱼₖ^{s}(t)+Δε_{L,jk}^{s}(t) (25)

In these equations, the correlated errors due to a reference satellite are not present, nor are the mathematical problems arising from the loss of such a reference satellite. In order to maintain these benefits, we avoid the introduction of any sort of reference satellite by differencing not through space, but through time (where V represents a temporal difference instead of a spacial one):

∇ΔPⱼₖ^{s}(∇t)=∇Δρⱼₖ^{s}(∇t)+c∇Δτⱼₖ(∇t)+∇Δε_{P,jk}^{s}(∇t)

∇ΔPⱼₖ^{s}(∇t)=∇Δρⱼₖ^{s}(∇t)+c∇Δτⱼₖ(∇t)+∇Δε_{L,jk}^{s}(∇t) (26)

We can see here that the carrier range model no longer includes an ambiguity term since it was constant through time. Additionally, the change in clock bias over time, cΔτᵣ(∇t), is known more commonly as the clock drift, typically denoted τ′ᵣ, and it is a much more stable value than the clock bias itself. As such, this temporal double-differencing model includes only the difference between the change in ranges of two receivers to one satellite over the course of one epoch and the difference between the two receivers' clock drifts, along with some amount of observation error. Substituting for the clock drift term and dropping the Vt-nomenclature for simplicity's sake, this results in:

∇ΔPⱼₖ^{s}(∇t)=∇Δρⱼₖ^{s}+c∇Δτⱼₖ+∇Δε_{P,jk}^{s}(∇t)

∇ΔPⱼₖ^{s}(∇t)=∇Δρⱼₖ^{s}+c∇Δτⱼₖ+∇Δε_{P,jk}^{s}(∇t) (27)

The similarity between these equations shows that we now have a model in which the two distinct satellite observation types can be used to represent the exact same thing, both geometrically and mathematically. This can be useful for data integrity verification (as in the triple-differencing model) or simply for replacing the observation values in pre-existing pseudorange-based techniques with the more accurate carrier range values, since they are created identically in this model. The carrier range equation shown above is unique in that it uses highly accurate carrier phase observations to produce unambiguous estimates of the change in relative ranges between a satellite and two receivers through time without requiring any sort of reference satellite or node.

### Relative Positioning Techniques

Using any number of techniques, the previously described differencing models can be utilized to determine the baseline between two or more receivers or to perform a type of localization known as relative positioning. As the name indicates, relative positioning consists of localizing one or more GPS nodes relative to either a reference node or to one another. It should be noted that relative positioning does not preclude results in an absolute geodetic coordinate space. On the contrary, most relative positioning techniques are simply a means by which to provide more accurate absolute receiver coordinates. This is usually achieved via prior knowledge of one or more node locations in an ECEF frame or, at the very least, the presence of at least one static node. Localization in the truly “relative” sense, with a network of roving receivers where none of the node positions are known a priori, is a much more recent development and describes the localization paradigm used by the new method in this dissertation.

### Differential GPS

The first set of techniques developed to increase the precision of relative positioning using GPS became known collectively as “Differential GPS,” or DGPS for short. In most cases, an algorithm is considered to be DGPS-based if it produces a baseline vector between two receivers in a situation where one “reference node” remains static at a location with previously determined coordinates and a second node roams freely around the reference [51, 16]. Relative DGPS techniques do not typically produce continuous position outputs, but rather require some amount of data aggregation and processing delay to achieve a solution. For stop and go techniques, in which the roving receiver must remain stationary at certain measurement points before moving on, these delays can range from 5-30 seconds. For continuous methods, the delay is only 0.5-5 seconds [16]. This differs from Real-Time Kinematic (RTK) positioning in which relative localization is carried out using carrier range measurements, with position outputs being produced in real-time [2].

DGPS is currently the status quo for high-precision surveying techniques with many commercial companies producing DGPS-based solutions [51, 9], not to mention a national DGPS system currently being implemented in the United States [26]. In most cases, a single reference node, sometimes called a beacon, will be erected in a pre-surveyed location with a clear view of the sky. The beacon will begin receiving satellite ranging signals and then retransmitting them to nearby receivers. Any number of mobile, roving nodes can be dispatched around the beacon to receive their own GPS ranging signals along with the ranging signals belonging to the beacon. In such a way, every node has two full sets of ranging data and a known reference position at every epoch. Using this information in a relative context, many of the large sources of error in the satellite ranging signals can be minimized or eliminated to produce a much more accurate baseline than would be possible using single point positioning techniques. Also, since the location of the reference beacon is precisely known, these baselines translate directly into absolute coordinates which makes DGPS an extremely attractive method for surveying.

There are, however, several caveats to using this type of methodology. The first and most obvious is the necessity of having a reference beacon with a precisely known location. It requires some amount of pre-planning and set-up time to find an acceptable location for such a beacon, as well as to allow the beacon to localize its own point position with a high enough accuracy that it can be used as a reference for the roving nodes. This makes it a bad choice or on-the-fly type applications which cannot tolerate long set-up and calibration times [16]. The second caveat is that data from multiple epochs are usually required to achieve the level of precision desired using these methods. As such, the roving receivers must remain stationary at each measurement point for a length of time in order to collect the appropriate amount of data for the specified method. Due to the stop-and-go nature of these types of methods, they are more suitable for applications that use GPS localization primarily as a surveying tool, such as feature mapping or boundary determination.

### Real-Time Kinematic (RTK) Positioning

A recent extension to standard DGPS methods which works well in highly dynamic and time-sensitive applications is Real-Time Kinematic (RTK) Positioning. This type of positioning represents a group of algorithms and solutions that use carrier range measurements from two (or more) receivers to provide real-time localization updates. While RTK can be viewed as a subset of DGPS, it is usually considered separately, with the main difference being that RTK algorithms are necessarily carrier-range based and always provide instantaneous and continuous receiver coordinates, whereas DGPS algorithms may only use pseudoranges and require post-processing, which precludes them from being used in strictly real-time scenarios. Further, the primary observable in DGPS methods is considered to be the pseudorange, because DGPS is concerned with minimizing correlated errors such that a more accurate absolute position can be estimated, and the primary observable in RTK is considered to be the carrier range with an emphasis on providing more accurate relative localization[30, 19, 16].

Since RTK primarily uses carrier ranges, the problem exists in that the carrier range model includes an unknown ambiguity term. In order to achieve the centimeter-level accuracy possible with this type of configuration, roving receivers need to be able to produce solutions that are ambiguity-fixed and double-differenced. As such, the main area of research in RTK positioning revolves around solving for the integer ambiguities in the double-differenced carrier range model. Since it is possible that the roving receivers may be in constant motion, this poses a particularly difficult problem when examining most of the “standard” ambiguity fixing algorithms in use today. In fact, it is such a problem that there still exists no real solution able to provide accuracies on par with those achievable if the roving receivers remain stationary during the ambiguity fixing process.

In the majority of cases, RTK algorithms will require an initial, short calibration phase during which the ambiguities can be unequivocally resolved. After that, the receivers are free to move anywhere they like, and assuming that at least three satellites retain their locks throughout the localization process, the accuracy is unlikely to degrade [16, 19]. If stationary calibration cannot be achieved, some algorithms make use of both the pseudorange and carrier range observables to resolve the ambiguities, leading to a time period of increasing accuracy as the solution algorithm transitions from a strictly ambiguity-float solution to an ambiguity-fixed solution.

It should be noted that the downside to DGPS and RTK algorithms alike is that they both presuppose the presence of a stationary reference node. The case where the locations of both nodes is unknown or, even worse, when the positions are unknown and both receivers may be moving, represents a realm of localization that has not yet been satisfactorily solved. The best approach in these cases at the time of writing is a so-called moving baseline method, in which two receivers are assumed to be in motion, and an RTK-like algorithm attempts to estimate the baseline vector between them at every time epoch [29, 27, 20]. Most current algorithms which fall under this heading are proprietary in nature, and there is yet to be seen an open, standard method for dealing with the uncertainties in this problem. The technique offered by this dissertation aims to fill this gap in relative localization techniques.

### Improved Relative Tracking and Baseline Solution Algorithms

As discussed above, the goal of this research is to provide a complete centimeter-scale relative localization system using low-cost, single frequency GPS receivers alone. Additionally, we have discussed many of the shortcomings of existing techniques, as well as the needs of certain applications which are not being met by the current state of the art.

As such, the following list has been devised, describing the essential requirements that a complete relative localization system should have to garner the largest amount of utility from the widest range of applications:
Centimeter-precision accuracy for a scalable network of nodes
No stationary calibration or data collection phase
No explicit reference station or hub

A centimeter-scale level of precision should be accurate enough to enable a wide range of highly location-dependent new applications. Likewise, the lack of an initialization phase in which the network of receivers must remain stationary will be extremely useful in ad-hoc or impromptu localization setups, where there is either no time to spend on lengthy calibrations, or the nature of the application precludes the component receivers from remaining stationary. Finally, the lack of an explicit reference station will increase both robustness and accuracy, eliminating any single points of failure from the system and ensuring that any unmodeled errors that may be present in a single reference signal remain decorrelated from the signals in the rest of the network.

The approach we take to realizing a complete localization system without violating any of these requirements stems from three key observations:

1. It is impossible to consistently, robustly, and dynamically achieve the level of precision desired without some form of calibration and/or error mitigation,

2. Calibration takes a long time because existing algorithms rely on the slowly changing geometry of satellites to introduce variety into the otherwise stationary observations, and

3. Receiver-based changes in geometry (motion) would greatly speed up the calibration process if the magnitude and direction of these changes were known precisely.

The last item listed is the key to making our technique work. It should be noted that there does exist a body of research aimed at increasing the accuracy of localization techniques by integrating them with motion-based sensors such as IMUs, accelerometers, or gyroscopes [59, 43, 61]. However, all of these sensing modalities suffer from rapid bias accumulation and are therefore only useful for increasing the short-term stability of GPS measurements.

It would be much more useful if there were a method that could provide highly accurate relative tracking results over an extended period of time. Not only would this allow for receiver motion during a calibration phase, but it would also provide the much-needed receiver-based change in network geometry required to more rapidly converge to the level of precision desired. Additionally, by knowing the relative 3D motions of the receivers through time, the number of unknowns in the system would not increase past the initial three X,Y,Z coordinates of the baseline. In other words, the known relative receiver motions can be used to make data observations taken over multiple epochs mathematically equivalent to the stationary case.

Take, for example, a system of receiver-satellite range equations (Rᵣ^{s}) over time, where each equation is a function of the initial unknown baseline coordinates (b(t₀)) with respect to a “stationary” reference (x_{ref}) at time t₀:

$${R}_{r}^{s} ( {t}_{0} ) = f ( \begin{matrix}{x}_{ref} + {b}_{x} ( {t}_{0} ) , \\ {y}_{ref} + {b}_{y} ( {t}_{0} ) , \\ {z}_{ref} + {b}_{z} ( {t}_{0} )\end{matrix} ) \\ {R}_{r}^{s} ( {t}_{1} ) = f ( \begin{matrix}{x}_{ref} + {b}_{x} ( {t}_{0} ) + Δ {b}_{x} ( {t}_{1} ) , \\ {y}_{ref} + {b}_{y} ( {t}_{0} ) + Δ {b}_{y} ( {t}_{1} ) , \\ {z}_{ref} + {b}_{z} ( {t}_{0} ) + Δ {b}_{z} ( {t}_{1} )\end{matrix} ) \\ {R}_{r}^{s} ( {t}_{2} ) = f ( \begin{matrix}{x}_{ref} + {b}_{x} ( {t}_{0} ) + Δ {b}_{x} ( {t}_{1} ) + Δ {b}_{x} ( {t}_{2} ) , \\ {y}_{ref} + {b}_{y} ( {t}_{0} ) + Δ {b}_{y} ( {t}_{1} ) + Δ {b}_{y} ( {t}_{2} ) , \\ {z}_{ref} + {b}_{z} ( {t}_{0} ) + Δ {b}_{z} ( {t}_{1} ) + Δ {b}_{z} ( {t}_{2} )\end{matrix} ) \qquad ( 28 )$$

Since the relative motions of the receiver to the reference are known (the Δb values), the only unknowns in the equations above are the initial baseline coordinates, (b(t₀)). Additionally, it does not even matter if the reference receiver is stationary, since we are only concerned with the relative baseline between the two nodes. As such, it is clear that including range observations from a number of consecutive epochs increases the amount (and quality) of data available to solve for the initial baseline, or in other words, to calibrate. Quality is said to be increased because data from different epochs correspond to different satellite constellation geometries, and the more geometries that are incorporated, the smaller the region of feasibility for the location of a receiver.

Using this knowledge, we created a technique which first tracks the positions of any node in a network relative to the receiver performing the localization, and then uses these tracking results in a baseline determination algorithm, with the end result that each receiver using the localization service has its own highly accurate internal mapping of all of the surrounding nodes taking part in the localization.

### Relative GPS Tracking Algorithm

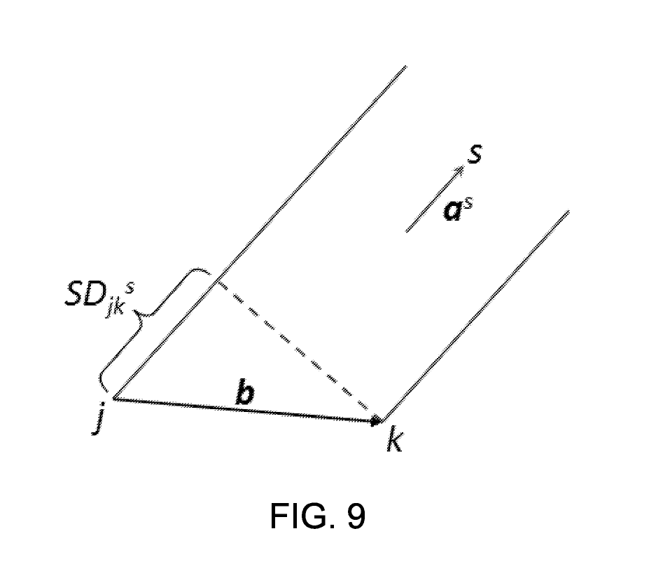

The new temporal double-differencing observation model as discussed above can be used directly in the creation of a novel tracking algorithm with the potential for centimeter-scale precision through time. FIG. 9 shows schematically geometric interpretation of the single-differencing operation according to certain embodiments of the present invention. By subtracting one receiver's carrier phase observation to satellite s from a second receiver's similar observation (i.e. single-differencing), the result is the range difference between the two receivers to that satellite, which is equal to the baseline between the two receivers projected onto the line-of-sight unit vector from receiver to satellite, as shown in FIG. 9.

It should be noted that the GPS satellites are such a great distance from the surface of the Earth that the unit direction vectors can be assumed to be identical for both receivers with little effect on the result as long as the two receivers are located in the same geographic region. We perform the same operation at the next time epoch, t+1, and then subtract the two results to create the temporal double-differenced value, with model corresponding to Equation 27, repeated here for clarity (and ignoring any receiver measurement noise):

∇ΔLⱼₖ^{s}=∇Δρⱼₖ^{s}+c∇Δτⱼₖ (29)

Since ∇Δρ^{s}ⱼₖ represents how much the projected baseline described above has changed over the course of one epoch, the model can be expanded as follows:

∇ΔLⱼₖ^{s}(t+1)=Rₖ^{s}(t+1)−Rⱼ^{s}(t+1)−Rₖ^{s}(t)+Rⱼ^{s}(t)+c∇Δτⱼₖ(t,t+1) (30)

For any arbitrary change in time, this is the same as:

∇ΔLⱼₖ^{s}(t+Δt)=Rₖ^{s}(t+Δt)−Rⱼ^{s}(t+Δt)−Rₖ^{s}(t)+Rⱼ^{s}(t)+c∇Δτⱼₖ(Δt) (31)

When the range is written recursively through time:

$$\begin{matrix}∇ Δ {L}_{jk}^{s} ( Δ t ) = ( {R}_{k}^{s} ( t ) + Δ {R}_{k}^{s} ( Δ t ) ) - ( {R}_{j}^{s} ( t ) + Δ {R}_{j}^{s} ( Δ t ) ) - \\ {R}_{k}^{s} ( t ) + {R}_{j}^{s} ( t ) + c ∇ {Δτ}_{jk} ( Δ t ) \\ = Δ {R}_{k}^{s} ( Δ t ) - Δ {R}_{j}^{s} ( Δ t ) + c ∇ {Δτ}_{jk} ( Δ t ) \\ = Δ {R}_{k}^{s} ( Δ t ) - Δ {R}_{j}^{s} ( Δ t ) + c Δ {\dot{τ}}_{jk} ( Δ t )\end{matrix} \qquad ( 32 )$$

This shows that the temporal double-differenced result is actually a measure of the change in range between two nodes and a satellite (plus the difference in relative clock drifts). Geometrically, this corresponds to the change in receiver-receiver baseline (Δb) projected onto the unit direction vector from receiver to satellite (aᵣ^{s}), where the At terms have been omitted for succinctness:

∇ΔLⱼₖ^{s}=Δb·aᵣ^{s}+cΔτⱼₖ (33)

It is clear from this result that neither of the initial positions of the receivers must be precisely known in order for the relative motions between them to be accurately tracked. Additionally, it is unnecessary to solve for the motions of both of the receivers, since Equation 33 allows for a direct solution of the change in baseline based on our general knowledge of the unit direction vector to satellite s. Thus, the assumption that one node is stationary (ΔRⱼ^{s}=0), even when it is not, causes all of the relative motion to be attributed to the second node (ΔRₖ^{s}=Δb·αⱼ^{s}), which is exactly what is desired, even though it is incorrect in the absolute sense.

In order to solve a system of tracking equations (in the form of either Equation 32 or 33), a simple least-squares optimization routine can be set up to estimate the tracked 3D coordinates through time along with the clock drift difference. As long as consistent satellite locks are maintained with at least four satellites, the relative positions of any node after initialization can be determined via simple dead reckoning (i.e. adding the current tracking result to the last relative position estimate).

In addition to allowing for the tracking of relative motions without requiring precise a priori knowledge of any node locations, our tracking methodology has the added advantage that neither of the nodes must remain stationary during the tracking procedure due to the fact that:
Any absolute changes in position are irrelevant since all motion gets attributed to the “relative” receiver, and
The satellite unit direction vectors are virtually identical for a node that has only moved an order of meters in one epoch (See Appendix C for a complete analysis of this assumption).

### Measurement Error Detection Using Clock Drift Estimation

The tracking methodology just described is able to produce highly accurate results in a low-multipath environment; however, multipath-rich environments tend to not only introduce additional unmodeled errors into one or more of the satellite observations, but also to increase the likelihood that very minute, undetected cycle slips may occur. In either of these cases, the errors themselves are so small that they are mathematically difficult to detect, but their effect on the results of the tracking algorithm can be quite large and accumulate quickly.

In order to provide a robust way to discard these erroneous measurements, aspects of the present invention provide a technique whereby the clock drifts of the participating receivers are tracked in their own separate filters through time and then compared to the clock drift term produced by the relative tracking algorithm described above. This is reasonable and simple to do since the clock drifts experienced by the local oscillators tend to be quite stable over relatively long time spans. The detection algorithm is as follows:
1. Compute the 3D tracking vector and clock drift term from Equation 33 using all valid, non-ignored satellite observations,
2. Compare the computed clock drift term with the tracked clock drift estimate from the clock dynamics tracking filter,
3. If the difference between the clock drifts (times the speed of light) is greater than 1.5 meters, OR the maximum error residual from the least-squares tracking solution is greater than ⅕th the wavelength of the carrier wave, one of the measurements is most likely erroneous. Recompute the 3D tracking vector by setting the clock drift term equal to its estimate from the dynamics tracking filter (i.e. remove a single degree of freedom), and add the satellite with the resulting maximum residual to an “ignore list,” then return to Step 1,
4. If this step is reached, no more satellite observations are determined to be in error.

Once no additional erroneous measurements are detected, the “good” satellite observations are used to produce a final tracking result which can then be used by the relative localization algorithm described in the next section.

### Relative GPS Localization Algorithm

The tracking results from the previous section provide exceptional accuracy when viewed from a dead-reckoning point of view. However, their real utility comes in allowing data from multiple epochs to be used in a single localization algorithm regardless of any absolute or relative motions between the receivers. For the theory in this section, an assumption is made that the available tracking results are completely error-free. The real-world impact of the omission of any such errors will be discussed later.

The basis for the relative localization algorithm is formed from the following observations:
1. Accurate tracking results allow us to use localization techniques that would normally be reserved for stationary network topologies,
2. The standard double-differencing observation model provides the strongest geometric solution while including the minimum amount of unmodeled error possible; however, it requires resolution of the so-called integer ambiguities,
3. A solution relying solely on the resolution of ambiguities in the carrier phase model is inadvisable, since it will, by necessity, be susceptible to large errors due to undetected cycle slips and will mandate that a certain subset of satellites remain consistently visible through time, and
4. The correct relative position will be characterized by a set of ambiguity values that results in low error residuals when the modeled receiver-satellite ranges are calculated and compared to the actual satellite observations over a significant period of time.

The last point in this list may not be immediately obvious. However it is easy to visualize if we provide a simplified example in two dimensions.

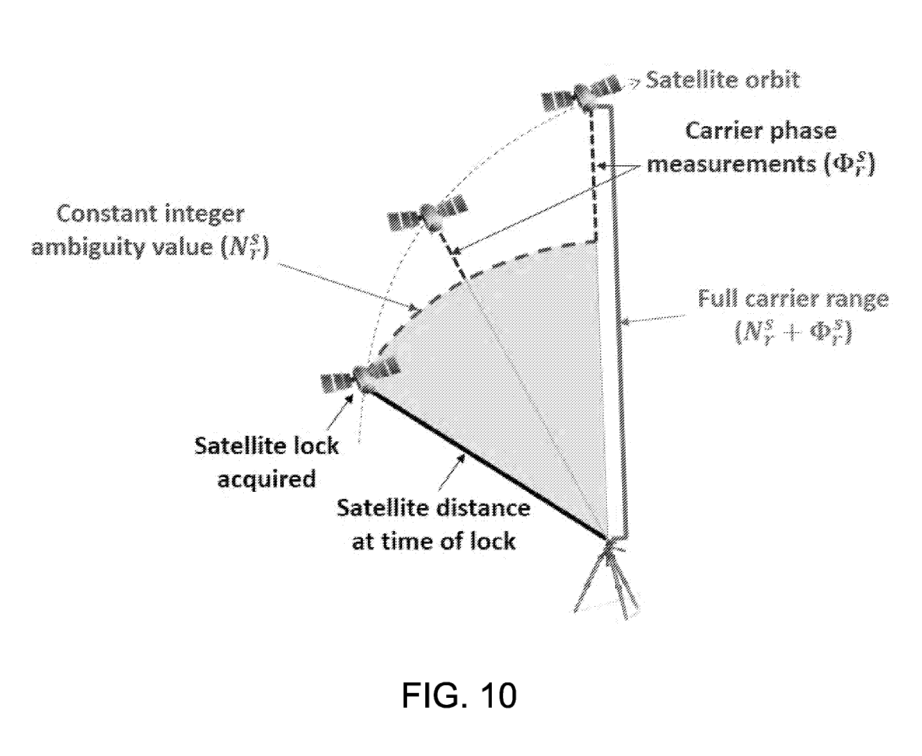

FIG. 10 shows schematically constituent components of the double-differenced carrier phase observation for a single satellite through time according to certain embodiments of the present invention. A single satellite observation viewed from the paradigm of the double-differenced carrier phase model will include a GPS-reported satellite-receiver carrier phase and an unknown integer ambiguity term, as shown in FIG. 10.

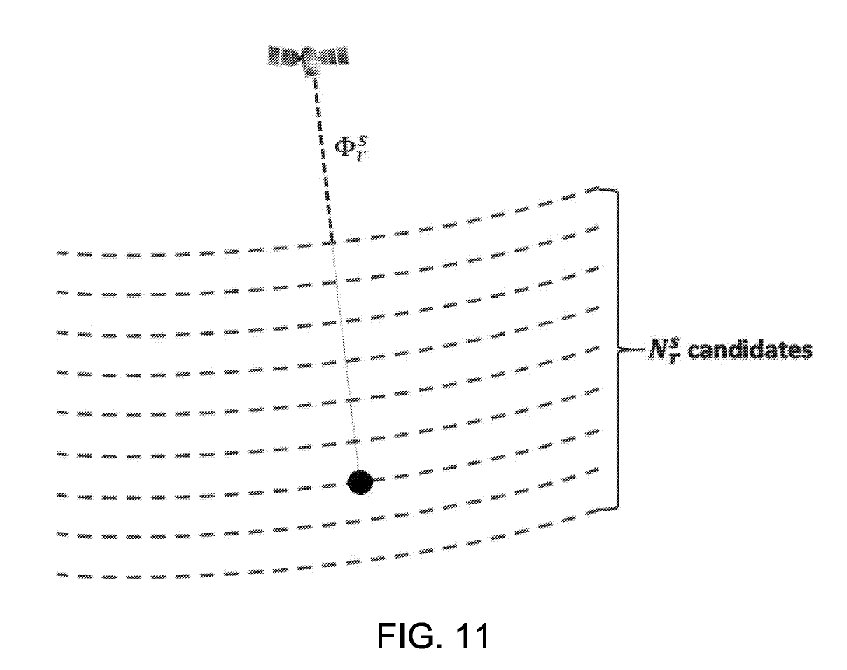

FIG. 11 shows schematically potential integer ambiguity candidates and their corresponding grid lines according to certain embodiments of the present invention. Since the integer ambiguity is related to the number of whole carrier wave cycles that were present between the satellite and receiver at the time of initialization, we can think of the observation to each satellite as a reported range value plus an unknown bias which is guaranteed to be equal to some number of carrier cycle wavelengths (˜19 cm), where the actual receiver position must lie on one of the grid lines representing the reported range plus the ambiguity bias, as shown in FIG. 11:

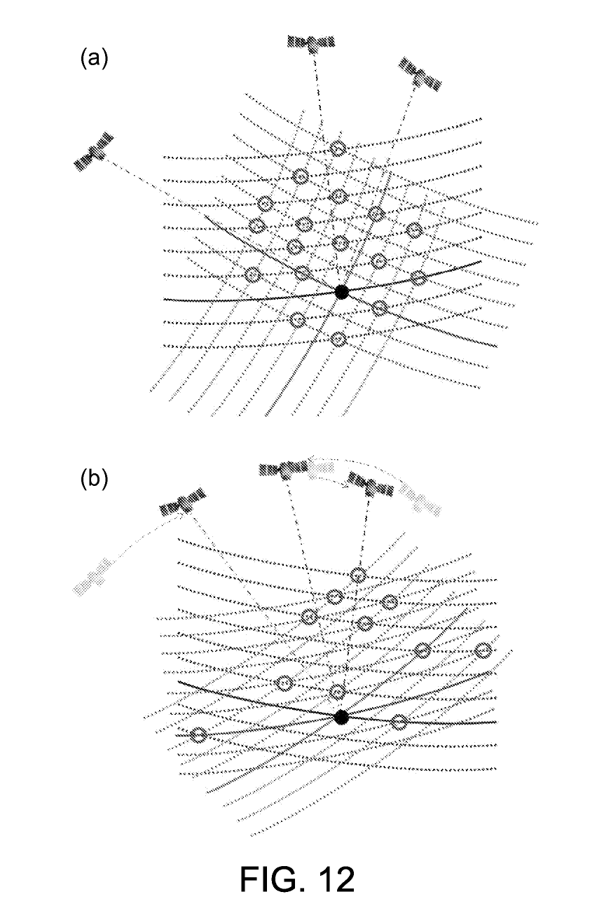

FIG. 12 shows schematically change in candidate receiver locations through time according to certain embodiments of the present invention, where (a) shows a set of potential receiver locations at time t₀, and (b) shows a set of potential receiver locations at time tₙ. If the model as shown in FIG. 11 is extended to a three-satellite configuration, as shown in FIG. 12(a), it is apparent that there are multiple intersecting points which could all be potential receiver positions since they are located on one of the gridlines from each of the satellites, and the relevant gridlines intersect one another very nearly perfectly. However, as the satellites move over time, the slopes of the gridlines will necessarily change such that a new set of possible locations becomes apparent, as shown in FIG. 12(b).

As shown in FIG. 12, one and only one of the candidate locations has remained constant through the change in satellite geometry. This is obviously the correct receiver position, and as stated in our list of observations above, this can be verified mathematically by noting that the satellite-receiver ranges calculated using the incorrect ambiguity values (lines) from FIG. 12(a) will no longer intersect with one another when recalculated after a change in satellite geometry. In other words, only the correct receiver position (with the correct ambiguity values) will have a continually low error residual when the computed satellite-receiver ranges are compared to the satellite observation values through time.

While this result shows the strength of the double-differenced observation model, as discussed above, it can suffer severe drawbacks in that:
Cycle slips are difficult to detect and will result in either very high error residuals or very wrong position estimates, and
The double-differenced model includes use of a reference satellite that may go in and out of visibility, undermining the ability of the ambiguity values to be resolved since their values are completely dependent on the reference satellite being used.

As such, we decided to look for other ways of carrying out our localization procedure without requiring resolution of the integer ambiguities.

### Ambiguity Function Method Overview

A mathematical concept, called the “Ambiguity Function Method” (AFM), has been introduced [10]. This method is unique in that it leverages the “integer-ness” of the ambiguity values in the double-differenced carrier phase model to determine a baseline position which minimizes the range errors in the participating satellites' observations. Recall that the simplified double-differenced carrier phase model looks like:

∇ΔLⱼₖ^{mn}(t)=∇Δρⱼₖ^{mn}(t)−λ_{L1}∇ΔNⱼₖ^{mn} (34)

By isolating the integer ambiguity term on the left-hand side of the equation:

$$∇ Δ {N}_{jk}^{mn} = \frac{∇ {Δρ}_{jk}^{mn} ( t ) - ∇ Δ {L}_{jk}^{mn} ( t )}{{λ}_{L 1}} \qquad ( 35 )$$

This shows that at the correct baseline coordinates, the entire right-hand side of the above equation will be a perfect integer (in the absence of any errors).

Mathematically, we can test a value for its integer-ness by converting the number to radians and taking its cosine:

cos(2π·integer)≡1.0 (36)

For numbers that are not perfect integers, the resulting value will drift further and further from 1.0, reaching a minimum of −1.0 at any integer±0:5, or in other words, at the least integer-like value possible. Extending this concept to the double-differenced carrier phase model, we see that:

cos(2π·∇ΔNⱼₖ^{mn})=1.0 (37)

And by extension, at the correct 3D baseline coordinates:

$$cos ( 2 π \cdot \frac{∇ {Δρ}_{jk}^{mn} ( t ) - ∇ Δ {L}_{jk}^{mn} ( t )}{{λ}_{L 1}} ) = 1 \qquad ( 38 )$$

This concept allows us to search for a baseline solution in the position domain, instead of in the measurement or ambiguity domains, as is usually the case.

By summing the resulting cosine values for all possible satellite observations and dividing this result by the number of observations, we can calculate an Ambiguity Function Value (AFV) in the range from −1:0≦AFV≦1:0:

$$AFV = \frac{{\sum }_{a = 1}^{{n}^{s}} cos ( 2 π \cdot \frac{∇ {Δρ}_{jk}^{mn} ( t ) - ∇ Δ {L}_{jk}^{mn} ( t )}{{λ}_{L 1}} )}{{n}^{s}} \qquad ( 39 )$$

where an AFV closer to 1.0 represents a position in which all of the double-differenced ambiguity values would be very nearly integer.

Since we know that the ambiguity values must be integers, the application of this method to GPS is as simple as defining a 3D search space, calculating the AFV for each and every point (down to some pre-defined resolution) in the search space, and picking the point with the highest value.

As simple as this sounds, this technique is almost never used in practice for several reasons:
1. Depending on the size of the search space and the desired resolution, the number of points that must be evaluated can become intractable,
2. The method pre-supposes all satellite observations to be error-free; however, a relatively small amount of error in one or more observation can result in an AFV that is quite far from 1.0,
3. Unmodeled errors can result in an incorrect set of coordinates having a higher AFV than the correct baseline coordinates, and
4. The method cannot be used over time unless both receivers remain stationary since we are searching in the position domain.

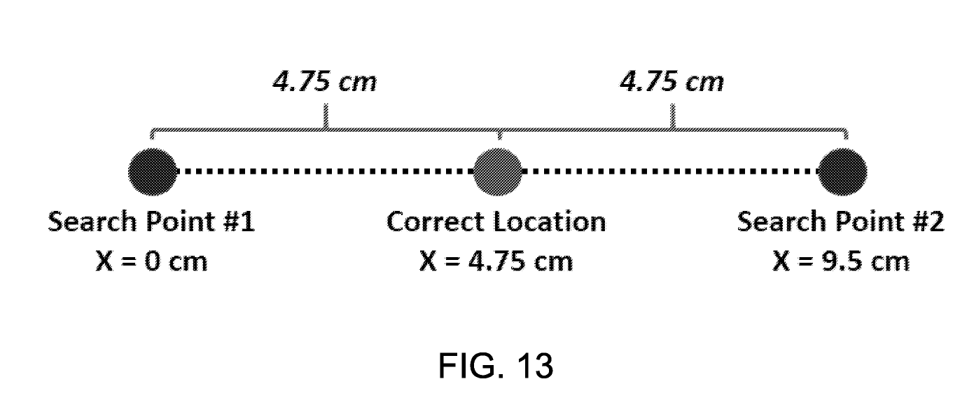

The reason this method is so intractable is due to the minimum resolution required to guarantee that the correct position is not missed. Since we are searching for positions that make the double-differenced ambiguities the most nearly integer, we must actually evaluate a position that is quite close to the intersecting ambiguity lines in the first place. FIG. 13 shows schematically the maximum 1D AFM error due to search resolution according to certain embodiments of the present invention. As shown in FIG. 13, it is clear, for example, that at a search resolution of 9.5 cm, or one-half the carrier wavelength, it is possible for the set of evaluated locations (in one dimension) to come no closer to the correct integer gridline than 4.75 cm.

By plugging this worst-case residual value of 4.75 cm into AFV Equation 39, we see this would result in an AFV of 0.0, clearly nowhere near 1.0. In order to achieve a reasonable AFV of at least 0.8, for example, the absolute minimum search resolution required would be nearly 4 cm. Given a typical GPS 3D RMS position error of 4 m, this would require (4 m/4 cm)³=1,000,000 individual search points for a single observation epoch.

In addition to the computational complexity of searching through the entire search space in the absence of measurement noise, real-world errors dictate that either much higher resolutions or much larger search spaces be used to ensure that the correct position is not missed. As such, this method has been all but abandoned for use in modern GPS localization techniques; however, it should be noted that this method alone stands apart from the rest due to its complete immunity to cycle slips. The fact that the method simply takes the integer-ness of a solution into account coupled with the fact that cycle slips are always integer in nature (barring half-cycle slips which will be discussed later) means that cycle slips which normally wreak havoc on other positioning techniques pose no problems whatsoever for the Ambiguity Function Method.

### Peak AFV Tracking Solution (PATS)

Because of the AFM's immunity to cycle slips, as well as its direct position-domain search space, it was chosen as the preferred method on which to build our baseline determination algorithm. Unfortunately, due to the errors and complications listed in the previous section, it could not be coupled with our tracking results and simply applied as a direct solution to the centimeter-scale relative localization problem.

Instead, we view the AFM search space in a different light, creating a heat-map topology in which the AFV at a specific point corresponds to the point's overall “fitness” as a potential candidate for the baseline solution.

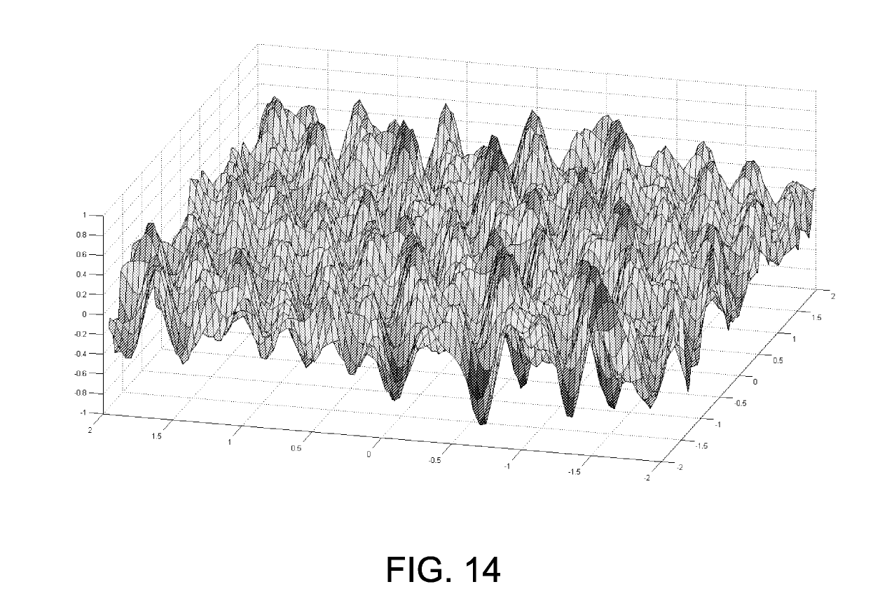

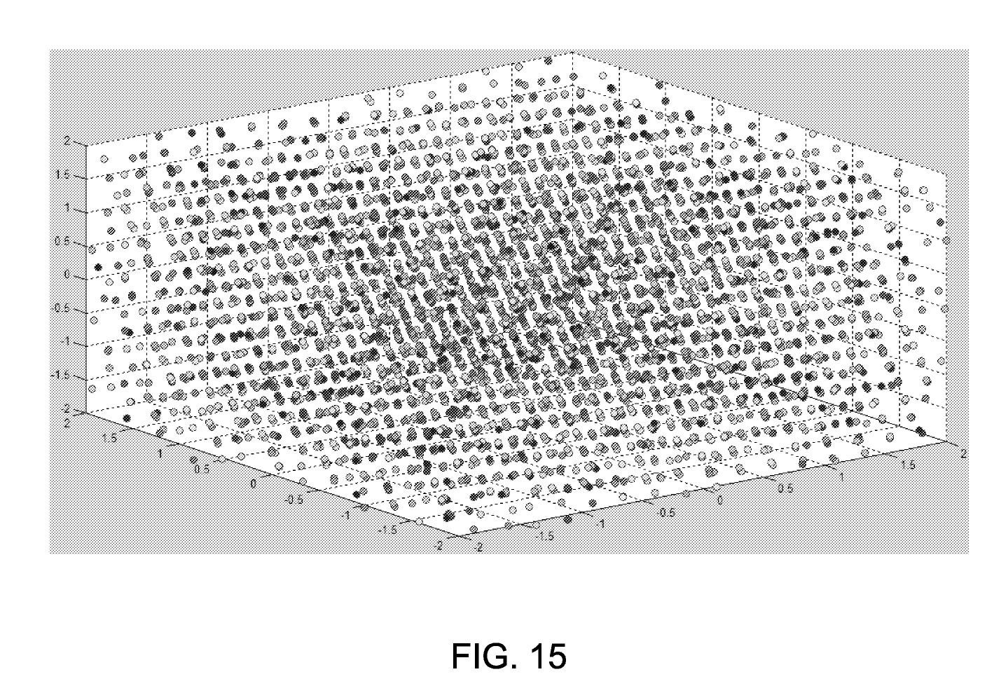

FIG. 14 shows schematically an AFM search space as a heat map in two dimensions according to certain embodiments of the present invention, and FIG. 15 shows schematically an AFM search space as a heat map in three dimensions according to certain embodiments of the present invention. As shown in FIG. 14, the X and Y axes correspond to the X and Y dimensions in the standard AFM search space, and the Z axis represents the corresponding AFV, or fitness value, at the specified location. The red peak areas in this FIG. 14 indicate regions in which the correct relative baseline is more likely to fall, while blue valley areas indicate regions of unfitness. It is clear, although the map is quite jagged and hilly, that the overall fitness function is relatively smooth and continuous over short intervals, with easily identifiable peaks and valleys present in the topology. These peaks are precisely referred to by the algorithm name “Peak AFV Tracking Solution.” When this same search grid is expanded to include three dimensions, as shown in FIG. 15, it is much more difficult to recognize the so-called peaks in the topology, but they are nonetheless identifiable and correspond to the darker, redder-colored dots as shown in FIG. 15.

The previous section explained how AFVs close to 1.0 correspond to baselines that make the double-differenced integer ambiguities in our model the most integer-like, and therefore, the most “correct” in a mathematical sense. This becomes quite easy to see in either of the figures above by recognizing that the various peaks correspond to likely baseline candidates. We also discussed that, due to multipath and unmodeled errors, there is a high probability that the highest peak will not actually correspond to the correct baseline solution. Referring back to FIG. 12, however, the correct baseline position will experience continually low error residuals (i.e. will remain a peak) through significant changes in both satellite and receiver geometry. Extending that concept to our AFV search grid, it is clear that peaks at incorrect locations will fade and turn into valleys as the change in geometry causes their fitnesses to decrease. As such, the “tracking” in the Peak AFV Tracking Solution refers to the fact that we not only identify the highest peak(s) at a given point in time, but also track these peaks such that it becomes possible to filter out the erroneous candidate baselines as their corresponding AFVs decrease.

In the simplest of cases, this procedure equates to initially searching over some pre-defined search space for all of the AFV peaks (i.e. baseline candidates) and then filtering through time by evaluating each remaining peak according to the newest epoch of GPS data and removing any baselines from the candidate set that are no longer valid. At some point, there will only be one valid peak remaining, corresponding to the correct relative baseline between the two receivers.

As discussed in the previous section, however, the technique is not carried out in an ideal situation in which the unmodeled errors can be simply ignored and assume that it is completely stationary or that our tracking results are completely error-free. In such an ideal case, we would simply be able to track the values of the peaks through time. In reality, it is required to track the peak locations as well as their values, since they are most likely in constant motion, and our knowledge of these motions is not completely without error.

Extended AFM with Hill Climbing

Although the implementation of the algorithms as discussed above provides incredibly accurate tracking results, they are nonetheless imperfect. As mentioned earlier, even single centimeters of error can lead to drastically low AFV levels. As such, a method of correcting for or overcoming these inaccuracies must be employed to make the tracking results useful in a motion-enabled, AFM-based technique. As such, we extend the AFM method with a simple hill climbing algorithm to overcome any inaccuracies in our tracking results and derive a new thresholding function to be used in determining an appropriate AFV level under which to filter our results.

Hill climbing algorithms provide a useful methodology for overcoming small optimization discrepancies by searching in a region close to or around an arbitrary initial position estimate for the “local maximum” of some fitness function. In our case, the fitness function is the AFV equation itself, and the location around which to search is an estimate of the baseline between two receivers that has been tracked through time (i.e. the “tracked peak” as discussed above).

Since our tracking results provide sub-centimeter-scale precision over single epochs of time, the errors are not large enough to push a potential baseline candidate so far from its corresponding local AFV maximum that it enters the domain of a different (i.e. wrong) local maximum. In other words, the local maximum of the AFV function for a given position at time t will be the same local maximum for the updated position at time t+1 if our tracking results are used over a single epoch.

This statement is only true for a finite amount of time, however. In order to guarantee that this claim always remains true, we must re-position our baseline estimate after every time step such that it always coincides with its corresponding local maximum. In essence, this is the same as removing any bias that would normally accumulate over time in a deadreckoning tracking algorithm such as ours.

Fortunately, since the AFV equation represents a continuous, smooth function in the position domain, we can directly use a steepest-ascent hill-climbing technique to quickly find the local maximum given our initial baseline estimate. All that this entails is evaluating the AFV equation for the points immediately around the estimate, and then repositioning it to be the point that experienced the largest increase in AFV from the original estimate. This process is repeated for the updated estimate and so on and so forth until no point is found with a better AFV than the current one. The corresponding point will be the local maximum of the function in the desired region.

At the next time step, we update our baseline estimate with the tracking results from the previous section, and then carry out this hill-climbing technique to once again remove any tracking error we incurred. In such a way, any position estimate (even if it is the wrong one) can be continuously tracked through time according to its fitness within the paradigm of the AFM. It remains to be seen, however, an effective way to remove candidates that no longer fit based on the changing satellite and receiver geometries.

### AFV Thresholding Function

As discussed above, some sort of thresholding function would be an ideal way to filter out baseline positions that have become unfit candidates over time. Such a thresholding function can be formed by taking into account the fact that:
Since we are searching over a discrete search space, there will almost always be some amount of error due to the offset between the “correct” position and its nearest search point on the grid, and
The carrier phase observations used for AFV determination are not perfect measurements and will include some amount of error, due primarily in this case to multipath and receiver noise.

As such, the error term that was omitted to form the simplified carrier phase model in Equation 34 should not be overlooked. Let us first re-derive the AFV equation without ignoring the error term. The full double-differenced carrier-range model is given by:

∇ΔLⱼₖ^{mn}(t)=∇Δρⱼₖ^{mn}(t)−λ_{L1}[∇ΔNⱼₖ^{mn}+∇Δεⱼₖ^{mn}(t)] (34)

Again, by isolating the integer ambiguity on the left-hand side of the equation:

$$∇ Δ {N}_{jk}^{mn} = \frac{∇ {Δρ}_{jk}^{mn} ( t ) - ∇ Δ {L}_{jk}^{mn} ( t )}{{λ}_{L 1}} + ∇ {Δε}_{jk}^{mn} ( t ) \qquad ( 41 )$$

Then, we take the cosine of its radian form to compute the AFV corresponding to the nth satellite.

$$cos ( 2 π [ \frac{∇ {Δρ}_{jk}^{mn} ( t ) - ∇ Δ {L}_{jk}^{mn} ( t )}{{λ}_{L 1}} + ∇ {Δε}_{jk}^{mn} ( t ) ] ) = {AFV}^{n} \qquad ( 42 )$$

This leaves us with an equation in which the unknowns are the 3D baseline coordinates (used to determine the ∇Δρⱼₖ^{mn} term) and the ∇Δεⱼₖ^{mn} error term.

Not immediately apparent is the fact that the λ term may also be unknown. We have discussed the nature of cycle slips earlier, but some receivers also suffer from what are known as “half-cycle slips.” These slips occur for the very same reason as full-cycle slips; however, they appear to add or remove cycles equal to only one-half the wavelength of the carrier wave. The reason these slips occur is because many receivers choose to remove the BPSK navigation messages from the received L1 signal by simply squaring the received waveform. Since a squaring operation makes all negative values appear to be positive, the resulting squared carrier wave will not repeat itself every λ_{L1} meters, but rather every

$$\frac{{λ}_{L 1}}{2}$$

meters.

Fortunately, most receivers that operate this way are able to detect when their carrier phase tracking loops get out of sync with the unsquared version of the received signal by a half-wavelength and will return this information along with the raw carrier phase measurement to indicate that ambiguity resolution may need to be carried out using half-wavelengths, denoted from here on as λ_{L1/2}. As such, the value in Equation 42 must be treated as a pseudo-variable since its value can change and the AFV equation depends on it, but it will always be known prior to use.

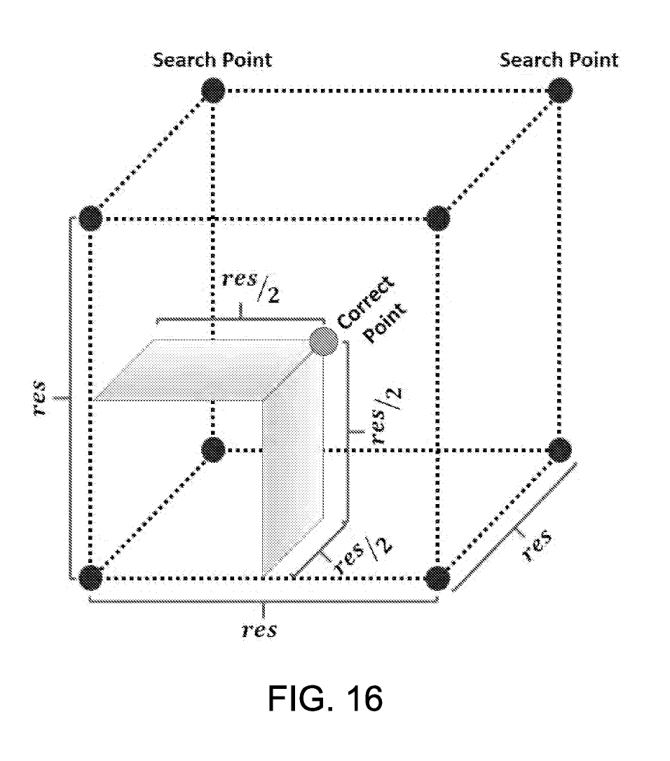

Finally, it was discussed in the previous section that the AFV equation will necessarily contain some amount of error due to the resolution of the search space. FIG. 16 shows schematically a maximum 3D AFM error due to search resolution according to certain embodiments of the present invention. As discussed above, an example is provided in one-dimension that showed the worst-case error to be equal to one-half the search resolution

$$( \frac{res}{2} ) .$$

However, GPS operates in three dimensions, so it is possible for the search point location (which determines the calculated ∇Δρ value) and the correct receiver location (which determines the ∇ΔL value) to differ by up to

$$\sqrt{{( \frac{res}{2} )}^{2} + {( \frac{res}{2} )}^{2} + {( \frac{res}{2 } )}^{2}} = \sqrt{3 \cdot {( \frac{res}{2} )}^{2}} ,$$

as shown in FIG. 16.

Now that we have determined the worst-case error due to the search resolution, investigated the possibility of a half-cycle slip, and included a catch-all term for any unmodeled errors (dominated by multipath), we can re-write the AFV Equation 42 for satellite n as a single-satellite, worst-case value:

$${AFV}_{worst}^{n} ( res , λ , ε ) = cos ( 2 π [ \frac{\sqrt{3 \cdot {( \frac{res}{2} )}^{2}}}{λ} + ε ] ) \qquad ( 43 )$$

Extending this to include all valid observations for a given epoch, we arrive at an AFV thresholding function, dependent on the search resolution used, ambiguity resolution required, and worst-case error present in any given observation:

$${AFV}_{th} ( res , λ , ε ) = \frac{{\sum }_{a = 1}^{{n}^{s}} cos ( 2 π [ \frac{\sqrt{3 \cdot {( \frac{res}{2} )}^{2}}}{λ} + ε ] )}{{n}^{s}} \qquad ( 44 )$$

It should be noted that in the equation above that the λ value may be different for individual satellite measurements since not all observations require half-cycle ambiguity resolution. As discussed above, carrier range errors due to multipath have a maximum error of ˜5 cm, but not all observations will experience multipath, and those that do are not likely to experience it in the same direction or with the same magnitude as one another; therefore, a reasonable technique is to scale down the maximum value of multipath error (ε_{M}^{max}) by the number of visible satellites (n^{s}) and use the resulting value (ε_{M}^{max}/n^{s}=0.05/n^{s})ₐₛ the E term in the AFV thresholding function above.

So far the inventors have introduced several concepts used by the PATS algorithm, but have yet to put them together and state them as a complete methodology for relative baseline localization through time. In certain embodiments, the explicit steps in PATS can be separated into three logical phases of execution: Initialization, Calibration, and Steady-State Localization.

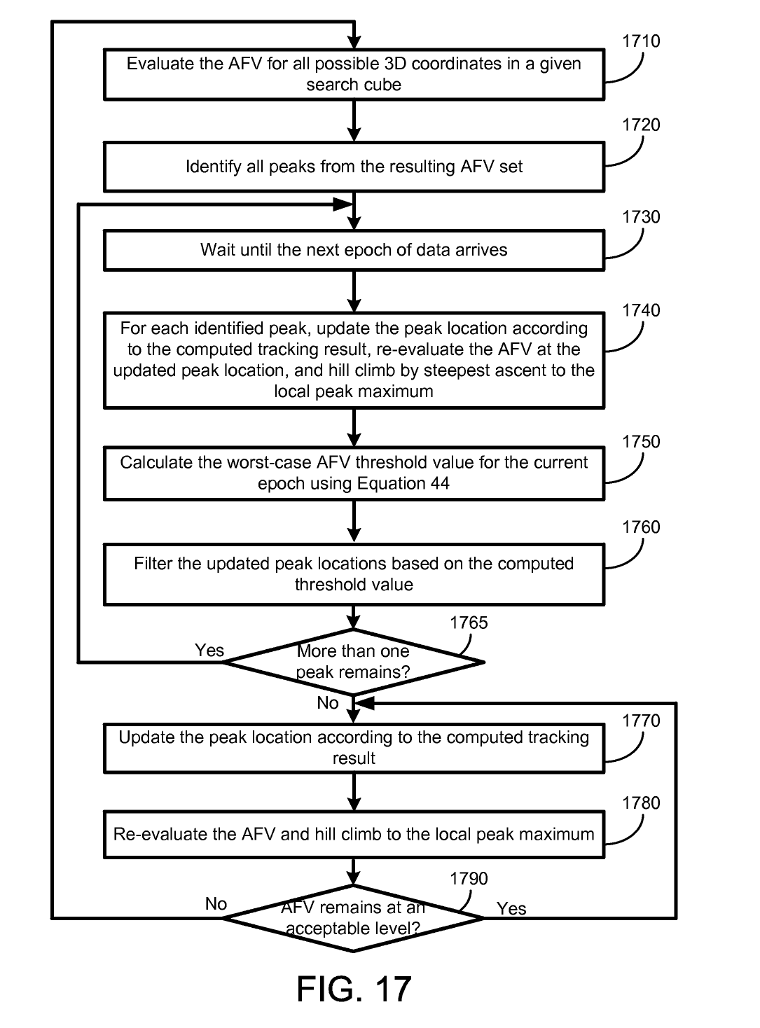

FIG. 17 shows a flowchart of an algorithm of Peak AFV Tracking Solution (PATS) according to certain embodiments of the present invention. As shown in FIG. 17, steps 1710-1720 are the initialization steps, steps 1730-1760 are the calibration steps, and steps 1770-1780 are the steady-state localization steps.

At step 1710, the AFV are evaluated for all possible 3D coordinates in a given search cube. At step 1720, all peaks from the resulting AFV set are identified.

At step 1730, the system waits until the next epoch of data arrives. At step 1740, for each identified peak, the system updates the peak location according to the computed tracking result, re-evaluates the AFV at the updated peak location, and performs hill climbing by steepest ascent to the local peak maximum. At step 1750, the worst-case AFV threshold value for the current epoch is calculated using Equation 44. At step 1760, the updated peak locations are filtered based on the computed threshold value.

Then, at step 1765, the system identifies if there is any more peak remains. If more than one peak remains, the system returns to step 1730 to continue the calibration process. If no peak remains, the system moves forward to perform the steady-state localization steps.

At step 1770, the system updates the peak location according to the computed tracking result. At step 1780, the system re-evaluates the AFV and performs hill climbing to the local peak maximum. At step 1790, the system identifies if the AFV remains at an acceptable level. If the AFV remains at an acceptable level, the system returns to step 1770 to continue the steady-state localization operation. If the AFV is not at the acceptable level, the system returns to step 1710 to restart the initialization step.

In essence, the goal of this algorithm is to reach the steady-state phase for every remote node participating in the localization procedure. Once this stage is reached, the relative baseline between two receivers (i.e. the current peak location) can be computed at a high level of accuracy using only minimal computational resources.

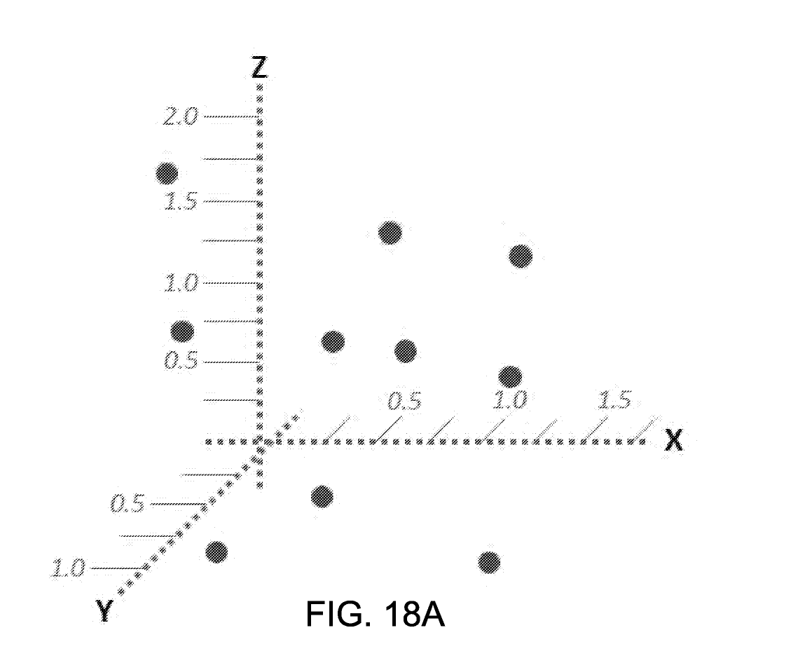

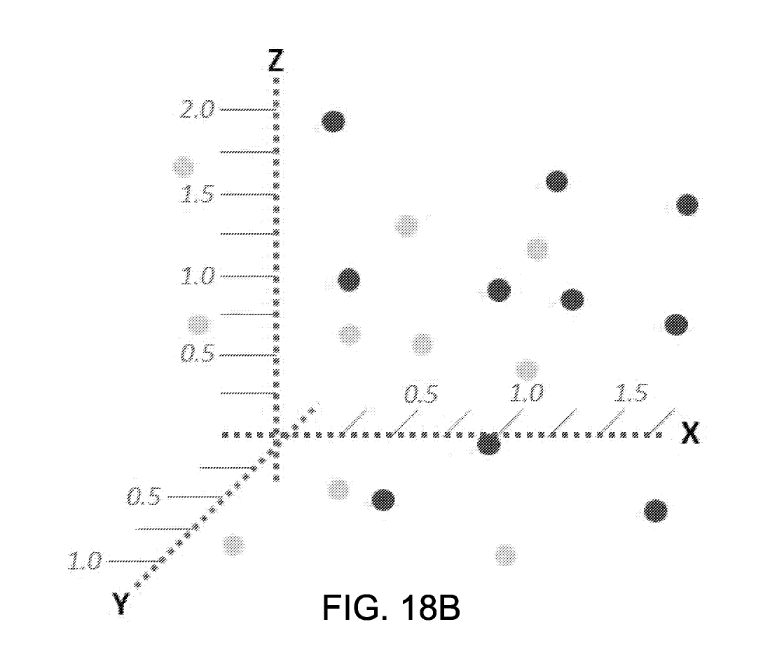

FIG. 18A shows schematically candidate peak locations at time t in the PATS algorithm according to certain embodiments of the present invention, and FIG. 18B shows schematically candidate peak locations at time t+1 in the PATS algorithm according to certain embodiments of the present invention. As shown in FIG. 18A, at some point in time, t, we have carried out the initialization phase of the PATS algorithm and are left with a set of candidate peak locations (represented by dots). At the next time step, t+1, each of the peak locations is updated according to the tracking results, which are (0.75, 0.0, 0.25) as shown in FIG. 18B.

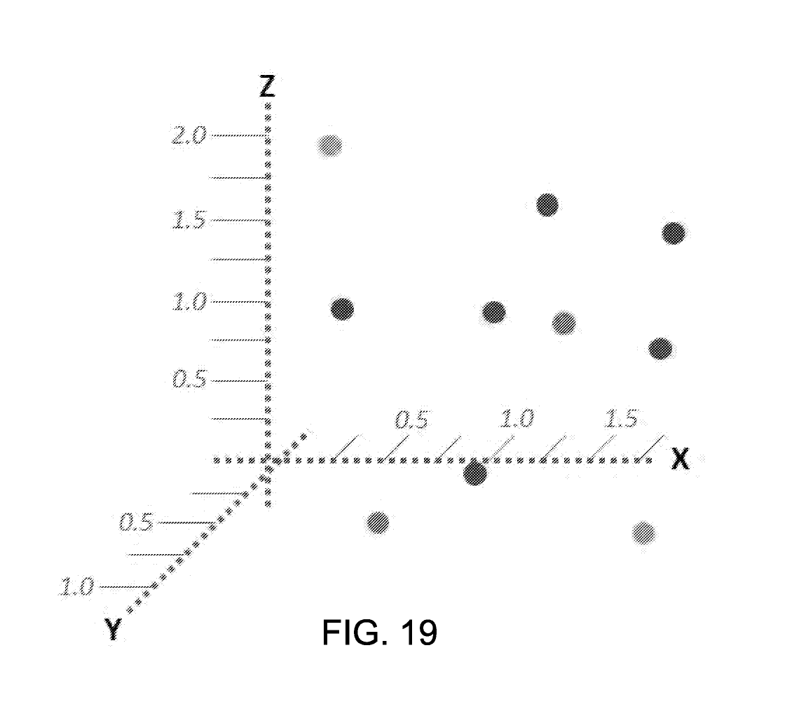

FIG. 19 shows schematically candidate peak locations after hill climbing and re-evaluation in the PATS algorithm according to certain embodiments of the present invention. As shown in FIG. 19, re-evaluation of the AFVs for each peak candidate and hill climbing reaches the local maximum.

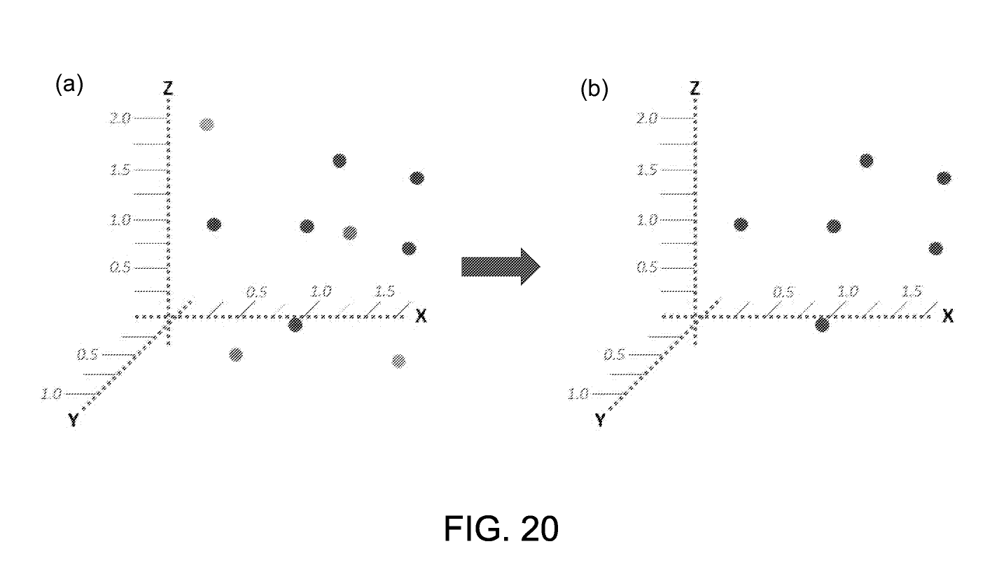

FIG. 20 shows schematically comparison of candidate peak locations before and after threshold filtering according to certain embodiments of the present invention, where (a) shows candidate peak locations before threshold filtering, and (b) shows candidate peak locations after threshold filtering. As shown in FIG. 20, from the resulting peak locations and AFVs, unsuitable results are filtered out using the calculated threshold value, such that only a subset of the peak candidates remain.

This process repeats itself at every time step until only one peak remains, corresponding to the correct relative baseline between two receivers. This single peak continues to be tracked through time, providing highly accurate relative node location information while requiring only minimal computational complexity.

It should be noted that since we have a set of potential relative coordinates at each time step which, by definition, correspond to sets of integer ambiguities containing minimal error, it is trivial to actually calculate the integer ambiguities for each peak using quite literally any satellite as a reference and then to store them for later use. Then, at the next time step, if the satellite previously used as a reference is still visible and without error, the integer ambiguities can be used to compute the current relative baseline in a least-squares sense, thereby providing a means of both verifying the validity of the location of the tracked peaks (i.e. a sanity check) and also providing additional criteria on which to filter and remove unfit peak candidates.

These and other aspects of the present invention are more specifically described below.

### IMPLEMENTATIONS AND EXAMPLES OF THE INVENTION

Without intent to limit the scope of the invention, exemplary methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

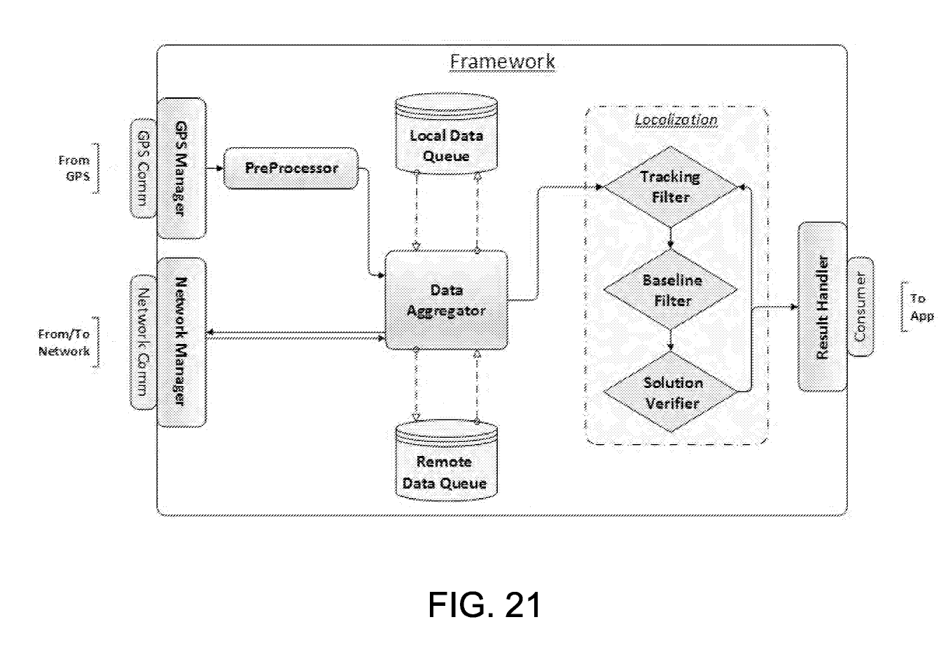

FIG. 21 shows a block diagram of the software implementation of the system according to certain embodiments of the present invention. As shown in FIG. 21, several conventions are used to aid in understanding how the software framework fits together as a whole, as well as how it interacts with the world around it. In certain embodiments, the solid black line labeled “Framework” encompasses the majority of the individual software components, which delineates a standalone platform-independent software service that can be instantiated any number of times on any number of devices without the device or user knowing anything about the inner workings of the framework.

In certain embodiments, the interfaces into and out of the framework are denoted by yellow rectangles connected to the outside of the framework boundary. The term “interface” means that it requires interface implementations to be written specifically for the device the framework is running on, as well as the inputs coming into the device. For example, the GPS chip that we use in our prototype transmits raw satellite data using a proprietary format that must be decoded before being passed into the framework. We therefore write a decoder implementation specific to the data format of the chip and attach it to the \GPS Comm” interface. Likewise, the implementation of the \Network Comm” interface will change depending on the networking technology we are using (e.g. Bluetooth, 3G, UDP Multicast, etc.) and the device the framework is running on. To reiterate, the only platform-specific implementations that must be written correspond to the three interface boxes, making this framework extremely easy to port to virtually any device with the computational power to run it.

In certain embodiments, the benefits of this black-boxing approach are threefold. Namely, the framework can easily be ported to run on any device, can be run in multiple instances on the same device (useful for simulation or log-file playback), and can be run across multiple devices and device types, with the guarantee that the results of internal computations will be mathematically identical, regardless of the device it is running on.

In certain embodiments, the framework can currently run as both a PC service on any operating system or on any handheld device running Android version 4.0 or later. This is useful on the analysis of the experimental results since it allowed us to conduct experiments very early in the project on both mobile and laptop devices and then continue to use the raw log files from these experiments in further research, knowing that the computational results of the research would be identical across devices since only one code base was used.

In certain embodiments, the individual software components within the framework, like the framework itself, are black-boxed from one another and communicate via unidirectional message passing using a common set of pre-defined messages and message types. Each component is referred to as a “module” throughout the rest of the disclosure, with the black-boxed nature of the configuration allowing us to drop in, change, or edit any of several possible module implementations in near real-time without requiring reconfiguration of the rest of the software.

### Example One

The inventors provide an example, in which each software component in detail and analyze the timing and computational requirements of each module to enable analysis of the scalability of the framework as a whole. All software was written in pure Java, ensuring cross-compatibility between various systems and allowing for ease of benchmarking the timing and memory requirements of each constituent module. For analysis of the processing times for each software module, results denoted by a “PC-based” benchmark were formed from the average of the corresponding operations run 10,000 times each on a:
Fujitsu Lifebook S Series, Intel Core 2 Duo @ 2.53 GHz, 4 GB RAM, Windows 7
Dell Precision T1600, Intel Xeon @ 3.30 GHz, 4 GB RAM, Windows 7
Apple MacBook Pro, Intel Core 2 Duo @ 2.40 GHz, 4 GB RAM, Mac OS X 10.8

Results denoted by a “mobile-based” benchmark were formed from operations run 10,000 times each on a:
Google Nexus 7 Tablet, ARM Cortex-A9 @ 1.2 GHz, 1 GB RAM, Android 4.3
HTC Desire, Qualcomm Scorpion @ 1 GHz, 576 MB RAM, Android 4.2.2

### GPS Manager

This module is responsible for receiving decoded GPS data, parsing it into a usable format for the rest of the framework, and packaging all of the satellite data corresponding to a single GPS epoch into one cohesive unit before forwarding it to the next module for pre-processing. This module is also responsible for creating any log files, if desired, since it is the only component with full access to the raw satellite data before any processing, parsing, or transformations have been carried out.

The processing time of this module is negligible, and its throughput is limited to the incoming data rate of the GPS packets, which, by design, is bursty with a 1 Hz transmission cycle.

From a memory standpoint, this module requires a maximum of only 1.52 kB of storage per full epoch of data, determined by the number of visible satellites at any given epoch, with a maximum of 12 satellites visible per unit time. In addition to the observation data, this module must also keep track of the received ephemeris data from each satellite. Fortunately, this memory can be allocated at one time and does not grow with the addition of satellites. The storage requirement for these ephemerides is a constant 24.03 kB of data, making the total maximum memory footprint for this module 25.55 kB.

### Preprocessor

The Preprocessor module handles the bulk of the error mitigation and correction techniques employed by the framework. This includes filtering the data for obvious outliers and error-prone observations, as well as extrapolating all measurement data to the common GPS epoch as discussed above. The first preprocessing step involves removing observations from the data set for satellites:
That are transmitting a satellite health problem as determined by the Control Segment,
Whose orbital accuracies (as determined by the CS and transmitted in the navigation messages) are above a threshold of 5 meters of error,
Whose received signal strengths (carrier-to-noise ratios) are below a minimum threshold of 28 dBHz (from a maximum signal strength of 44 dBHz), or
Whose elevations in the sky relative to the GPS receiver are lower than 15°.
   The remaining observations are then tested for potential cycle slips using the following formula:

$$\begin{matrix}{ε}_{L , threshold} < \vert \hat{L} ( t ) - L ( t ) \vert \\ with & ( 45 ) \\ \hat{L} ( t ) \approx L ( t - 1 ) - {λ}_{L 1} \frac{{f}_{D} ( t ) + {f}_{D} ( t - 1 )}{2} & ( 46 )\end{matrix}$$

where:

\hat{L} is the predicted carrier range at the specified time;

L is the actual carrier range at the specified time;

f_{D} is the instantaneous Doppler shift at the specified time;

λ_{L1} is the wavelength of the carrier signal; and

ε_{L,threshold} is a threshold value for the difference between the predicted and the actual carrier range values.

Since the instantaneous Doppler shift is immune to cycle slips (unlike the carrier phase observable), and the carrier phase is created via integration of the actual, or continuous, Doppler shift through time, the change in carrier phase over one epoch should be close to the average of the instantaneous Doppler shifts at the limits of the observation period. Since these two values are only approximately equal, we take any deviation over an absolute threshold of 5 wavelengths (ε_{L,threshold}=5λ_{L1}≈1 m) to indicate the possibility of a cycle slip. These measurements are simply marked as potential slip candidates, and it is up to the individual modules to determine how to handle a slip (e.g. slips adversely affect the tracking algorithm, whereas they are irrelevant for the AFM-based localization solution).

After any slipped measurements have been marked and erroneous measurements discarded, the preprocessor estimates the current clock bias of the receiver from GPS time using a simple least-squares positioning algorithm, as can be found in [23]. The resulting clock bias value is used to extrapolate all of the data from the current observation set to the correct GPS epoch using the algorithm described above. The fully preprocessed data is then sent to the next module for aggregation.

The total processing time for all of the aforementioned operations is a negligible 164.4 μs on a PC-based framework. The maximum memory requirements for this module are 4.38 kB of storage, with the bulk of the memory being used for constant storage of the full ephemeris data from each satellite. The reason the processing time and memory requirements for this module are so low is because all of the operations can be expressed in the form of deterministic, closed-form algorithms which contain a minimum number of algebraic or matrix operations (3 matrix multiplications and 1 inversion) per epoch.

### Network Manager

The Network Manager's only two functions are to package preprocessed data into a format that can be easily transmitted over a network link, and to unpack network data received from other remote GPS nodes into the same format as the local preprocessed data. Upon reception of remote data, the data is parsed into the correct format and immediately forwarded to the next module for aggregation.

Since the mathematical functionality of this module is limited, its average processing time on any platform is approximately 21 μs. Likewise, the memory requirements are limited to the amount of storage required to hold both the network- and framework-based formats of one epoch of satellite data, which in this case represents a maximum of 1.36 kB.

### Data Aggregator

This module's primary responsibility is to match local and remote data from the same GPS epoch, such that a single cohesive package containing only relevant data points can be sent to the localization modules for further processing. When a local data packet is received from the Preprocessor module, this module simply forwards it to the Network Manager to be transmitted to other remote nodes. It then stores the data in a local database for later use, simultaneously removing any stale data that is five seconds old or older.

Once a remote data packet is received from the Network Manager, this module first stores a copy of it into a database containing all of the remote packets from the corresponding node over the previous five epochs; then, it searches through its databases to find the local preprocessed data corresponding to the GPS epoch of the received packet, as well as the local and remote data corresponding to the previous GPS epoch.

Once all four data packets (i.e. local and remote data for the current and previous GPS epochs) have been located, they are combined into a single “pairwise data unit” that contains all of the various differencing operations that will be needed by the localization algorithms. The reason to have these operations carried out here instead of by the localization algorithms themselves is that, in this case, they only need to be performed once, after which they can be utilized by the various algorithms without incurring additional computational costs. As such, a pairwise data unit is constructed using the following steps:
1. Two reference satellites are chosen from the list of currently visible satellites based on their elevations in the sky and their likelihood to have experienced a cycle slip (where the satellite with the highest elevation and no cycle slips is ranked first),
2. Of the resulting two satellites, one satellite is chosen as a reference which was not the reference at the last time epoch. This is done to minimize the potentially correlative effects of multipath (and other error sources) arising from use of the same reference satellite over time,
3. The temporal double difference is calculated for all visible satellites that have experienced no apparent cycle slips between the current and previous epoch,
4. The classical double difference is calculated using the reference satellite determined in Step 2, and
5. The double-differenced observation is marked to indicate whether it requires half-cycle ambiguity resolution or not, as determined by the GPS chip itself.

After completion of these steps, the resulting pairwise data unit is forwarded to the next module to begin localization as described above.

Since only five epochs of data are stored in the local and remote data queues, epoch-matching is a trivial operation, attributing the bulk of the processing time to carrying out the differencing operations between the various satellites and epochs of data. As such, the total latency for this module from remote packet reception to module output is 47.9 μs for a PC-based framework.

It should be noted that this module will never block unless it receives a remote data packet that is newer than any of its local data. This should never happen in a real-time, networked mode of operation since the network latency should be far greater than the latency of the preceding modules running on a local framework; however, this behavior has been noted when playing back log files on a local machine. All module operations, however, begin on a new thread once a data packet is received, so any remote packets that come in and can be matched immediately with a local packet will not be held up by a blocked module. Likewise, if a newer local packet is produced than the one for which the module is blocking, the framework will assume that the missing epoch included a complete loss of all satellite locks, and it will discard any pending operations for epochs up to the current valid local data packet. As such, this module will not bottleneck under any circumstances.

The memory requirements for this module are dominated by the data queues used to store the past five epochs of data for both the local and remote nodes. These queues, coupled with the storage necessary to carry out any differencing operations, total a maximum of 66.95 kB of data at any given time for a single remote node. It should be noted that each additional remote receiver that participates in the localization procedure will require another maximum of 33.12 kB of memory to store five epochs of received data, although in reality, this number is likely to be only half as much, since an average of six to seven satellites are usually visible, and this memory value corresponds to the consistent visibility of twelve satellites.

### Tracking Filter

The Tracking Filter implements a smart version of the relative tracking algorithm as described above, including use of the clock drift estimation and matching procedure described in that section to detect previously unresolved cycle slips and poor observation data due to multipath and other unmodeled errors. Since there is the possibility that pairwise data may be unavailable for relatively short periods of time, such as when walking in a heavily-wooded area or driving underneath an overpass on the interstate, a constant-acceleration motion model is employed to bridge the gap between non-consecutive periods of satellite visibility. The complete tracking filter works as follows:
1. Upon receipt of continuous, consecutive satellite data, the filter carriers out a “standard tracking update,” which involves direct implementation of the tracking algorithm described above. Since our update rate is 1 Hz, the resulting track is equivalent to the relative velocity in meters per second in our motion model. Likewise, the relative acceleration is equal to the difference between the current relative velocity and the relative velocity of the previous epoch.
2. If non-consecutive satellite data is received, meaning that one or more epochs of data are unavailable, but the missing number of epochs is relatively short (i.e. less than 5 seconds long), the motion model will simply update the relative velocity using its estimate of the relative acceleration.
3. If non-consecutive satellite data is received and the missing number of epochs is greater than 5 seconds, the filter is reset with a relative velocity and acceleration of 0.

In all cases, the resulting relative velocity is checked to ensure that it does not exceed an unrealistic threshold (currently 100 km/s), and its value is passed to the next module as the tracking result for the current epoch.

This is the first module whose mathematical operations are not deterministic, as some processes iterate multiple times using different parameters and inputs to remove any erroneous measurements and provide the highest possible tracking accuracy for subsequent modules. As such, processing times may vary; however, the types of operations performed are still computationally cheap (i.e. 3 matrix multiplications and 1 matrix inversion per iteration). For this reason, the average processing time on a PC-based platform is 22.1 μs.

Regardless of the number of iterations required to come to an acceptable solution, the memory requirements of this module do not grow over time, but rather re-use data structures from previous iterations for further processing. As such, the maximum memory requirements for this module are 1.68 kB of data for any given epoch.

### Baseline Filter

This module uses the previously determined relative tracking results to carry out the PATS baseline localization algorithm described above. The implementation of this algorithm is straightforward and follows directly from the listing in the PATS algorithm. Once again, recall that the PATS algorithm is unaffected by whole cycle slips; thus, no slip detection is required to maintain a high level of accuracy in this module. Conversely, half-cycle slips do affect the solution, but they are detected by the GPS chips themselves. Upon receipt of an observation that may contain a half-cycle slip, this module will simply replace the λ_{L1} value in AFV Equation 39 with λ_{L1}/2, and use λ_{L1}/2 as the wavelength argument to the thresholding function, Equation 44.

As mentioned above, the dramatic impact the search resolution can have on the resulting AFVs. However, increased resolution has an exponential effect on the computational complexity of the initial peak detection algorithm. As such, we use two different search resolutions depending on the phase of execution we are currently in. In the initialization phase in which we are simply trying to identify the locations of the peaks in a search space, we use a coarse-grained resolution of 4 cm between search points. This represents a high enough resolution to determine whether or not a peak exists in a given region, but cuts down on the number of points that must be evaluated to cover the entire space.

After this initialization step (which lasts only one epoch), we enter the calibration phase in which we hill-climb using a much finer resolution of 5 mm. This ensures that the error due to misalignment between a discrete search point and the real baseline position is small and will have a minimal impact on the AFV. It should be noted that this is the resolution that gets passed as an argument to AFV Thresholding Equation 44 to help determine the worst-case value that could arise from the various error sources in this technique.

Finally, once only a single peak candidate remains, we have effectively identified the correct relative baseline between ourselves and the remote receiver being localized. At this point, we enter the steady-state localization phase of the algorithm in which we simply continue to track the peak through time and monitor it for any unexpected errors. Such an error will manifest as a sharp and significant lowering of the peak's associated AFV over the course of one epoch, at which point, we will be required to re-initialize the PATS algorithm.

However, we can assume that, although our peak tracking algorithm has experienced an unknown error (most likely due to multipath or a loss of lock), and the peak can no longer be considered to be valid, it is still likely to be quite close the correct location (i.e. at least within a meter of error). As such, re-initialization can take place over a dramatically smaller search space than was initially used, enabling us to quickly re-determine the correct relative baseline without spending too much processing time in the calibration phase.

The memory requirements of this module, similar to the processing latencies, are highly dependent on the state of the algorithm. In the absence of any peaks, the module requires a maximum baseline of 13.99 kB of memory to function. This is trivial compared to the large amount of memory needed to store the list of peak candidates during the initialization and calibration phases of the localization algorithm. Each peak candidate requires a maximum of 960 bytes of memory to store its relevant information, so in the steady-state, the memory footprint of the module is only 14.98 kB. In the initialization phase, however, the memory requirements are completely dependent on the number of peaks in the search space (which in turn depend on the size of the search space itself).

### Solution Verifier

Solution verification in this case is actually carried out on all potential baseline candidates identified in the previous module and involves comparing the PATS baseline solution with a fixed double-differenced solution (see [23]) using the estimated carrier phase ambiguities from the previous epoch of data. As mentioned earlier, the result of a successful iteration of PATS will be a relative peak location that would produce a set of carrier phase ambiguity values that are quite close to perfect integers. In our framework, we go one step further and actually compute these integer ambiguities for all peak candidates and store them until the next time epoch.

Once each peak has undergone an iteration of the PATS algorithm, the locations of the remaining peaks are then recalculated in a least-squares sense using the fixed ambiguity values from the previous observation epoch. If the PATS solution and the fixed solution agree, we know that the current baseline candidate remains a good fit in our overall localization paradigm. If the solutions do not match, then the Ambiguity Function Value corresponding to the fixed solution is computed (the AFV is already known for the PATS solution from the previous module) and compared to the PATS AFV. In the likely case that a cycle slip has occurred, the AFV from the fixed solution will be significantly lower than the AFV from the PATS solution, which should remain above the threshold value calculated from Equation 44. In this case, the PATS solution is simply accepted and the ambiguity values are recomputed to remove the cycle slip for the next epoch's data set.

If, on the other hand, the AFV from the fixed solution remains above the threshold value but the PATS AFV has dropped significantly, this is indicative of an error in the tracking solution itself. In this case, the location of the peak is updated to be consistent with the fixed solution. In the final case, if both AFVs are below the threshold value, we know that the baseline candidate is simply no longer a good fit, and as such is not worth further consideration. With this in mind, our implementation of the framework described by FIG. 21, actually combines the solution verification module with the baseline filter itself, since it became apparent that non-verification of a solution could be a useful additional criterion on which to filter potentially unfit baseline candidates. As such, the processing times and memory requirements of this module were included in analysis of the Baseline Filter module in the previous sub-section.

It should be noted, however, that this module was retained as a separate and additional processing step in the description of our framework because statistical analysis and verification of the reported baseline solution from the previous module is currently lacking but may be advisable in future work, not only as a means to increase system robustness, but also to provide better performance metrics and to handle the potential case when an unknown filtering error occurs and incorrect position information is returned by the system.

### Result Handler

The purpose of this module is simply to repackage the baseline solution into a standard, easy-to-read format for use by whatever application is consuming the result. It takes the verified solution, along with the confidence value corresponding to the reported baseline, and sends a single message to the output interface containing the relevant GPS epoch number, the applicable device name or ID of the remote node, the relative 3D baseline vector, and an estimated accuracy value for the result.

### Processing Time and Memory Loading

To summarize, an overview of the processing times and memory requirements of each of the software modules comprising the relative localization framework is provided. Times are given both in absolute terms and as a percentage of the total available time for a given epoch of data, namely 1 s. All of the values as shown in the following tables are for a single pair of GPS receivers over one observation epoch.

Table 1 gives a summary of the maximum memory requirements for each software module and the framework as a whole. It should be noted that since each module can only operate on one epoch of data from a single remote receiver at a time, these values correspond to the maximum amount of storage that may be required by the system as a whole.

TABLE 1
Summary of the memory requirements for each localization software
component

| Module Name | Memory Requirements |
|---|---|
| GPS Manager | 25.55 kB |
| Preprocessor | 4.38 kB |
| Network Manager | 1.36 kB |
| Data Aggregator | 66.95 kB |
| Tracking Filter | 1.68 kB |
| Baseline Filter (Calibrating) | 100 kB |
| Baseline Filter (Running) | 14.98 kB |
| Solution Verifier | 0.00 kB |
| Result Handler | 0.45 kB |
| TOTAL (Calibrating) | 100 kB |
| TOTAL (Running) | 113.67 kB |

### Hardware and Platform Components

We implemented an actual working prototype of the distributed system as shown in FIG. 21 using a network of Android smartphones and tablets. Specifically, three HTC

Desire smartphones and three Google Nexus 7 tablets provided us a network of six devices with varying levels of processing power and memory capabilities on which to test our system. Each device was paired with exactly one custom Bluetooth-headset [56] that included a μblox LEA-6T GPS receiver. We chose this particular L1 receiver because it supplies raw measurement data, whereas many current low-cost receivers do not. The standalone accuracy of the LEA-6T is around 2:5 m with an unobstructed view of the sky [54].

In our setup, all GPS measurements were obtained via an external antenna connected directly to the Bluetooth headset which streams raw GPS data (pseudorange, carrier phase, ephemerides, etc.) over a virtual COM port to its paired Android device using the UBX proprietary protocol of the μblox GPS receiver. The GPS coordinates computed and reported by the receiver were also streamed to the device to allow for comparison between our methodology and the built-in algorithms supplied by μblox.

To avoid having a single point of failure, we opted for a distributed, symmetric software architecture whereby each device shares its raw GPS data with the entire network and runs the localization algorithm independently on the data received from its peers, as well as from the local GPS receiver. We relied on 3G data communications and an Amazon-based cloud server for network-wide broadcast of the raw GPS readings. In our prototype, we configured the framework to use UDP over WiFi/3G to send data to the centralized cloud server whose purpose was to keep track of the participating GPS receivers and to re-broadcast any received data packets to all other networked nodes.

In playback mode (i.e. when pre-recorded log files were played using a PC-version of the framework), multiple instances of the framework were instantiated in separate processes to simulate the behavior of the framework running on physically unique devices. Each instance communicated with all other local instances via UDP-based loopback multicast over the PC's network interface. In other words, from the framework's point of view, each instance ran on its own dedicated CPU and communicated via a physical network link.

### Node Tracking Results

All of the experiments were used specifically to test the capabilities of the relative tracking algorithms as described above. The first two sub-sections deal with cumulative tracking results from a series of temporally significant experiments (in other words, from a dead-reckoning point of view), and the final sub-section examines short-term tracking results on an epoch-by-epoch basis, as this is the primary way in which tracking results are used in the baseline localization algorithm.

### Running Track

Establishing the ground truth for localization experiments is always difficult, even more so when mobility is involved. The site for our first set of experiments, a running track with precisely marked lanes, helped greatly in this regard; hence, we tried out multiple different scenarios. The first experiment was a stationary setup with four nodes placed on the track at the corners of a rectangle approximately 100×50 m in size. The second experiment utilized a 9-foot long pole. We placed one receiver at each end of the pole and walked around the track multiple times in the middle of lane 4. The pole was kept perpendicular to the direction of movement; hence, the nodes were moving approximately on the border between lanes 2 and 3, and between 5 and 6, respectively. We also placed an additional stationary node on the track. Finally, we constructed an equilateral triangle of three 9-foot long poles and put a node at each corner. This setup was similar to the single pole configuration with an additional node moving along the center of lane 4 ahead of the other two nodes. Once again, a stationary node was also used.

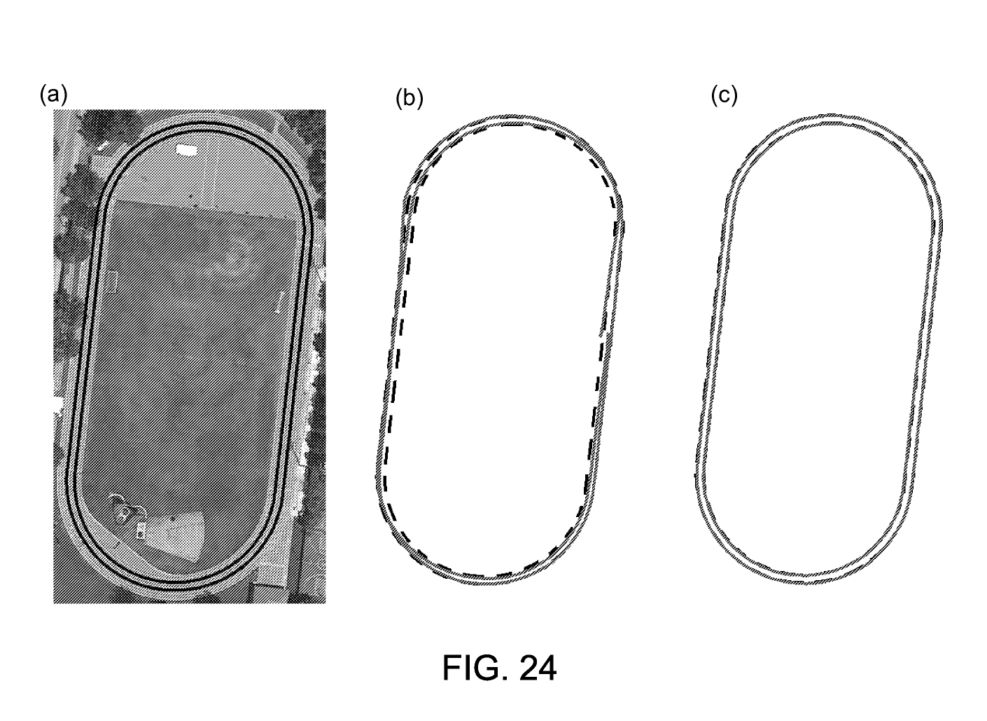

These experiments are useful because the relative distances of the nodes attached to the poles are precisely known at all times, with only the relative directions changing. As such, they provide us with a way to measure the performance of the technique in the \free mobility” case with extreme precision. The additional static node adds range mobility to the experiment, since both the relative directions and distances to the nodes are changing continuously when viewed from this receiver. This provides performance statistics on the technique when used with baselines of varying lengths. Finally, the stationary node gives us the ability to create absolute ground truth maps for easier visualization, such as using Google Earth as shown in FIG. 24.

### Stationary Setup

In this setup, four nodes were placed at the corners of a rectangle approximately 100×50 m in size. The track had trees and a building next to it, so the nodes had a partially obstructed view of the sky. Nevertheless, this can still be considered a benign GPS environment. To test system stability, we let the system run for more than 25 minutes. Note that our tracking algorithm made no assumption that the nodes were stationary.

To evaluate the accuracy of the system, we set the absolute initial position of each node to be equal to the reported absolute location from the GPS chip. This allows for fair comparison since both our methodology and the internal μBlox algorithms start with identical views of all of the node positions in the network. Each receiver then tracks the motions of the other nodes through time using the pairwise relative tracking vectors between the remote node and itself. The error is determined from the distance between the computed relative location at any point in time and the ground truth. Since the nodes are completely stationary, the ground truth is simply the starting location of each node.

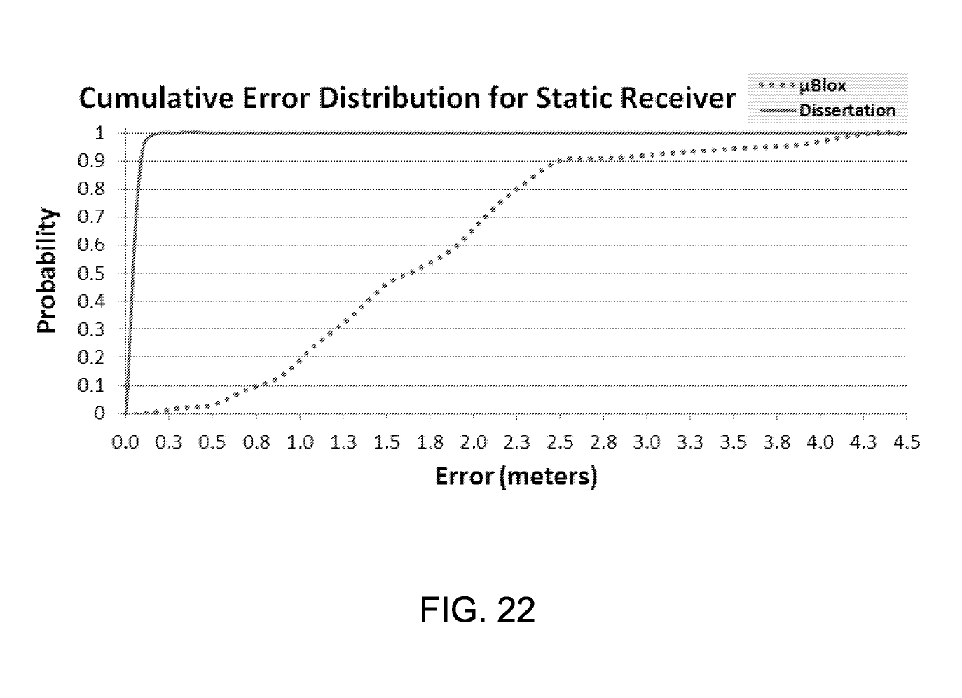

FIG. 22 shows schematically cumulative error distributions for a stationary receiver according to certain embodiments of the present invention. As shown in FIG. 22, the results indicate the cumulative error distribution for one of the three remote nodes as viewed from an arbitrarily chosen reference receiver. It should be noted that different choices of reference and/or remote node result in almost identical distributions, so only one of the 12 possible options is shown here. In every case, our algorithm produced very accurate results with mean errors ranging from 7.5-10.3 cm (with standard deviations of 4.9-6.8 cm). The errors from the built-in Blox algorithms were significantly worse, with mean errors ranging from 1.46-1.82 m and standard deviations from 0.7-0.84 m. This is almost a 20-time improvement in average error, with an extremely substantial increase in stability as evinced by the low standard deviations.

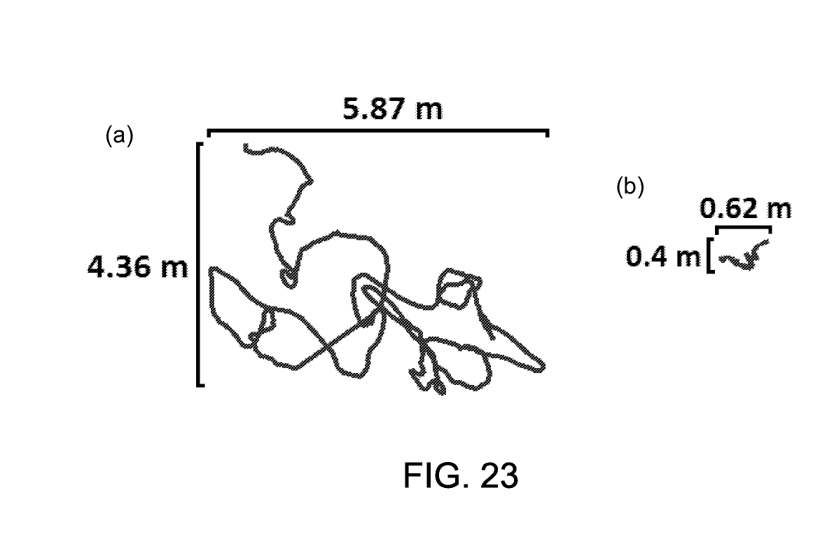

FIG. 23 shows schematically static tracks using (a) the built-in μBlox algorithms vs. (b) the tracking methodology according to certain embodiments of the present invention. FIG. 23 shows what this type of improvement looks like graphically over a 25-minute period. It should be noted that our tracking algorithm resulted in both significantly slower and smaller error accumulations than the chip-based solution; however, the errors from the μBlox algorithms appear to be zero-mean, whereas our errors indicate a slow bias over time.

### Fixed 9-Foot Distance

FIG. 24 shows schematically tracks of two nodes separated by a constant 9-foot baseline making one lap around a running track according to certain embodiments of the present invention, where (a) shows the ground truth using Google Earth, (b) shows the result using μBlox, and (c) shows the result using the tracking methodology according to certain embodiments of the present invention.

As shown in FIG. 24, the results of the experiment with two mobile nodes on a 9-foot (2.74 m) pole and a single stationary node are probably the easiest to visualize. FIG. 24(a) shows the ground truth of this experiment: the tracks of the two mobile nodes in Google Earth. FIG. 24(b) shows the tracks estimated by the built-in μBlox algorithms using the stationary node as a reference, under the assumption that its precise absolute location is known. FIG. 24(c) shows the tracks computed by the dissertation algorithms, indicating the relative location vectors between the stationary node and the two mobile nodes through time (and again assuming that the stationary node is perfectly localized and the starting positions are known). In other words, these results indicate the tracks of the two mobile nodes as seen from the reference with relative ranges varying from 0 to ˜125 m. As shown in FIGS. 24(b) and (c), the ground truth is shown using a dashed line, and the background image is removed for clarity.

As shown in FIG. 24, the tracks reported by our dissertation algorithms are generally closer to the ground truth. For example, the two nodes are always perpendicular to the track and finish almost exactly where they started.

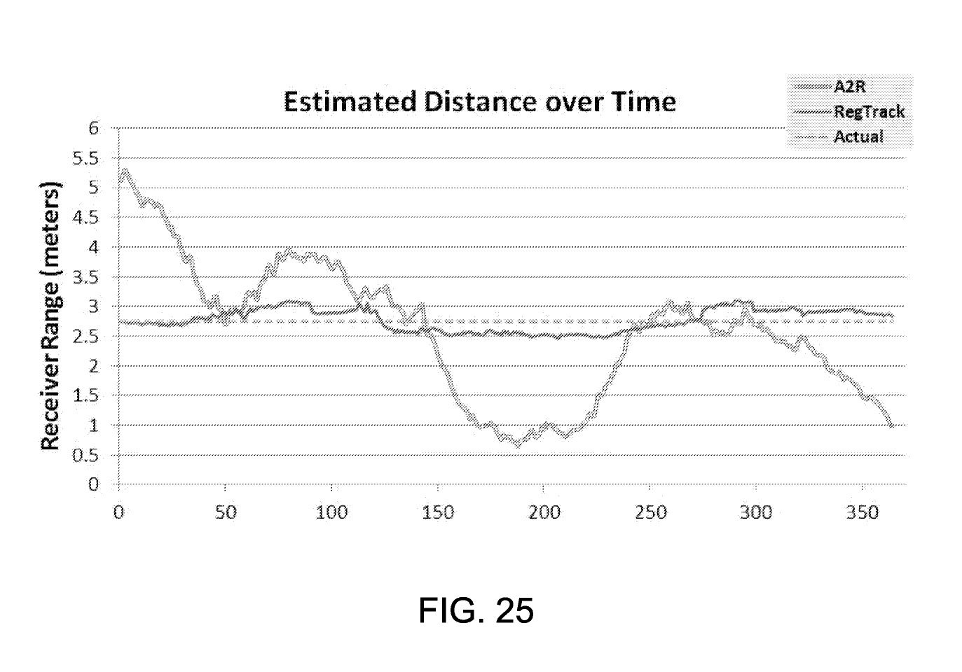

FIG. 25 shows schematically an estimated distance between two mobile nodes (as seen by a stationary node) as a function of time as they moved around the track according to certain embodiments of the present invention. Specifically, FIG. 25 shows the estimated distance between the mobile node pair (as seen from the stationary reference) as it moved around the lap. By comparing FIG. 24(b) to FIG. 25, the tracks from the μBlox algorithms are not only inconsistent in their ability to stay in the correct lane position, but the nodes also frequently move in an orientation that is not perfectly parallel to the track, as indicated by the greater than 9-ft range errors in FIG. 25 that correspond to track locations in FIG. 24(b) at times when they visually appear to be less than 9-ft, and also in the starting locations of the two nodes in FIG. 24b (with a range of close to 5 m as opposed to the expected 2.74 m).

Knowing the ground truth between the two mobile nodes to be a fixed 9 feet, or 2.74 m, the mean error using the μBlox algorithms (as seen from the stationary reference node) was 89 cm with a standard deviation of 68.5 cm. Taking the difference of the vectors provided by our tracking algorithms between each mobile node and the reference, the mean error was 16.8 cm with a standard deviation of 8.4 cm.

It should be noted that we can also track the relative distance of the two mobile nodes to one another without an explicit reference node. Each of the mobile nodes can consider itself to be the reference and track the relative location of the other. This is the default operating mode of our tracking algorithms; the stationary reference node was only necessary to give results over changing baseline ranges and to show the absolute track in FIGS. 24(b) and (c). Results using this method provide a mean error of 14.2 cm according to both receivers, with a standard deviation of 7.8 cm. It should also be noted that the relative errors are very similar whether we use a reference node up to 125 m away or just the two mobile nodes that are less than 3 m apart. In conclusion, this experiment showed a factor of 6 improvement over 83 the built-in μBlox algorithms, with almost a 10-time improvement in stability as indicated by the standard deviation values.

### 9-Foot Equilateral Triangle

This experiment was very similar to the previous one with the addition of an extra mobile node. Again, our approach is compared to that of the μBlox algorithms; that is to say, the value computed by taking the difference of the absolute positions reported by the three μblox receivers involved and the stationary reference. The combined mean error of the μBlox algorithms for all three baselines was 1.12 m, while the mean error of our tracking algorithm was 23.2 cm, an overall improvement of 6.6× in mean error. The standard deviation of our tracking algorithm came to 17.6 cm, which was a 3.5-time improvement over the μBlox standard deviation of 63.2 cm.

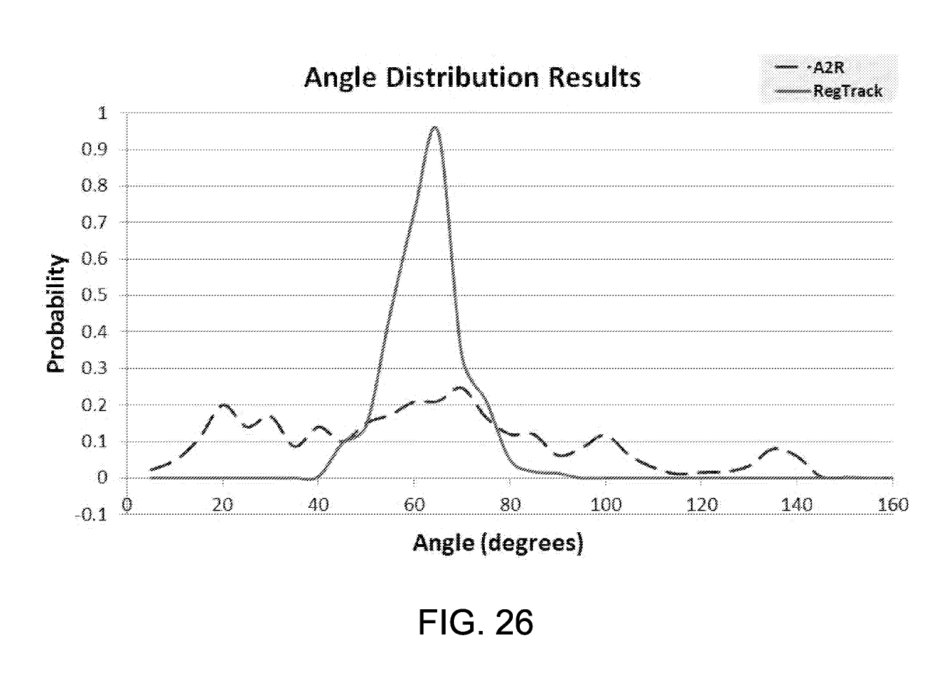

Note that in this setup, each mobile node sees the other two at a 60° angle. Since our algorithms compute location vectors, we can estimate this angle easily. It is also straightforward to do with the absolute coordinates provided by the GPS chips. FIG. 26 shows schematically relative angular distributions between three nodes in an equilateral triangle configuration for one lap around the track according to certain embodiments of the present invention. Specifically, FIG. 26 shows the distribution of all three angle estimates throughout the lap. These results show a marked improvement over the μBlox algorithms, with a clear spike in the distribution curve around the 60° mark. The standard deviation of our results was 8°, while the standard deviation of the built-in results was 33°. However, due to the close proximity of the receivers, a small error in range can result in significant angular errors.

### Driving

Since multiple experiments in a fairly benign environment all produced marked improvements over the built-in μBlox algorithms, we decided to test the limits of our system by running experiments in both a partially-obstructed area and under high-dynamic conditions, namely driving in a car. This experiment involved placing three GPS nodes on top of a car and driving over an 8.5 km stretch of road, where the course was broken up into two distinct parts. The first part involved driving at relatively low speeds (<50 km/h) between 2-4 story tall buildings and under numerous leafy trees; in other words, a slightly higher dynamic environment than in previous experiments with significantly more opportunities for multipath, cycle slippage, and losses of lock. This was followed by an extremely high-dynamic situation in which we drove on an interstate highway, where the main obstructions were the numerous overpasses that temporarily blocked satellite visibility.

In addition to the three mobile nodes on the roof of the car, we also set up a stationary node at the starting position to test the accuracy of our algorithm when a receiver is tracking multiple nodes many kilometers away (a maximum of 3.5 km in this case).

### Driving in an Obstructed Area

Three nodes were placed on top of a vehicle situated in a wide open parking lot with a clear view of the sky, two in the front approximately 1.04 m apart and a third on the back left side approximately 1.35 m behind the front left node. After initialization, the car was driven slowly through a very narrow alleyway with buildings on either side and significant tree cover. The car then drove through a one-lane, suburban-type road with occasional tree cover, followed by a main road (at approximately 50 km/h) with tree cover. The total length of this portion of the experiment was 1.478 km, which took 5 minutes to complete including a few stops due to traffic. Table 2 summarizes the results as they accumulated over time, where “Reference” indicates the pairwise node ranges as computed with reference to the stationary node, and “Direct” indicates the results as computed directly (pairwise) from each of the mobile nodes on the vehicle relative to one another, excluding the stationary node.

Somewhat surprisingly, the overall results were only marginally less accurate than those from the running track, even though this experiment included a much more difficult GPS environment. We would have expected multipath and losses of satellite locks to have more of an impact, but it is possible that the close proximity of the receivers to one another meant that any multipath effects were actually quite similar for all receivers, and therefore canceled out.

TABLE 2
Cumulative accuracy for one of the node pairs while driving through a
difficult GPS environment

| | Distance | | | Standard |
|---|---|---|---|---|
| Method | Traveled | | Mean Error | Deviation |
| RegTrack | 500 | m | 15.2 cm | 10.5 cm |
| RegTrack-Direct | 500 | m | 50.7 cm | 24.0 cm |
| A2R | 500 | m | 93.6 cm | 36.5 cm |
| RegTrack | 1 | km | 15.0 cm | 10.2 cm |
| RegTrack-Direct | 1 | km | 48.4 cm | 24.1 cm |
| A2R | 1 | km | 97.5 cm | 36.5 cm |
| RegTrack | 1.48 | km | 25.3 cm | 24.8 cm |
| RegTrack-Direct | 1.48 | km | 62.2 cm | 36.4 cm |
| A2R | 1.48 | km | 113.4 cm | 55.6 cm |

It is interesting to note that the direct application of our tracking algorithms from each of the roving nodes to one another resulted in less accurate results than when viewed from the stationary node by a factor of about 3. The most likely reason for this is that the stationary node had a clear view of the sky, meaning it was more likely to have a larger number of visible satellites in common with each of the mobile nodes at any given time than they did with one another. In either case, our methodology outperformed the μBlox algorithms by a factor of 2 for the direct case, and a factor ranging from 4.5-6.5 when using the stationary node as a reference.

### High-Speed Driving

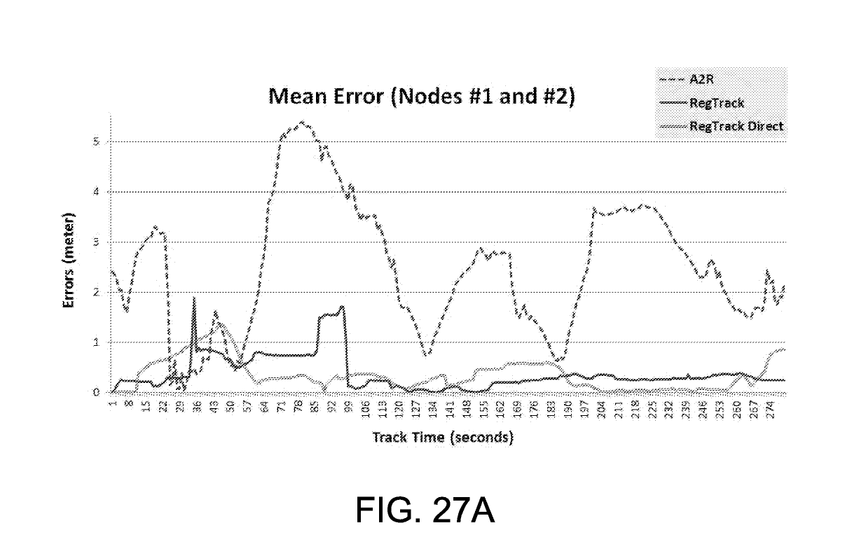

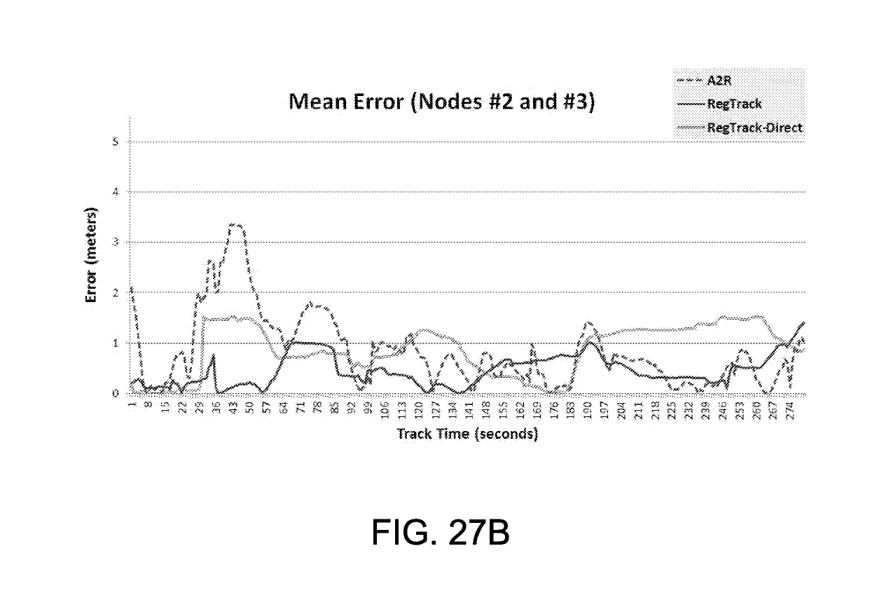

FIG. 27 shows schematically the mean errors over time for two of the mobile node pairs attached to the roof a car driving along the interstate according to certain embodiments of the present invention, where (a) shows the mean errors over time for nodes No. 1 and No. 2, and (b) shows the mean errors over time for nodes No. 2 and No. 3.

For this portion of the driving test, we entered an interstate highway with a clear view of the sky, obstructed only by occasional overpasses. It is important to note here that we did not stop and re-initialize the tracking algorithm, but rather continued on from the end of the previous portion of the driving experiment. Therefore, any error that had accumulated during that time was also present to begin this test.

The total length of the path traversed during this experiment was 7.027 km, taking 4.75 minutes to complete. The receivers were moving an average speed of 90 km/h during this time. The results for two of the mobile node pairs are summarized in FIG. 27. Clearly, the improvement of our tracking methodology over the μBlox algorithms in the mean error graph for mobile nodes No. 1 and No. 2 looks significantly better than the results from nodes No. 2 and No. 3. We included both sets of results to emphasize an important point, namely to indicate how bias can accumulate in a dead-reckoning algorithm and to show why these tracking results should not be used exclusively in a standalone fashion.

Nodes No. 1 and No. 2 correspond to the front two receivers on the car, which, from looking at both GPS tracks and analyzing the result data, accrued only a modest amount of error over the first part of the driving experiment. Node No. 3 was the node on the back of the car directly behind node No. 2, and it was apparent that this node had accumulated more error than the other two in the directional sense. In other words, the reported ranges between the nodes were quite close to the actual ranges, however the direction vectors from node No. 3 to the other nodes were slightly incorrect. As such, the tracking algorithm could have been working flawlessly and the comparison to ground truth would still show significant error since the initial positions at the beginning of this portion of the experiment had already accumulated error.

Since the initial positions of nodes No. 1 and No. 2 were shown to be more closely representative of the ground truth, the results in the first graph are more indicative of the performance of our tracking algorithm. Once again, it outperformed the μBlox receivers by a significant margin, only this time the direct localization approach (i.e. the positions of the mobile nodes as seen from one other, excluding the stationary node) performed slightly better than the stationary node case (as expected). This again furthers our theory that low satellite visibility in the first part of the experiment was to blame for the decrease in accuracy.

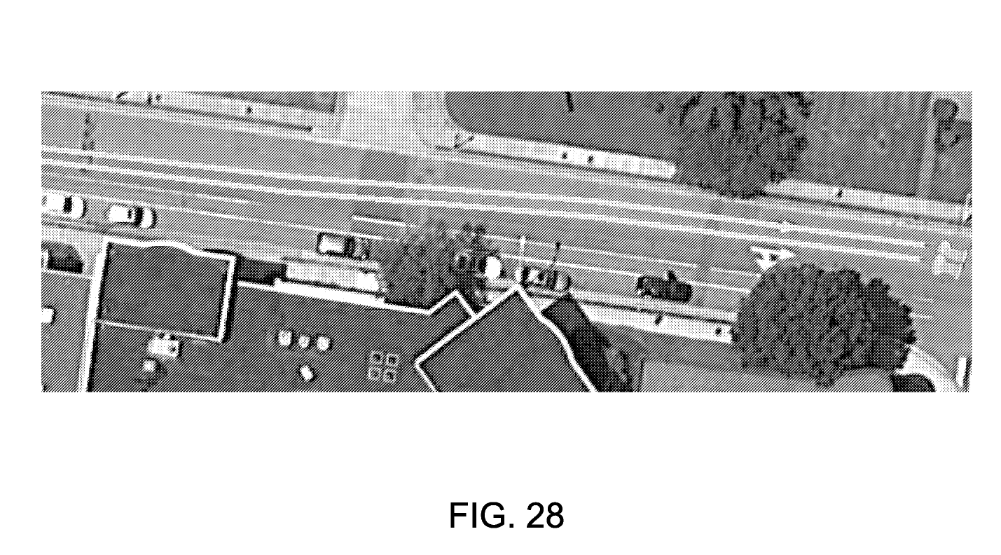

FIG. 28 shows schematically tracking of car carrying out a lane change according to certain embodiments of the present invention. For numerical comparison, the mean error of the μBlox method was 2.47 m with a standard deviation of 1.29 m, whereas the mean error of the dissertation method using a stationary reference node was 37.6 cm with a standard deviation of 34.5 cm, and the mean error of the direct dissertation method was 34.8 cm with a standard deviation of 31 cm. As a frame of reference, this level of accuracy allows for quite obvious feature extraction of important driving events such as lane-changing as shown in FIG. 28, approximately 1 km into the experiment:

One final important thing to note about this driving experiment is the level of accuracy that was able to be maintained relative to a stationary reference node, even though the range to that node varied up to 3.5 km away. This shows that our error analyses and the dual-receiver corrections used in our tracking algorithm produce precise enough satellite observations that accuracy is largely independent of the pairwise distances between the mobile nodes being tracked. As a summary, Table 3 shows the results of all experiments described in this section.

TABLE 3
Summary of tracking results for all nodes in each experiment

| Experiment | Method | Mean Error | Standard Deviation |
|---|---|---|---|
| Track: Stationary | Reference | 9.1 cm | 6.1 cm |
| | μBlox | 168.4 cm | 77.3 cm |
| Track: 9-ft pole | Reference | 16.8 cm | 8.4 cm |
| | Direct | 14.2 cm | 7.8 cm |
| | μBlox | 89.0 cm | 68.5 cm |
| Track: Triangle | Reference | 23.2 cm | 17.6 cm |
| | μBlox | 112.0 cm | 63.2 cm |
| Driving: | Reference | 25.3 cm | 24.8 cm |
| Obstructed/Multipath | Direct | 62.6 cm | 36.4 cm |
| | μBlox | 113.4 cm | 55.6 cm |
| Driving: High-Speed | Reference | 37.6 cm | 34.5 cm |
| | Direct | 34.8 cm | 31.0 cm |
| | μBlox | 247.0 cm | 149.0 cm |

This disclosure presented a novel approach to GPS-based differential tracking of mobile nodes. The evaluation of the technique under various conditions clearly showed the feasibility of achieving an order of magnitude improvement in localization accuracy over traditional absolute positioning provided by standard GPS while relying on low-cost single frequency receivers. Also, unlike most GPS-based navigation solutions, our approach does not snap positions to maps or try to use a dynamic model for the motions of the receivers (other than during satellite lock loss). We showed centimeter-scale accuracy in various walking experiments and sub-meter accuracy while driving at various speeds. This demonstrated high-accuracy of RegTrack is notable because the approach uses a form of dead reckoning in which errors accumulate over time. Conversely, before we can fully realize our vision, RegTrack needs an additional component to periodically compute the instantaneous relative position of any node participating in the localization. This is also necessary to initialize the tracking at start-up time and because any complete loss of satellite locks resulting in fewer than four visible satellites will necessitate a complete re-initialization of the tracking algorithm. The current simplistic extrapolation of receiver positions using previous velocity estimates during a satellite outage degrades the accuracy of the algorithm.

### ADDITIONAL EMBODIMENTS

We have explained the idea and implementation details behind an algorithm that is able to produce centimeter-scale relative tracking results over the short term. Such an algorithm is not only useful because of the obvious advantage of being able to accurately localize a set of receivers through time, but also because it enables us to mathematically reverse the relative motions of a receiver such that the initial baseline vector between two receivers can be estimated as if both receivers had remained stationary.

To make this clearer, let us assume that we have two nodes, one of which has a general idea of its location on Earth (the reference) and is trying to localize the second node, which could be located anywhere in its vicinity (the rover). It has already been shown that the relative motions of the rover can be accurately tracked without prior knowledge of its absolute location. Since only a general idea of the location of a node is required to produce an extremely accurate satellite direction vector, it can be assumed that the reference location is precisely known at a given time instant and does not change over time; likewise, the relative motions of the rover are precisely known (from the tracking algorithm).

Since we know the satellite positions (X^{sat}), the reference position, and the relative motions of the rover through time, we can mathematically describe a system of range equations from the rover to a satellite (R^{s}), such that each equation is only a function of the initial baseline vector coordinates (b(t0)) with respect to the “stationary” reference (xref) at time t0:

$${R}_{rover}^{s} ( {t}_{0} ) = \sqrt{{( {X}^{sat} - {x}_{ref} - {b}_{x} ( {t}_{0} ) )}^{2} + {( {Y}^{sat} - {y}_{ref} - {b}_{y} ( {t}_{0} ) )}^{2} + {( {Z}^{sat} - {z}_{ref} - {b}_{z} ( {t}_{0} ) )}^{2}}$$

$${R}_{rover}^{s} ( {t}_{1} ) = \sqrt{\begin{matrix}{( {X}^{sat} - {x}_{ref} - {b}_{x} ( {t}_{0} ) - Δ {b}_{x} ( {t}_{1} ) )}^{2} + {( {Y}^{sat} - {y}_{ref} - {b}_{y} ( {t}_{0} ) - Δ {b}_{y} ( {t}_{1} ) )}^{2} + \\ {( {Z}^{sat} - {z}_{ref} - {b}_{z} ( {t}_{0} ) - Δ {b}_{z} ( {t}_{1} ) )}^{2}\end{matrix}}$$

$${R}_{rover}^{s} ( {t}_{2} ) = \sqrt{\begin{matrix}{( {X}^{sat} - {x}_{ref} - {b}_{x} ( {t}_{0} ) - Δ {b}_{x} ( {t}_{1} ) - Δ {b}_{x} ( {t}_{2} ) )}^{2} + \\ {( {Y}^{sat} - {y}_{ref} - {b}_{y} ( {t}_{0} ) - Δ {b}_{y} ( {t}_{1} ) - Δ {b}_{y} ( {t}_{2} ) )}^{2} + \\ {( {Z}^{sat} - {z}_{ref} - {b}_{z} ( {t}_{0} ) - Δ {b}_{z} ( {t}_{1} ) - Δ {b}_{z} ( {t}_{2} ) )}^{2}\end{matrix}}$$

$$⋮ = ⋮$$

The only unknowns in the equations above are the initial baseline coordinates, (b(t0)). As such, it is clear that including range observations from a number of consecutive epochs increases the amount (and quality) of data available to solve for the initial baseline. Quality is said to be increased because data from different epochs correspond to different satellite constellation geometries, and the more geometries that are incorporated, the smaller the region of feasibility for the location of a receiver. This overcomes one of the fundamental pitfalls of precise GPS localization that currently exists; namely, the requirement that a roving receiver must remain stationary relative to a reference node for some amount of time while its position is determine.

In the current state of the art, multiple epochs of data from two stationary receivers must be collected and analyzed to remove any correlated receiver-or satellite-based errors from the data, leaving only uncorrelated errors and random noise. As the satellite configuration changes over time, the set of possible baseline solutions becomes smaller and smaller until only one viable set remains, corresponding to the actual baseline vector. Using our methodology, multiple epochs of data can be collapsed into the stationary node case which does not presuppose the exact location of the roving node. As such, not only is it unnecessary for the exact absolute location of the reference node to be known a priori, but both the reference and roving nodes are free to move at random during the localization process, making our methodology appropriate for truly ad-hoc, random mobile networking applications.

Among other things, this disclosure presents an approach that uses GPS to derive relative location information for multiple receivers. Nodes in a network share their raw satellite measurements and use this data to track the relative motions of neighboring nodes as opposed to computing their own absolute coordinates. The system has been implemented using a network of Android phones equipped with a custom Blue-tooth headset and integrated GPS chip to provide raw measurement data. Our evaluation shows that centimeter-scale tracking accuracy at an update rate of 1 Hz is possible under various conditions with the presented technique. This is more than an order of magnitude more accurate than simply taking the difference of reported absolute node coordinates or other simplistic approaches due to the presence of uncorrelated measurement errors.

In sum, the present invention, among other things, recites a novel approach to GPS-based differential localization of mobile nodes, with the overarching goal of dramatically increasing the precision of relative 3D baseline coordinates using only commercial, off-the-shelf GPS receivers. By allowing a network of GPS receivers to share their raw satellite measurements with one another, aspects of the present invention are capable to achieve centimeter-scale relative localization accuracy via:
Better modeling and correction of error sources unique to the two-receiver localization case, stemming primarily from relativistic effects due to ill-synchronized local receiver clocks,
Creation of a new observation model called the Temporal Double-Differencing model which is able to use independent satellite observations from two receivers to create a set of unambiguous, highly-accurate carrier phase equations representing the relative motions of a set of receivers through time and space,
Integration of this new model in a tracking algorithm that produces pairwise 3D location vectors between a local node and any number of remote receivers without requiring a reference node, reference satellite, stationary setup or calibration phase, or any a priori knowledge of the locations of one or more of the participating receivers,
Use of the highly accurate tracking results in a robust algorithm that allows for motionenabled, uncalibrated receivers to determine the relative baselines between them in an impromptu, ad-hoc fashion, and
Synthesis of the aforementioned research milestones in a working Java-based prototype on physical mobile Android devices for testing and validation.

Unlike most GPS-based navigation solutions, aspects of the present invention do not snap positions to maps or try to use a dynamic model for the motions of the receivers (other than for tracking during satellite losses of lock). Further, unlike other high-precision GPS localization techniques used in applications for which the system of the embodiments may have utility (e.g. Differential GPS, Real-Time Kinematic navigation, or any number of post-processing methods used in applications such as land surveying, precision agriculture, temporal feature extraction, or autonomous driving), aspects of the present invention do not require a stationary calibration phase, relying instead on a symbiotic feedback relationship between relative tracking and baseline localization to provide real-time coordinate updates.

Based on the experiment results, aspects of the present invention meets the following requirements, which represent the ideal characteristics a complete relative localization system should embody:
Centimeter-precision accuracy for a scalable network of nodes
No stationary calibration or data collection phase
No explicit reference station or hub

Certain embodiments of the present invention allow any GPS receiver to become its own reference, thus negating the need for an explicit “reference station.” Likewise, Certain embodiments of the present invention employ observation models which either do not require a reference satellite or impose no limitations on which satellite must be used as a reference (or for how long). By incorporating tracking results into the baseline determination algorithms, there is no longer the need to pre-survey receiver locations prior to application deployment or for any receiver in the network to remain stationary during calibration. As such, the methodology provides a simple out-of-the-box, ready-when-deployed solution to high accuracy relative localization. Finally, the combination of techniques for dual-receiver error correction and continuous tracking through time has enabled the localization algorithms to achieve levels of precision that are limited only by the measurement resolutions of the individual GPS receivers themselves. The evaluation of aspects of the present invention under various conditions has clearly showed the feasibility of achieving an order of magnitude improvement in localization accuracy over the traditional absolute positioning algorithms provided by standard GPS while relying on low-cost, single frequency receivers alone.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### REFERENCE LIST

[1] Federal Aviation Administration. Navigation Services—Wide Area Augmentation System (WAAS). August 2010, http://www.faa.gov/about/office_org/headquarters_offices/ato/service_units/techops/nayservices/gnss/waas/.
[2] Cooper E. Allison. GPS and RTK-GPS: A Comparison. EzineArticles, Oct. 31, 2011, http://ezinearticles.com/?GPS-and-RTK-GPS:-A-Comparison&id=6642248.
[3] S. F. Appleyard, R. S. Linford, and P. J. Yarwood. Marine Electronic Navigation (2^{nd} Edition). Routledge and Kegan Paul, 1988.
[4] Neil Ashby. The Sagnac effect in the Global Positioning System. Relativity in Rotating Frames, 2010.
[5] Geoffrey Blewitt. Basics of the GPS Technique: Observation Equations. Geodetic Applications of GPS, 1997.
[6] Bill Clinton. Statement by the President regarding the United States' decision to stop degrading Global Positioning System accuracy. Office of the Press Secretary, May 1, 2000.
[7] J. M. Codol and A. Monin. Improved triple difference GPS carrier phase for RTK-GPS positioning. IEEE Statistical Signal Processing Workshop, pages 61 {64, 2011.
[8] Oscar L. Colombo. Ephemeris errors of GPS satellites. Journal of Geodesy, 60(1):64-84, 1986.
[9] Southern Avionics Company. DGPS Reference Station Transmitters. 2012, http://www.southernavionics.com/products/differential-gps-transmitters/.
[10] C. Counselman and S. Gourevitch. Miniature interferometer terminals for earth surveying: Ambiguity and multipath with Global Positioning System. IEEE Transactions on Geoscience and Remote Sensing, GE-19(4), October 1981.
[11] Peter H. Dana. Global Positioning System Overview. University of Texas at Austin, 1999, www.colorado.edu/geography/gcraft/notes/gps/gps_f.html.
[12] Global Positioning Systems Directorate. Systems engineerings and integration interface specification. IS-GPS-200F, September 2011.
[13] Hamid Ebadi. Positioning with GPS. K. N. Toosi University of Technology, August 2000.
[14] Ahmed El-Sayed El-Rabbany. The effect of physical correlations on the ambiguity resolution and accuracy estimation in GPS differential positioning. Technical Report No. 170, Geodesy and Geomatics Engineering, December 1997.
[15] Tamer F. Fath-Allah. A new approach for cycle slips repairing using GPS single frequency data. World Applied Sciences Journal, 8(3):315-325, 2010.
[16] Survey Land Advisory Board for State ofWashington Department of Natural Resources. GPS guidebook: Standards and guidelines for land surveying using Global Positioning System methods. Version 1, November 2004.
[17] J. G. Garcia, P. I. Mercader, and C. H. Muravchik. Use of GPS carrier phase double differences. Latin American Applied Research, 35:115-120, 2005.
[18] Tekmon Geomatics. Antenna phase center offset and variation. 2011-2012, http://tekmon.gr/tag/phase-center-antenna/.
[19] Tekmon Geomatics. Network RTK. GPS Network Tutorial, 2011-2012, http://tekmon.gr/2011/03/network-rtk-2/.
[20] Waypoint Consulting Inc. Relative moving baseline software (RMBS). March 2000, http://webone.novatel.ca/assets/Documents/Waypoint/Reports/RelativeMovingBaselineSoftware.pdf.
[21] Berg Insight. GPS and mobile handsets. Technical Report, LBS Research Series, 2012.
[22] Alan Kaminsky. Trilateration. Rochester Institute of Technology, Department of Computer Science, Ad hoc Networks Class, Module 05: http://www.cs.rit.edu/˜ark/543/module05/trilateration.pdf.
[23] Elliott D. Kaplan and Christopher J. Hegarty. Understanding GPS: Principles and Applications. Artech House, Inc., Norwood, Mass., USA, second edition, 2006.
[24] kowoma.de. Sources of errors in GPS. The GPS System, http://www.kowoma.de/en/gps/errors.htm.
[25] D. Kuang, B. E. Schutz, and M. M. Watkins. On the structure of geometric positioning information in GPS measurements. Journal of Geodesy, 71(1):35-43, 1996.
[26] NASA Jet Propulsion Laboratory. The NASA Global Differential GPS System. NASA, September 2009, http://www.gdgps.net/system-desc/index.html.
[27] Simon Lightbody and Gary Chisholm. Techniques in relative RTK GNSS positioning. White Paper, Trimble Marine Group, 2010.
[28] The Decca Navigator Company Limited. The Decca Navigator: Principles and Performance of the System. The Decca Navigator Company Limited, July 1976.
[29] Ning Luo. Centimetre-level relative positioning of multiple moving platforms using ambiguity constraints. In Proceedings of the ION GPS2000 Conference, Salt Lake City, Utah, September 2000.
[30] Cetin Mekik and Murat Arslanoglu. Investigation on accuracies of real time kinematic GPS for GIS applications. Remote Sensing Journal, 1:22-35, March 2009.
[31] National Coordination Office for Space-Based Positioning, Navigation, and Timing. Control segment. GPS.gov—Official U.S. Government information about GPS and related topics, June 2012, http://www.gps.gov/systems/gps/control/.
[32] Kevin J. O'Brien. Smartphone sales taking toll on GPS devices. New York Times, Nov. 14, 2010, Online at http://www.nytimes.com/2010/11/15/technology/15iht-navigate.html.
[33] U.S. Departments of Defense and Transportation. 1994 Federal Radionavigation Plan. National Technical Information Service, Springfield, Va., 22161, DOT-VNTSCRSPA-95-1/DOD-4650.5, May 2005.
[34] U.S. Department of Homeland Security. NAVSTAR GPS User Equipment Introduction. U.S. Department of Homeland Security, September 1996.
[35] U.S. Department of the Air Force. Pseudorandom Noise (PRN) Code Assignments. Los Angeles Air Force BaseWebsite, February 2011, http://www.losangeles.af.mil/library/factsheets/factsheet.asp?id=8618.
[36] U.S. Department of the Navy. Current GPS Constellation. http://tycho.usno.navy.mil/gpscurr.html.
[37] Bradford W. Parkinson. Introduction and heritage of NAVSTAR, the Global Positioning System. Global Positioning System: Theory and Applications, 1:3-28, 1996.
[38] Bradford W. Parkinson, James J. Spilker Jr., Penina Axelrad, and Per Enge. Global Positioning System: Theory and Applications, volume 164. Progress in Astronautics and Aeronautics, ii edition, January 1996.
[39] Mark Petovello. GNSS solutions: Carrier phase and its measurements for GNSS. InsideGNSS, July/August 2010, http://www.insidegnss.com/auto/julaug10-solutions.pdf.
[40] Nam D. Pham. The economic benefits of commercial GPS use in the U.S. and the costs of potential disruption. NDP Consulting, June 2011.
[41] Darius Plausinaitis. GPS signal acquisition. GPS Signals and Receiver Technology MM11, Danish GPS Center, Aalborg University, Denmark, 2009.
[42] Maxim Integrated Products. An introduction to spread-spectrum communications. Application Note 1890 (AN1890), February 2003.
[43] Honghui Qi and J. B. Moore. Direct Kalman filtering approach for GPS/INS integration. IEEE Transactions on Aerospace and Electronic Systems, pages 687-693.
[44] Marco Rao and Gianluca Falco. Code tracking and pseudoranges. GNSS Solutions—Inside GNSS: Engineering Solutions from the Global Navigation Satellite System Community, January/February 2012, http://www.insidegnss.com/node/2898.
[45] Sabbi Babu Rao. Design and implementation of a GPS receiver channel and multipath delay estimation using teager-kaiser operator. Masters Thesis, Department of Super Computer Education and Research Centre, Indian Institute of Science, Bangalore, India, June 2009.
[46] J. K. Ray and M. E. Cannon. Characterization of GPS carrier phase multipath. In Proceedings of ION NTM-99, San Diego, January 1999.
[47] Jagdish Rebello. Four out of five cell phones to integrate GPS by end of 2011. Press Release, IHS Market Research, Jul. 16, 2010.
[48] Zhoufeng Ren, Liyan Li, Jie Zhong, Minjian Zhao, and Yingjie Shen. A real-time cycleslip detection and repair method for single frequency GPS receiver. In 2nd International Conference on Networking and Information Technology (IPCSIT), volume 17. IACSIT Press, Singapore, 2011.
[49] Chris Rizos. Principles and practice of GPS surveying. The University of New South Wales, Syndey, Australia, May 2000, http://www.gmat.unsw.edu.au/snap/gps/gps_survey/principles gps.htm.
[50] J. B. Schleppe. Development of a real-time attitude system using a quaternion parametrization and non-dedicated GPS receivers. M.Sc. Thesis, University of Calgary, Canada, 1996.
[51] United States Geological Survey GPS Committee. USGS Global Positioning System. GPS Applications and Surveying Methods, http://water.usgs.gov/osw/gps/index.html.
[52] Rick W. Sturdevant. Chapter 17: NAVSTAR, the Global Positioning System: A sampling of its military, civil, and commercial impact. Societal Impact of Spaceflight, NASA SP-2007-4801:331-351, 2007.
[53] National Geodetic Survey. Antenna calibrations. http://www.ngs.noaa.gov/ANTCAL/.
[54] u-blox AG. Lea-6t module with precision timing. 2013, http://www.u-blox.corn/de/lea-6 t.html.
[55] Jan van Sickle. GPS for Land Surveyors. Taylor and Francis, New York, N.Y., second edition, 2001.
[56] Peter Volgyesi, Sandor Szilvasi, Janos Sallai, and Akos Ledeczi. External smart microphone for mobile phones. In Proceedings of the International Conference on Sensing Technology, ICST, 2011.
[57] Phillip Ward. The natural measurements of a GPS receiver. In Proceedings of the 51st Annual Meeting of the Institute of Navigation, pages 67-85, June 1995.
[58] Clifford M. Will. Einstein's Relativity and Everyday Life. Physics Central, http://physiescentral.comlexplorelwritersiwill.cfm, 2012.
[59] Oliver J. Woodman. An introduction to inertial navigation. Technical Report Number 696, University of Cambridge, August 2007.
[60] G. Wubenna, M. Schmitz, F. Menge, V. Boder, and G. Seeber. Automated absolute field calibration of GPS antennas in real-time. In International Technical Meeting ION GPS-00. Salt Lake City, Utah, USA, September 2000.
[61] Yudan Yi. On improving the accuracy and reliability of GPS/INS-based direct sensor georeferencing. Thesis for Doctor of Philosophy, Ohio State University, 2007.
[62] Jason Zhang, Kefei Zhang, Ron Grenfell, and Rod Deakin. On the relativistic doppler effect for precise velocity determination using GPS. Journal of Geodesy, 80:104-110, 2006.

1. (canceled)

2. (canceled)

3. The method of claim 30, further comprising:
for each receiver, determining an initial relative position of the receiver.

4-10. (canceled)

11. The system of claim 38, wherein each receiver has a GPS chip configured to measure the raw satellite data.

12. The system of claim 38, wherein each receiver is further configured to determine an initial relative position of the receiver.

13-29. (canceled)

30. A method of high-accuracy differential tracking of global positioning system (GPS) receivers, comprising:
providing a network having a plurality of receivers, wherein the receivers are configured to communicate with each other;
configuring the plurality of receivers in the network to measure raw satellite data, and to share the raw satellite data measured by each receiver; and
processing the measured raw satellite data for each receiver to track relative motions of the neighboring receivers so as to derive relative location information for the plurality of receivers.

31. The method of claim 30, wherein the step of processing the measured raw satellite data for each receiver is performed with a Peak Ambiguity Function Value (AFV) Tracking Solution (PATS).

32. The method of claim 31, wherein the step of processing the measured raw satellite data for each receiver comprises:
initializing an AFV set for a given three-dimensional (3D) search region, and identifying data of AFV peaks for the AFV set;
calibrating the data of the AFV peaks for the AFV set; and
performing a steady-state localization for the AFV set when the AFV maintains at an acceptable level.

33. The method of claim 32, wherein the step of calibrating the data of the AFV peaks for the AFV set further comprises:
for each AFV peak, updating peak locations of the AFV peaks, reevaluating the AFV at each of the updated peak locations, and performing hill climbing by steepest ascent to a maximum value of a local peak;
calculating a worst AFV threshold value for a current epoch; and
filtering the updated peak locations based on the calculated worst AFV threshold value.

34. The method of claim 32, wherein the step of processing the measured raw satellite data for each receiver further comprises:
re-initializing the AFV set for the given 3D search region when the AFV is not at the acceptable level.

35. The method of claim 30, further comprising:
for each receiver, calculating 3D pairwise relative changes of position between the plurality of receivers.

36. The method of claim 35, wherein the step of calculating 3D pairwise relative changes of position comprises:
deriving vector solutions locally at each receiver with resulting tracks of other receivers in the network using a current location of the receiver as a reference position.

37. The method of claim 35, wherein the step of calculating 3D pairwise relative changes of position comprises:
determining a receiver clock bias using a simple least-squares point positioning solution;
determining a hypothetic receiver clock bias as if the raw satellite data were measured at a correct GPS epoch according to the receiver clock bias;
determining a hypothetic receive time of the correct GPS epoch according to a local receiver clock of the receiver;
calculating a change in satellite range over the receiver clock bias; updating pseudorange observables based on the calculated change in satellite range;
calculating an extrapolated signal transmit time according to the updated pseudorange observables;
calculating a satellite position at the extrapolated signal transmit time; and
updating the satellite position for a Sagnac effect according to an actual receive epoch and the extrapolated signal transmit time.

38. A system for high-accuracy differential tracking of global positioning system (GPS) receivers, comprising:
(a) a network; and
(b) a plurality of receivers in the network, wherein the receivers are configured to communicate with each other, and each receiver is configured to measure raw satellite data, to share the raw satellite data measured by each receiver, and to process the measured raw satellite data for each receiver to track relative motions of the neighboring receivers so as to derive relative location information for the plurality of receivers.

39. The system of claim 38, wherein each receiver is configured to process the measured raw satellite data with a Peak Ambiguity Function Value (AFV) Tracking Solution (PATS).

40. The system of claim 39, wherein each receiver is configured to process the measured raw satellite data by:
initializing an AFV set for a given three-dimensional (3D) search region, and identifying data of AFV peaks for the AFV set;
calibrating the data of the AFV peaks for the AFV set; and
performing a steady-state localization for the AFV set when the AFV maintains at an acceptable level.

41. The system of claim 40, wherein each receiver is configured to calibrate the data of the AFV peaks for the AFV set by:
for each AFV peak, updating peak locations of the AFV peaks, reevaluating the AFV at each of the updated peak locations, and performing hill climbing by steepest ascent to a maximum value of a local peak;
calculating a worst AFV threshold value for a current epoch; and
filtering the updated peak locations based on the calculated worst AFV threshold value.

42. The system of claim 40, wherein each receiver is configured to process the measured raw satellite data by:
re-initializing the AFV set for the given 3D search region when the AFV is not at the acceptable level.

43. The system of claim 38, wherein each receiver is configured to calculate 3D pairwise relative changes of position between the plurality of receivers.

44. The system of claim 43, wherein each receiver is configured to calculate the 3D pairwise relative changes of position by:
deriving vector solutions locally at each receiver with resulting tracks of other receivers in the network using a current location of the receiver as a reference position.

45. The system of claim 43, wherein each receiver is configured to calculate the 3D pairwise relative changes of position by:
determining a receiver clock bias using a simple least-squares point positioning solution;
determining a hypothetic receiver clock bias as if the raw satellite data were measured at a correct GPS epoch according to the receiver clock bias;
determining a hypothetic receive time of the correct GPS epoch according to a local receiver clock of the receiver;
calculating a change in satellite range over the receiver clock bias; updating pseudorange observables based on the calculated change in satellite range;
calculating an extrapolated signal transmit time according to the updated pseudorange observables;
calculating a satellite position at the extrapolated signal transmit time; and
updating the satellite position for a Sagnac effect according to an actual receive epoch and the extrapolated signal transmit time.

46. The system of claim 38, wherein each of the plurality of receivers is stationary or movable.

47. The system of claim 46, wherein each of the plurality of receivers is provided on a mobile device or an automobile.

48. A non-transitory computer readable medium storing computer executable instructions, wherein the instructions, when executed at a processor of a global positioning system (GPS) receiver, are configured to:
configure the receiver in a network having a plurality of receivers;
configure the receiver to measure raw satellite data, and to share the raw
satellite data measured by each receiver with the plurality of receivers in the network; and
process the measured raw satellite data to track relative motions of the neighboring receivers so as to derive relative location information for the plurality of receivers.

49. The non-transitory computer readable medium of claim 48, wherein the receiver is configured to process the measured raw satellite data with a Peak Ambiguity Function Value (AFV) Tracking Solution (PATS).

50. The non-transitory computer readable medium of claim 49, wherein the instructions are further configured to process the measured raw satellite data for each receiver by:
initializing an AFV set for a given three-dimensional (3D) search region, and identifying data of AFV peaks for the AFV set;
calibrating the data of the AFV peaks for the AFV set; and
performing a steady-state localization for the AFV set when the AFV maintains at an acceptable level.

51. The non-transitory computer readable medium of claim 50, wherein the instructions are further configured to calibrate the data of the AFV peaks for the AFV set by:
for each AFV peak, updating peak locations of the AFV peaks, reevaluating the AFV at each of the updated peak locations, and performing hill climbing by steepest ascent to a maximum value of a local peak;
calculating a worst AFV threshold value for a current epoch; and
filtering the updated peak locations based on the calculated worst AFV threshold value.

52. The non-transitory computer readable medium of claim 50, wherein the instructions are further configured to process the measured raw satellite data for each receiver by:
re-initializing the AFV set for the given 3D search region when the AFV is not at the acceptable level.

53. The non-transitory computer readable medium of claim 48, wherein the instructions are further configured to calculate 3D pairwise relative changes of position between the plurality of receivers.

54. The non-transitory computer readable medium of claim 53, wherein the instructions are further configured to calculate 3D pairwise relative changes of position by:
deriving vector solutions locally at each receiver with resulting tracks of other receivers in the network using a current location of the receiver as a reference position.

55. The non-transitory computer readable medium of claim 53, wherein the instructions are further configured to calculate 3D pairwise relative changes of position by:
determining a receiver clock bias using a simple least-squares point positioning solution;
determining a hypothetic receiver clock bias as if the raw satellite data were measured at a correct GPS epoch according to the receiver clock bias;
determining a hypothetic receive time of the correct GPS epoch according to a local receiver clock of the receiver;
calculating a change in satellite range over the receiver clock bias; updating pseudorange observables based on the calculated change in satellite range;
calculating an extrapolated signal transmit time according to the updated pseudorange observables;
calculating a satellite position at the extrapolated signal transmit time; and
updating the satellite position for a Sagnac effect according to an actual receive epoch and the extrapolated signal transmit time.
